(19) United States
(12) Patent Application Publication
(10) Pub. No.: US 2026/0336123 A1
(43) Pub. Date: Oct. 29, 2026

(54) META-CONTROL TECHNIQUES FOR HUMANOID ROBOT DATA COLLECTION SYSTEM

(71) Applicant: Figure AI Inc., San Jose, CA (US)

(72) Inventor: Victor Ragusila, San Jose, CA (US)

(21) Appl. No.: 19/661,670

(22) Filed: Apr. 28, 2026

Related U.S. Application Data
(60) Provisional application No. 63/795,722, filed on Apr. 28, 2025.

(51) Int. Cl. B25J 9/16; B25J 13/00; B25J 13/04; G06F 3/01; G06F 3/04815; G06F 3/0482; G06F 3/0484

(52) U.S. Cl. CPC B25J 9/1689; B25J 9/1697; B25J 13/003; B25J 13/04; G06F 3/013; G06F 3/014; G06F 3/017; G06F 3/04815; G06F 3/0482; G06F 3/0484

(57) ABSTRACT

A robot teleoperation system and methods enable a human operator to issue meta-commands to a robot while a primary motion-mapping interface continuously maps the operator's limb movement to the robot. Meta-commands are received through non-primary input modalities—including voice, gaze, foot pedals, or anatomically distinct gestures lying outside the robot's kinematic envelope—and modify operational state without interrupting primary motion mapping. Meta-commands include toggling a data collection subsystem for machine learning training, adjusting a posture parameter of the robot, engaging a clutch to suspend mapping while maintaining a commanded pose, or causing the robot to perform a predetermined motion. A clutch-gated channel further permits re-origination of a tracking origin, fine adjustment of joint angles or end-effector coordinates, and state toggles received via an independent modality while the robot holds pose, after which motion mapping resumes through a velocity-limited blend.

### CROSS-REFERENCE TO RELATED APPLICATIONS

This application claims the benefit of and priority to U.S. Provisional Patent Application Nos. 63/795,722, filed on Apr. 28, 2025, which is fully incorporated herein by reference.

### TECHNICAL FIELD

The present disclosure relates to humanoid robot control systems, and more particularly to meta-control techniques for a humanoid robot data collection system using non-primary input modalities.

### BACKGROUND

Contemporary industrial and commercial sectors face significant challenges related to labor availability, particularly for tasks deemed unsafe or undesirable. Within the United States alone, estimates suggest millions of such positions contribute to persistent labor shortages. This situation drives a compelling need for advanced automation solutions. Humanoid robots, designed with anthropomorphic configurations, are emerging as a promising solution due to their potential versatility in operating within environments structured for humans and performing a wide range of tasks traditionally undertaken by people. As industries increasingly adopt robotics to enhance productivity and workplace safety, the demand for sophisticated robotic systems, including humanoids capable of adapting to dynamic conditions, is growing. However, significant technical hurdles remain, particularly concerning stable mobility, dynamic balance, and operational safety. Furthermore, many existing robotic solutions are specialized for narrow, repetitive tasks and lack the adaptability required for seamless integration into diverse and complex workplace settings.

While the humanoid robot market expands, driven by advancements in artificial intelligence, sensing, and mechanics, critical limitations persist in training and control methodologies. Existing approaches often rely on pre-programmed routines or limited datasets, resulting in inflexible robot behavior unsuitable for novel situations. This highlights a need for robust data collection systems capable of capturing diverse human movements and interactions to enable more effective learning and adaptation in dynamic environments. Moreover, current control interfaces and mechanisms for humanoid robots often present significant challenges. They can be complex, non-intuitive, and time-consuming to operate, requiring specialized expertise and hindering widespread adoption. This complexity creates a barrier to entry and limits the effective utilization of these advanced platforms. There is an unmet need for more user-friendly control systems that bridge the gap between human operators and robotic capabilities.

Furthermore, limitations in accurately capturing and translating the nuances of human movement and intention via existing interfaces impede performance in tasks requiring fine motor skills or complex decision-making. This gap necessitates advancements in sensor systems and data processing to enable more natural and effective human-robot interaction and control. Safety also remains a critical concern, as current systems may lack robust safeguards against unintended movements or collisions in shared human-robot workspaces, demanding control mechanisms that ensure safety without sacrificing operational flexibility. Therefore, there exists a need in the art for improved systems and methods for controlling and training humanoid robots that overcome the limitations of the prior art regarding adaptability, intuitive control, safety, effective data acquisition for learning, and efficient skill transfer.

### SUMMARY

The presently disclosed subject matter is directed to a humanoid robot teleoperation and data collection system, together with related apparatus, components, computer-implemented methods, and non-transitory computer-readable media storing instructions that, when executed, cause one or more processors to perform the recited steps. The invention captures pilot movement using a wearable training apparatus, drives a humanoid robot through a primary motion mapping, and concurrently provides multi-modal meta-control over the system through input modalities that operate independently of, and in parallel with, the primary motion mapping. Aspects of the invention may be embodied as a teleoperation system, a wearable training apparatus, a humanoid robot, a head-mounted display sub-system, a glove component, a mouth-controller sub-system, a vision sub-system, or as computer-implemented methods for control, calibration, meta-control, data collection, training-data generation, haptic feedback, and clutched fine-adjustment.

In a representative embodiment, the system comprises a wearable training apparatus configured to be worn by a pilot (also referred to as a human operator); a humanoid robot having a plurality of actuators; one or more computing devices configured to receive sensor data from the wearable training apparatus, process the sensor data to generate control data, transmit the control data to the humanoid robot, and concurrently monitor for one or more meta-control inputs; a data storage database configured to collect robot data and synchronized telemetry from the humanoid robot; a clutch coupled to the wearable training apparatus and configured to selectively pause transmission of the control data; and one or more pilot-perceptible feedback channels including a head-mounted display, haptic feedback, audible feedback, and visual feedback. The control architecture supports a primary motion-mapping interface that maps continuous limb movement of the operator to continuous movement of the robot, and a meta-command channel that is monitored concurrently with, and remains independent of, the primary motion mapping. Meta-commands may be executed without producing an observable discontinuity in a commanded trajectory of the robot generated from the primary motion mapping, may be prioritized over conflicting primary motion-mapped movement while permitting non-conflicting primary motion-mapped movement to continue, and may be gated by a clutch state, a duration threshold, a repetition threshold, a movement-direction threshold, a force threshold, a voice-confirmation threshold, or a confidence score generated by a trained classifier.

The wearable training apparatus comprises a base frame configured to be worn on a torso of the pilot, an adjustable harness coupled to the base frame and comprising a back support, shoulder straps, and a waist belt configured to be adjusted to fit the individual pilot, and left and right actuated or passive articulated pilot arms extending from opposing sides of the base frame and configured to move with corresponding arms of the pilot. Each pilot arm comprises a base actuation assembly coupled to the base frame, a medial actuation assembly, a wrist component, and rigid frame links connecting the base actuation assembly to the medial actuation assembly and the medial actuation assembly to the wrist component, the rigid frame links being adjustable to accommodate different pilot physiologies. The base, medial, and wrist assemblies each include at least one actuator with a momentary peak torque between approximately 19.8 and 24.2 N·m, and the actuators are configured to provide haptic feedback to the pilot. A glove component is coupled to each wrist component and is configured to be worn on a hand of the pilot. The glove component comprises an electromagnetic field source configured to create an alternating magnetic field, and a plurality of sensors coupled to the fingers of the glove and configured to detect the field generated by the source so as to determine locations of the fingers relative to the palm of the hand, optionally with six degrees of freedom. The wearable training apparatus may further include onboard processing capacity, local data storage, and wireless communication capabilities including Wi-Fi, Bluetooth, and 5G modalities for collection and transmission of sensor data.

The wearable training apparatus carries a plurality of sensors configured to capture sensor data associated with movements of the apparatus, including a plurality of joint encoders distributed along each pilot arm and configured to measure rotational displacement of associated joints, a wrist inertial measurement unit coupled to the wrist component of each pilot arm and configured to measure orientation, a torso inertial measurement unit coupled to the base frame and configured to establish a torso reference frame providing a ground-truth orientation, and optionally one or more strain gauges. In one minimal configuration, the motion sensors used to compute the wrist poses consist of exactly nine sensors, comprising three joint encoders and one wrist inertial measurement unit per pilot arm together with the single torso inertial measurement unit, such that the pose of each wrist is determined from a total of nine sensors. A computing device, operatively coupled to the joint encoders and the inertial measurement units, is configured to compute, for each wrist, a continuous six-degree-of-freedom pose relative to the torso reference frame by fusing absolute orientation signals from the torso inertial measurement unit with rotational data from the joint encoders and the wrist inertial measurement units. Sensor fusion may comprise Kalman-based filters and orientation-estimation algorithms such as Mahony or Madgwick filters, and may include a complementary filter that combines gyroscope-derived rate-of-change data with accelerometer-derived gravity-vector data, the resulting orientation estimate being combined with joint-angle measurements to produce a corrected wrist orientation in which drift accumulated through inertial integration is reduced by reference to the joint-angle measurements. Sensor data may be captured at frequencies between approximately 50 Hz and 200 kHz, and control data may be generated and transmitted at a control rate between approximately 10 Hz and 10 kHz, the control data being structured as a time-sequenced six-degree-of-freedom pose for each wrist relative to the pilot's torso, or alternatively as a representation of a change between a current pose and a previously determined pose.

A calibration procedure may be performed in which the computing device detects that a pilot wearing the apparatus has assumed a predetermined calibration pose, captures calibration sensor data, processes the calibration sensor data to determine offset values for the plurality of sensors, and stores the offset values for use in subsequent data collection operations. The system may further calibrate the apparatus or its sensors to an operator-specific range of motion, with subsequent meta-gesture and primary-motion recognition performed against the calibrated range.

The humanoid robot comprises a torso housing a plurality of components, left and right arm assemblies coupled to the torso, a head and neck assembly coupled to the torso, a pair of stereoscopic cameras mounted in the head and oriented in a vertical configuration, left and right leg assemblies coupled to the torso, and a whole body controller. Each arm assembly comprises a shoulder actuator, an upper arm assembly comprising an upper humerus with an upper-arm twist actuator and an elbow with an elbow actuator, a lower forearm with a lower-arm twist actuator and a wrist flex actuator, and a wrist with a pivot actuator. The head and neck assembly comprises a head twist actuator configured to enable rotational movement of the head about a vertical axis and a head nod actuator configured to adjust pitch of the head about a horizontal axis. The whole body controller is configured to receive control data from the computing device, generate torque targets and current signals for selected actuators based on the control data, and collect robot data resulting from actuator movements.

The robot's head assembly is configured for unoccluded proprioceptive vision. An upper camera and a lower camera are secured to a rigid robotic head frame in a vertically stacked orientation and are mounted at a fixed downward pitch angle relative to a transverse plane of the head frame. The fixed downward pitch establishes a continuous, unoccluded visual field of view projecting past the physical torso volume of the robot to capture concurrent visual data of a floor surface and the robot's lower extremities, allowing a remote operator to maintain an upright neck posture during locomotion. A telepresence vision system receives vertically aligned stereo image data from the vertical stereo camera pair and executes real-time epipolar-geometry transformations to synthesize a horizontally oriented stereo image pair. The synthesized pair has a horizontal viewpoint separation corresponding to the interpupillary distance of the operator and is displayed through a head-mounted display to provide stereoscopic depth perception, eliminating vergence-accommodation conflict while preserving the structural vertical-edge detection advantages of the robot's vertical camera configuration.

A head-mounted display worn by the pilot includes a stereoscopic display with separate image channels for each eye providing depth perception, the display having a refresh rate of at least 90 Hz and a resolution of at least 1920×1080 pixels per eye. The head-mounted display presents a stereoscopic view captured by the robot's cameras and may further render a user interface comprising selectable user-interface elements that correspond to meta-control functions, together with an augmented reality overlay on a live video feed reflecting changed operational states of the robot. At least one gaze tracking sensor is coupled to the head-mounted display and comprises at least one near-infrared eye-facing camera operating at a frame rate of at least 90 Hz, and at least one near-infrared light source operating at a wavelength between approximately 850 nm and 940 nm to illuminate the eye and create corneal reflections. The computing device determines a pupil-corneal-reflection vector from images of the eye, computes a continuous gaze vector, and estimates a point of regard within the displayed representation of the robot's environment. A target may comprise a rendered user-interface element, a real-world object represented in the head-mounted display from sensor data captured by the humanoid robot, or a part of the humanoid robot represented in the head-mounted display. To prevent unintentional state modifications during passive visual scanning, gaze-driven meta-commands require both an overlap or dwell of the point of regard on the target for a predetermined duration, and an additional confirmation input received from an input modality other than the gaze direction.

A mouth controller worn by the pilot may comprise a sip-and-puff transducer in the form of a pneumatic transducer that measures the velocity, volume, and duration of air-pressure changes, a bite-activated sensor in a mouth guard, an inductive tongue computer interface, or a tongue drive system using a tongue-mounted magnet and an array of magnetic sensors. The computing device classifies mouth-controller data based on measured pressure magnitude, pressure duration, bite force, bite location, or tongue position, and treats the classified data as instantaneous (discrete), continuous, or proportional commands. Transient air-pressure events are mapped to discrete system toggles, while sustained air-pressure levels are mapped to continuous proportional adjustments, allowing the pilot to dynamically adjust whole-body robot posture, including a lean angle or bend angle, while the limbs remain engaged in independent kinematic teleoperation.

A wearable lower-extremity apparatus may contain an array of force-sensitive resistors that measure pressure distribution across the plantar surface of the pilot's feet. The computing device processes the distribution to calculate a continuous center-of-pressure shift along a spatial axis, and proportionally commands the robot to lean or bend at the waist based on the calculated shift. The same apparatus detects transient kinetic spikes corresponding to rapid foot impacts, including heel taps and toe taps, and executes discrete meta-commands in response. Foot-actuated input devices may also be used as a clutch trigger or to issue meta-commands while upper-extremity limb movement is continuously mapped to the robot.

A sensorized glove component detects kinematic hand movements to drive a robotic gripper. One or more digit sensors determine a lateral abduction angle between a first finger and an adjacent digit, and when the abduction angle satisfies a threshold, the computing device executes a predefined system meta-command. The abduction-based meta-command operates orthogonally to the primary flexion and extension mappings used to actuate the gripper. A respective abduction state may be determined for each adjacent pair of digits, the states assembled into a feature vector representing an overall hand pose, and a meta-command selected from a library of meta-commands by reference to the value of the feature vector. Where the robot's end-effector has fewer degrees of freedom than the pilot's hand, for example a parallel gripper lacking independent finger articulation, meta-gestures may comprise finger configurations that are incapable of being replicated by the end-effector.

The system supports concurrent monitoring of additional non-primary input sensors operating independently of the primary motion mapping, including microphones for spoken voice commands and speech-recognition-based meta-commands, foot-actuated pedals and other foot-worn pressure or motion sensors, eye-tracking sensors for gaze-dwell and gaze-confirmation commands, facial-expression sensors and cameras for facial gestures, jaw movement, head nods, head shakes, and shoulder shrugs, facial electromyography sensors, head-motion sensors, tongue or mouth sensors, pressure sensors, buttons, touch sensors, and gesture sensors positioned to receive input from a body part not used as the primary mapped limb. The system may distinguish meta-commands from incidental motion through duration, repetition, direction, force, voice-confirmation, or classifier-confidence thresholds, and may require a confirmation input from a sensor of a different modality than the modality that issued the meta-command.

Meta-commands include, without limitation, engaging or disengaging a robot clutch; activating or deactivating a data collection subsystem; resetting or returning the humanoid robot to a neutral or predetermined home pose; initiating a diagnostic routine; switching robot operational modes; adjusting control-system parameters, including a motion-scaling factor between operator and robot motion, an impedance, stiffness, or compliance profile of a robotic joint, a gripper state, an end-effector tool state, an autonomy state, a speed-scaling state, a camera-view state, a safety state, a robot-assistance state, and a guarded mode that limits robot velocity or applied force; triggering a safety stop; defining virtual fixtures in a robot workspace; initiating a grasp operation or other predetermined motion; adjusting robot lean, robot bend, torso height, torso lean angle, base pose, base stance, or center of gravity without altering the real-time position of an end-effector controlled by the primary motion mapping; navigating the robot toward a target; switching an active viewpoint of a primary camera feed transmitted from the robot; appending an annotation label to captured primary motion data; and storing or recalling a named pose. Predetermined motions may be selected from a library of stored motion primitives indexed by an identifier derived from a non-primary input sensor and parameterized by a current robot pose, end-effector pose, object pose, task state, or user-selected speed.

In a further aspect, a meta-gesture is captured comprising movement of an operator body part that is not mapped to a corresponding movable part of the robot, or that lies outside the kinematic envelope of the robot. Such gestures include movements of operator joints beyond the corresponding range of motion of the robot, finger configurations that the robot cannot replicate, leg or foot movements when the robot lacks lower extremities, head or neck movements when the robot lacks a corresponding articulated joint, facial expressions when the robot lacks facial actuators, limb motion outside a robot-reachable workspace, and arm-crossing movements that would cause physical self-collision in corresponding parts of the robot. To prevent accidental triggering, the meta-gesture may be required to be sustained for a predetermined temporal threshold, exceed a confidence threshold of a gesture classifier, or both. A rapid, high-velocity flinch movement exceeding a normal operational speed limit may be classified as an emergency stop that instantly arrests all robot actuation. Meta-gestures may be matched to a vocabulary of predefined gestures, each mapped to a distinct meta-command, and may be excluded from the primary motion data so that they do not cause unintended robot movement through the primary mapping.

The clutch coupled to the wearable training apparatus is configured to selectively pause transmission of control data. Engagement of the clutch may be initiated by a foot pedal, hand switch, voice command, gaze command, touch sensor, pressure sensor, mouth-actuated sensor, or gesture sensor separate from the wearable apparatus, and may comprise a sustained engagement requiring continuous activation, with disengagement occurring upon release. Upon engagement, the system suspends mapping of limb movement to the robot, maintains the commanded pose of the robot in a robot coordinate frame using a pose-hold controller that actively controls actuators to compensate for gravity and external loads subject to joint, force, torque, speed, and collision-avoidance constraints, and continues to track movement of the operator in a local coordinate frame. The clutch enables ergonomic local-to-global restitution, in that the operator may physically reposition their body into a more ergonomic posture without affecting the robot, and upon disengagement of the clutch a current posture of the operator is assigned as a new tracking origin for subsequent relative movement, effectively ratcheting the motion-derived control commands. Establishment of the new tracking origin may comprise calculating an offset between the current pose of the wearable apparatus and the maintained commanded pose of the robot, aligning a tracked point of the operator with a corresponding point of the robot while preserving orientation, and resuming transmission so that the robot does not jump to an absolute pose at the moment of disengagement; resumption may include blending from the maintained pose to the resumed motion-mapped pose over a ramp time or a velocity-limited transition. Clutch disengagement may also occur automatically when sensors detect that the operator has physically aligned with the new tracking origin, and the system may apply haptic resistance to the wearable apparatus while the clutch is disengaged to physically guide the operator's limbs toward the new origin. The clutch may further engage automatically in response to operator-inattention indicators, including a gaze direction outside a predefined region, removal of a hand from the wearable apparatus, or loss of tracking.

While the clutch is engaged, the system may enable input from one or more secondary control devices worn or carried by the operator, including a smartwatch, a smart ring having one or more inertial sensors, a forearm-mounted flexible display, a discrete physical controller comprising a directional pad, joystick, or dial, a voice-spoken numeric value, or a projector device that projects a user interface onto a surface together with a paired camera that detects pilot interaction with the projected interface. The secondary device transmits a fine-tuning input that modifies a robot joint angle, end-effector coordinate, tool-center-point offset, or posture parameter independently of the suspended motion-derived control data. Adjustments may be applied as precise, mathematically predefined increments selected based on input duration, force, displacement, repetition count, or selected adjustment resolution. While the clutch is engaged, multiple meta-commands may be accepted and executed in sequence prior to disengagement, the commanded pose may be saved to a named-pose memory in response to a save input for later recall, and a simulated ghost robot may be displayed to preview the effects of the fine-adjustment input before execution. A visual or audible indicator distinguishes the clutched state from the unclutched state and may indicate the maintained commanded pose, a current pose of the wearable apparatus, the new tracking origin, or a predicted post-disengagement pose. Spatial computing interfaces, including augmented reality or virtual reality menus, may also be presented for clutch-gated meta-command selection.

In another aspect, the wearable data collection apparatus and the humanoid robot may include corresponding sensing components selected to produce matched sensor-domain signals for corresponding degrees of freedom, the corresponding sensing components comprising at least one matched pair of optical encoders, magnetic encoders, or inertial measurement units that consist of identical silicon hardware models exhibiting matching thermal-drift characteristics and baseline noise densities. Captured pilot movement data is packaged into a training-data representation usable by a robot control model and is directly insertable into a robotic neural-network training space without applying software-based domain adaptation to compensate for sensor hardware discrepancies between a first sensor technology domain and a different second sensor technology domain.

The data collection subsystem records, in a synchronized and time-aligned manner, primary motion data derived from the primary motion-mapping interface, corresponding robot state data, sensor data, video data, audio data, command labels, task-event labels, the meta-gesture or meta-command, and a time-stamped indication thereof. Records are stored in the data storage database structured for use as training data for a machine learning model, including imitation-learning policies for autonomous operation. Toggling data collection may cause synchronized storage to begin and may cryptographically tag the resulting telemetry dataset for use in training. Annotation labels, including operator-provided semantic labels for primary motion data immediately preceding clutch engagement, may be appended in response to a meta-gesture or meta-command, thereby categorizing the data for a specific robotic task. The system supports later playback, audit, and imitation-learning use of the recorded data.

In a related aspect, a method for haptic feedback comprises receiving robot data from the humanoid robot at the wearable training apparatus, processing the robot data to generate haptic feedback data, and actuating at least one actuator of the left and right pilot arms to provide haptic feedback to the pilot based on forces experienced by the humanoid robot. Distinct haptic notifications may confirm successful execution of a meta-command. The system may further provide audible or visual feedback, including a change in resistance of the primary motion-mapping interface, prior to or contemporaneously with execution of a meta-command. Augmented reality overlays on the live video feed may update to reflect changed operational states of the robot.

The system evaluates identified meta-commands and primary motion commands against a pre-programmed safety envelope and may block, modify, delay, or request confirmation of a command when execution would violate a workspace limit, speed limit, force limit, collision limit, joint limit, prohibited workspace, protected object, or task-specific safety limit, or would conflict with a current task state. Meta-commands may be executed according to a priority rule giving them precedence over conflicting primary motion-mapped movement while permitting non-conflicting motion to continue. Predetermined motions executed as meta-commands, such as automated grasping sequences, may temporarily suspend the primary motion mapping for a specific gripper to complete the sequence before returning control of the gripper to the operator. Recognition of a meta-gesture may further require duration thresholds, repetition thresholds, classifier-confidence thresholds, or multi-modal cross-confirmation, and meta-gestures and primary motion data may be derived from distinct sensor streams that do not contribute to one another. Continuous parameters encoded in a meta-gesture may modulate an operational parameter of the robot in proportion to the parameter.

The disclosure further encompasses computer-implemented methods corresponding to each of the foregoing systems, including methods for capturing sensor data from the wearable training apparatus and transmitting the sensor data to a computer; processing the sensor data to generate control data and transmitting the control data to the humanoid robot; actuating the robot's actuators based on the control data; collecting robot data into a data storage database; displaying a stereoscopic view captured by the robot's cameras on the head-mounted display; providing haptic feedback to the pilot; monitoring at least one sensor for a movement or interaction not corresponding to a controlled robot body component, detecting commands therefrom, and performing the detected commands in parallel with primary motion-control routines, where the meta-operation does not directly control a primary kinematic chain or end-effector motion of the humanoid robot; executing supervisory meta-commands using gaze tracking with deliberate secondary confirmation; classifying intraoral input as instantaneous, continuous, or proportional commands; governing robotic balance and posture using bimodal plantar pressure control; expanding the command vocabulary using orthogonal finger-abduction gestures; performing clutch-gated secondary fine-tuning via wearable computing devices; generating deterministically consistent training data through hardware-symmetric pipelines; and managing operator fatigue using ergonomic local-to-global clutch restitution. The methods may be embodied in non-transitory computer-readable media storing instructions that, when executed, cause one or more processors to perform the recited steps.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8 is a block diagram of an onboard artificial intelligence (AI) system for the humanoid robot of FIGS. 1-3B;

FIG. 9 is a schematic diagram of a humanoid robot data collection system including: (i) a humanoid robot, (ii) a mobile data collection apparatus, (iii) data storage, (iv) a secondary computer, (v) a display, and (vi) an optional clutch in communication directly or via a network;

FIG. 10 is a diagram showing an open loop connection between the operator wearing the wearable training apparatus and the robot of FIG. 9;

FIG. 11 is a diagram illustrating a stereoscopic interface that may be provided to the pilot wearing the wearable training apparatus while operating the robot of FIGS. 1-3B;

FIG. 12 is a simplified flow diagram illustrating a meta-control method for the robot of FIGS. 1-3B;

FIG. 13 is a diagram illustrating an interface with selectable user interface elements that may be provided to the pilot wearing the wearable training apparatus while operating the robot of FIGS. 1-3B in connection with the meta-control method of FIG. 12;

FIGS. 14-17 are diagrams illustrating additional control devices that may be used by the pilot wearing the wearable training apparatus while operating the robot of FIGS. 1-3B in connection with the meta-control method of FIG. 12; and

FIG. 18 is a schematic diagram illustrating gestural interactions that may be performed by the pilot wearing the wearable training apparatus while operating the robot of FIGS. 1-3B in connection with the meta-control method of FIG. 12.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. INTRODUCTION

General-purpose humanoid robots emulate human form and functionality with two legs, two arms, and a face-like screen. With the general-purpose humanoid robot's emulation of the human body, arises the necessity for torso and arm assemblies that can closely replicate human movements, capabilities, and structural nuances. The need for the torso and arm assemblies to be capable of mimicking human structure and functions extends far beyond cosmetic resemblance. For example, it is also desirable that the torso and arm assemblies enable the end effector of the robot to be able to seamlessly interact with and physically manipulate diverse objects in complex environments while performing in a durable, cost-effective, and controllable manner using the robot's limited resources, including its battery power resources.

To enable the humanoid robot to seamlessly interact with and physically manipulate diverse objects in complex environments, data needs to be collected to train the artificial intelligence-based models that are running on the computer that are either local to the robot, remote to the robot, and/or a combination of both. To collect the above-described data, this Application describes a unique robot data collection system that includes a wearable training apparatus configured to be worn by a human user or pilot and is designed to control the robot to perform a given task or command. The collected data may include sensor data that relates to the movement of the pilot's wrist or hand. In particular, the wearable training apparatus may be designed to capture sensor data related to: (i) position and movement of the torso position (e.g., twist or bend at the waist and location within a space), and/or (ii) position and movement of the arm, wherein said arm may include the pilot's shoulder, elbow, wrist, and hand (e.g., fingers and thumb). While collecting additional data about the shoulder or elbow position may be helpful in training the robot, it should be understood that the systems disclosed herein may only collect wrist and a portion of the hand data, or wrist and all hand data.

The humanoid robot data collection system, including the wearable training apparatus, is configured to capture robot data from a robot that is controlled by the human pilot using the wearable training apparatus. The humanoid robot data collection system can also be used to collect data and provide haptic feedback to a pilot in a simulated environment. If the system is being used to control a robot to collect robot data, then: (i) the wearable training apparatus is configured to transfer sensor data from the wearable training apparatus to a computer, (ii) the computer processes the sensor data to generate control data and sends control data to the robot in real-time, (iii) then a data storage database collects robot data from sensors contained on the robot that relate to the positions and movements of said robot to refine and annotate the robot data into training data. The wearable training apparatus provides substantial benefits over conventional systems because it is portable, lightweight, can quickly be manufactured, and is less expensive than other conventional apparatus. For example, the wearable training apparatus allows the pilot to collect data while performing actual tasks that the robot may perform by minimizing the footprint and eliminating a complicated walking base, additional wires, or other electrical components.

Certain embodiments of the wearable training apparatus includes (i) a base frame having an adjustable harness coupled thereto, (ii) left and right actuated pilot arms that extend from opposing sides of the base frame on each side, (iii) a plurality of sensors configured to capture sensor data associated with movements of the wearable training apparatus, and (iv) a piloting control system including a computing device and operatively connected to the sensors and actuators of the actuated pilot arms. Each actuated pilot arm includes (i) a base actuation assembly coupled to the wearable base frame, (ii) a medial actuation assembly, (iii) a wrist component, (iv) a glove component suitable to be worn by the pilot and coupled to the wrist component, and (v) first and second frame links that extend between the base actuation assembly and the medial actuation assembly, and the medial actuation assembly and the wrist component. The wrist component of each actuated pilot arm provides six degrees of freedom to track the delta between the positions and orientations of the pilot's wrists.

In certain embodiments disclosed herein, the arm framework (i.e. first and second arm links) is not fixed. In other words, the arm framework can be adjusted to fit the human properly and is ergonomic for the pilot. The design allows the pilot to perform repetitive tasks and collect significant data needed to train the robot without overly straining the pilot during the collection of data. In contrast, other embodiments disclosed do not allow for adjustment of the linkages or distances between encoders. Further, other disclosed embodiments may be custom manufactured (e.g., 3D printed) or custom modified for a specific pilot based on measurements or a scan (e.g., LiDAR or video).

In some embodiments disclosed herein, the humanoid robot data collection system also includes a clutch coupled to the wearable training apparatus to allow the pilot to pause sending control data from the computer to the robot. The clutch permits the pilot to reposition their hands to a more comfortable or natural position before resuming the operation of the wearable training apparatus. This prevents the hands of the robot from replicating all of the hand motions of the pilot, for example when the pilot is repositioning their hands.

A majority of robot data that is captured can be directly added to the training data set without substantial review and multiple manipulations or alterations of the robot data. This simplifies training data collection, data labeling, and allows breaking a task down into sub-steps, where certain aspects of the training data may be reused for other tasks. For example, in a factory environment for assembling automobiles, the task may include moving one piece of sheet metal in a factory line requiring a first set of movements, then moving a second piece of sheet metal in the factory line requiring a second set of movements, wherein a substantial number (e.g. 80%) of the first and second sets of movements are the same.

The sensors of the wearable training apparatus are fixed to components of the wearable training apparatus and are not placed by the pilot. This eliminates the misplacement or substantial changes to the location of the sensors between pilots. For example, the sensors may include encoders of each actuator and inertial measurement units (IM) coupled to the wearable training apparatus at and the wrist components and the torso (i.e. at the back frame). The wearable training apparatus also uses only four sensors for each arm, or nine sensors in total. This allows for more accurate and simplified training data collection.

The wearable training apparatus is a cost-effective solution that does not require a complex design for training data capture. The wearable training apparatus simplifies training data collection and does not require a substantial number of additional external sensors or detection devices. The wearable training apparatus does not require an extensive camera setup with the proper lighting that is typically required by conventional camera systems. Because the sensor data is collected by the pilot wearing the wearable training apparatus, there are no black-out spots that are created due to machines or other structures found in a training environment. For similar reasons, the wearable training apparatus does not require a quiet environment needed for an acoustic sensor system.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

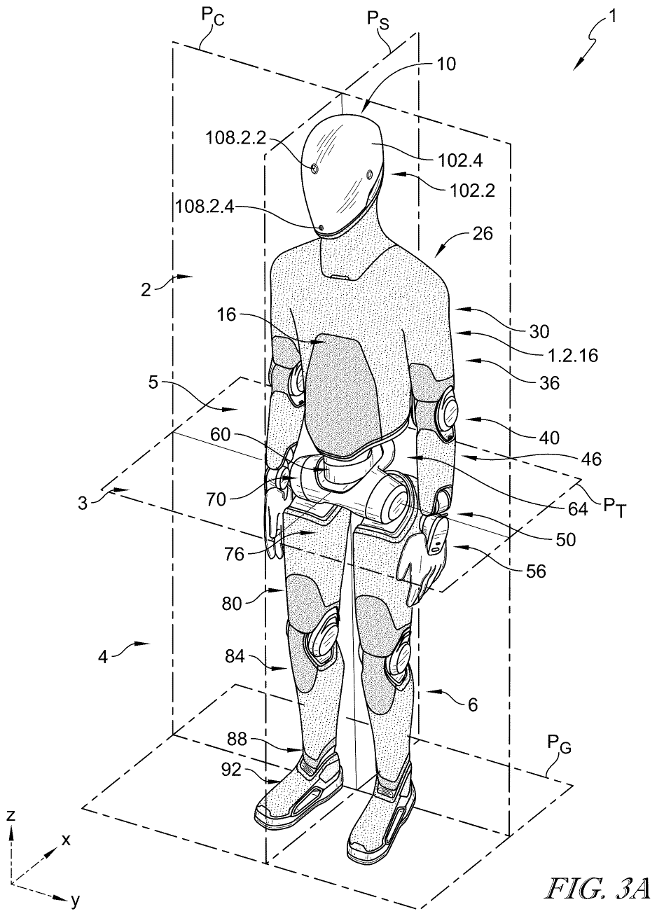

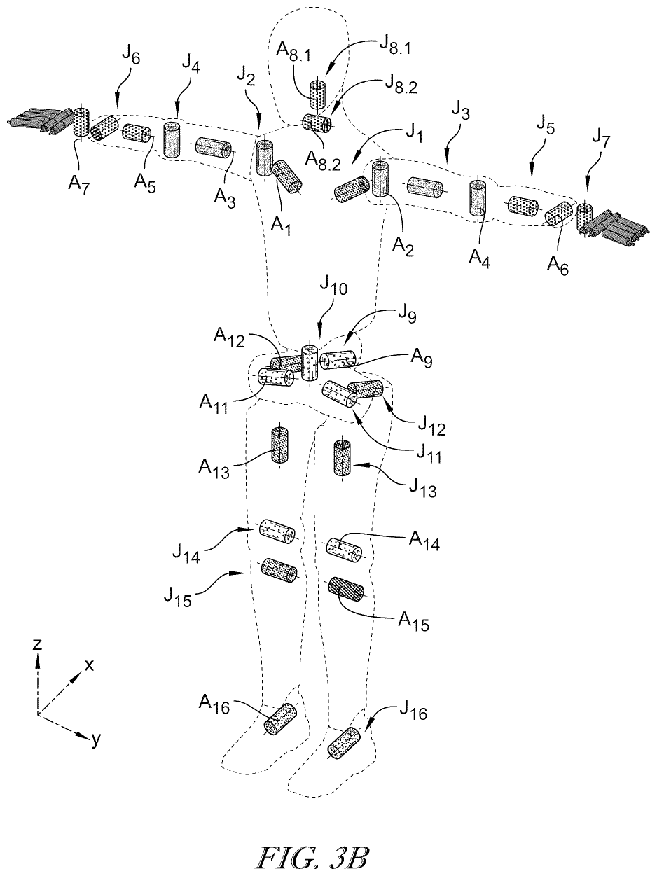

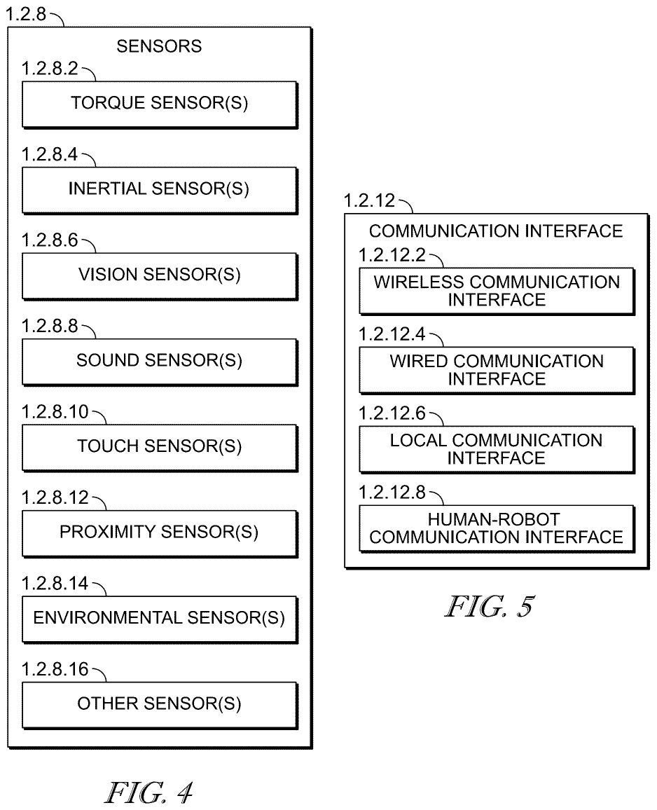

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (A₁) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. ROBOT(S) AND ENVIRONMENT

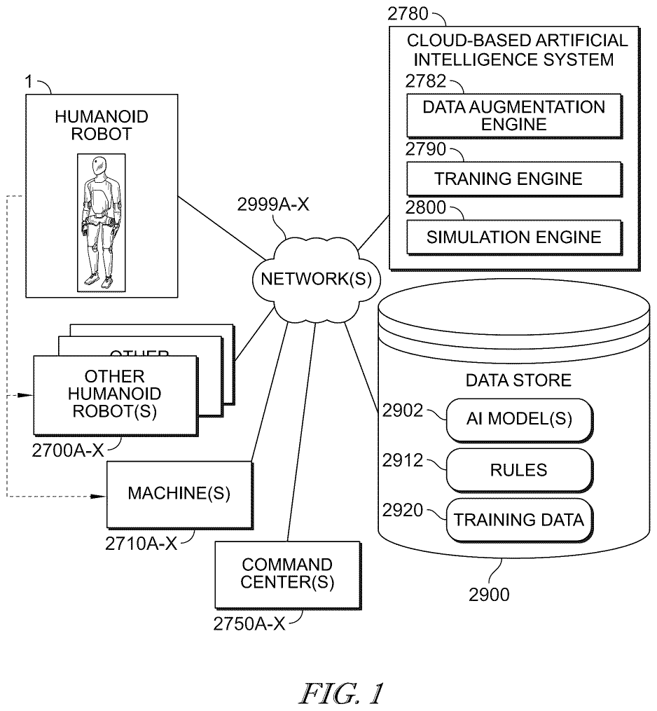

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of vision data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

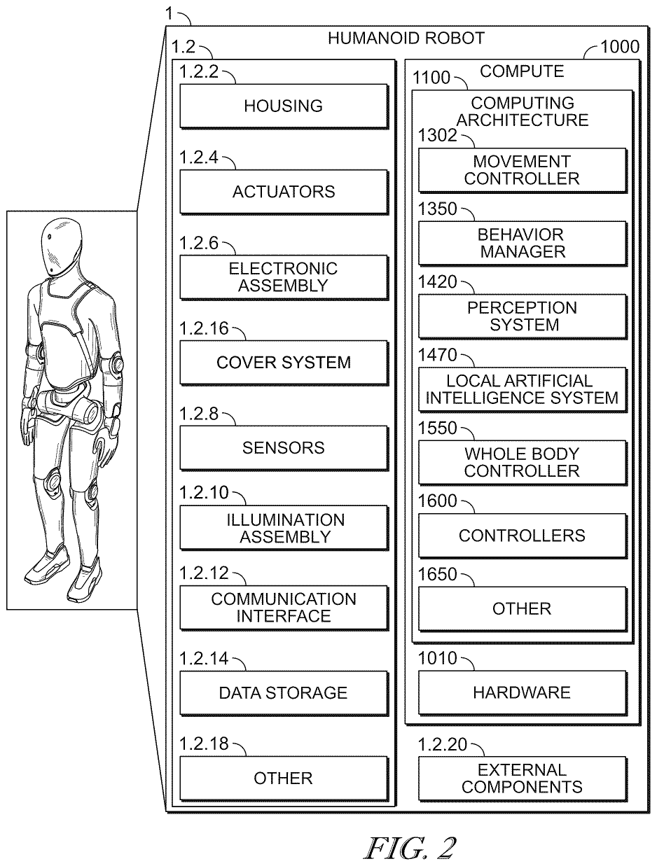

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane (P_{S}) but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane (P_{S}). This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from vision and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 includes various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies 5 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 2

| | | Actuator | | |
|---|---|---|---|---|
| Actuator | Qty | Name | Informal Actuator Name(s) | Axis |
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand | A₆ |
| | | | pitch, flick | |
| (J7) 520 | 2 | wrist pivot | wrist/hand z, wrist/hand | A₇ |
| | | | yaw, wave | |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, | A₁₁ |
| | | | forward kick | |
| (J12) 768 | 2 | hip roll | hip x, hip/leg roll, | A₁₂ |
| | | | sideways kick | |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear | |
| | | | kick | |
| (J15) 860 | 2 | foot flex | foot y, foot pitch, or | A₁₅ |
| | | | first ankle | |
| (J16) 900 | 2 | foot roll | talus, foot roll, foot x, | A₁₆ |
| | | | second ankle | |

It should be understood that in other embodiments, some of these systems, assemblies, components, and/or parts may be omitted, combined, or replaced with alternative systems, assemblies, components, and/or parts.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

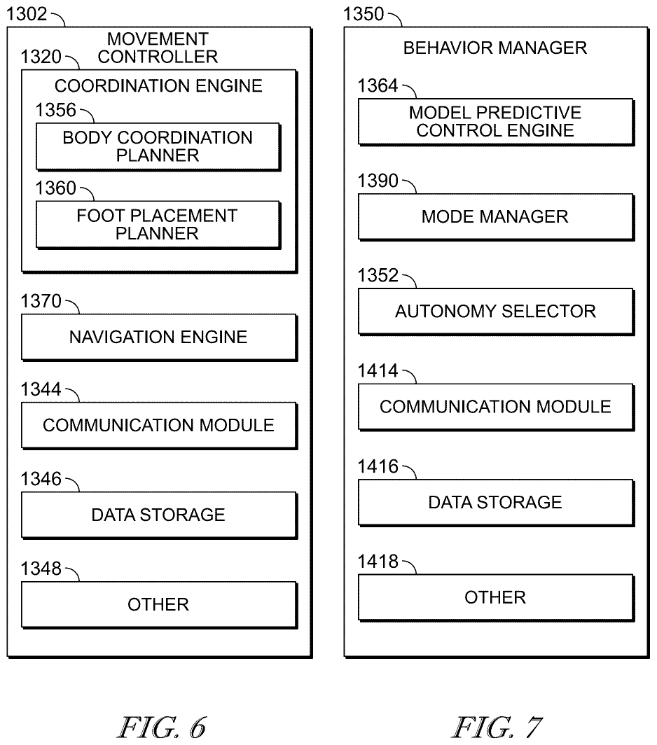

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

### 2. Behavior Manager

Referring to FIG. 7, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several critical technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Overtime, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470.

4. Local AI system

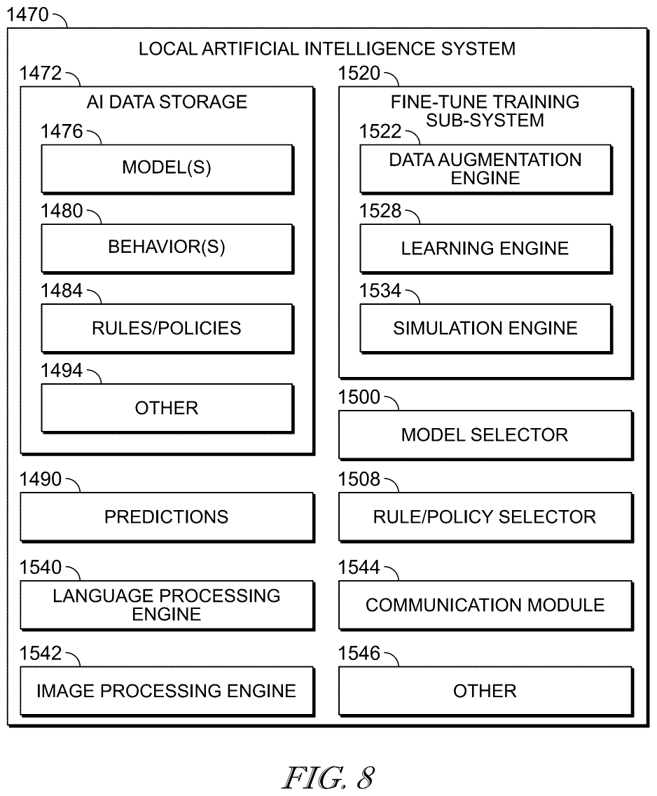

The local AI system 1470 may be embodied as any combination of hardware, software, or circuitry to drive semi- to fully-autonomous perception, learning, and behavior by the humanoid robot 1. The local AI system 1470 may: (i) include modes or architectures that are run on the disclosed local AI system 1470 only, (ii) include models or architectures where a portion of the model or architecture is run on the local AI system 1470 and another portion of the model or architecture is run on the remote AI system 2780, and (iii) include modes or architectures that are run on the disclosed remote AI system 2780 only. The local AI system 1470 is described in further detail relative to FIG. 8.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600). As such, in some embodiments, the compute 1000 may only include or primarily include the local AI system 1470. In other words, the local AI system 1470 may not be considered a separate component or system, but instead an integral component of other systems contained within the compute 1000. Thus, a primary technical issue solved by the local AI system 1470 is the challenge of real-time, context-aware decision-making. Traditional robotic systems often rely on pre-programmed responses or remote processing, which can lead to delays or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including vision, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that critical processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech. The image processing engine 1542 may be embodied as any combination of hardware, software, or circuitry for performing object detection, image classification, segmentation, object tracking, facial recognition, scene understanding, depth estimation, anomaly detection, or reinforcement learning on input vision data (e.g., as obtained by sensors 1.2.8 such as cameras or in preloaded training data).

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other 1546 may include a communications module that is embodied as any combination of hardware, software, and/or circuitry to enable components of the local AI system 1470 to communicate with one another and with other components of the humanoid robot 1 (such as of the compute 1000). It should be understood that the controllers may be omitted and/or consumed by one or more models (e.g., RL trained models) that are contained within the local AI system 1470.

### 5. Whole Body Controller

The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### 6. Other

Other components 1650 of the compute 1000 may include components not discussed above relative to the compute 1000, such as power management modules (e.g., to manage battery pack health, manage power usage profiles, etc.) and calibration modules (e.g., to ensure that actual kinetic movements of the humanoid robot 1 align with the expected kinetic movements determined based on calculations). The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices.

### E. HUMANOID ROBOT DATA COLLECTION SYSTEM

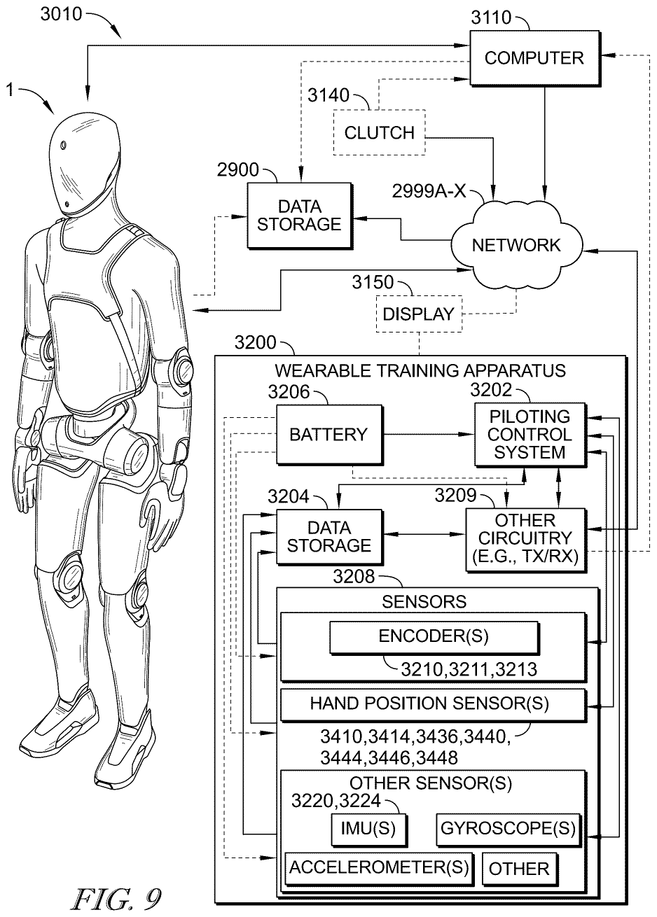

As best illustrated in FIG. 9, the humanoid robot data collection system 3010 may include: (i) a mobile data collection apparatus 3200 (also referred to herein as the wearable training apparatus 3200), (ii) a computer 3110, (iii) a data storage database 2900, (iv) a clutch 3140, (v) a display 3150, which may be a headset device, and/or (vi) the robot 1 in data communication via a network 2999A-X. The data collection system 3010 includes a mobile data collection apparatus 3200 to be worn by an operator (also referred to as a pilot 2, user, teleoperator, data collector, apparatus wearer, or human operator) to collect pilot movement data associated with the operator's movements. This pilot movement data may be utilized by a robot 1 for training models and executing teleoperation tasks. The pilot movement data may be stored locally within data storage 3204 on the apparatus 3200, stored remotely in the data storage database 2900, and/or transmitted in real-time to the robot 1 through the network 2999A-X. This data may be incorporated into training data of the robot 1 to be utilized to perform tasks in the operational environment, including manipulation tasks, locomotion patterns, and complex multi-step procedures.

The data collection system 3010 is designed to collect data derived from the movements of the operator while performing various tasks and activities. Specifically, while wearing the apparatus 3200, the operator generates pilot movement data that may include or relate to: (i) the position and/or movement of the operator in space while performing a task, including translational and rotational components in three-dimensional space, (ii) the relative spatial locations of anatomical joint centers of rotation, including shoulder, hip, elbow, knee, wrist, ankle, and/or finger joints, (iii) the velocity and acceleration profiles of each tracked body segment, and/or (iv) any other data about the operator that is relevant to the control and training process (e.g., grip force patterns, hand orientation trajectories, or movement timing sequences). The pilot movement data may be captured at sampling rates ranging from 1 Hz to 10 kHz, with higher sampling rates providing finer temporal resolution for rapid movements. In some embodiments, the sampling rate may be dynamically adjusted based on the detected movement velocity or task complexity to optimize data quality while managing storage and bandwidth constraints. The mobile data collection apparatus 3200 is free of dependence on external optical tracking infrastructure, line-of-sight markers, or fixed cameras placed within the operating environment, such that the apparatus 3200 captures pilot movement data through body-coupled sensing components alone.

This pilot movement data may encompass: (a) the position and movement of the operator's torso, including actions such as twisting or bending at the waist with angular measurements in roll, pitch, and yaw axes, and the operator's location within a training environment tracked through both relative and absolute positioning methods, (b) the position and movement of the arms of the operator, where such tracking may detail the operator's shoulder motion, elbow flexion and extension, wrist pose (defined by both position and orientation) in six degrees of freedom, and hand or finger gestures, which can be captured via gloves 3400 coupled to the mobile data collection apparatus 3200 or other sensors with sufficient resolution to distinguish individual finger movements (e.g., each joint) of the operator, and/or (c) the position and movement of the legs of the operator, where such tracking may detail the operator's hip motion, knee flexion and extension, ankle pose (defined by both position and orientation) in six degrees of freedom. In alternative embodiments, the pilot movement data may also include head position and orientation data captured through sensors integrated into the display 3150 or through separate head-mounted sensors. The tracking of leg movements may enable full-body teleoperation scenarios where the robot 1 replicates both upper and lower body motions of the operator. In a further alternative embodiment, the pilot movement data may include physiological signals derived from sensors integrated into the apparatus 3200, such as electromyography signals indicative of muscle activation patterns, where these signals supplement the kinematic data with intent or effort information.

The pilot movement data can be captured by the mobile data collection apparatus 3200 as sensor data, which may then be transferred to another component for further processing or storage through various communication protocols. This recipient component may be: (i) a remote computer (e.g., a command center 2750) connected via wireless or wired networks, (ii) the computer 3110 integrated with or separate from the apparatus 3200, or (iii) another computing system or architecture, such as the whole body controller (WBC) 1550 operating on compute 1000 of the robot 1. This data transfer enables the execution of instructions to generate robot control data or log data for training purposes, such as training the robot 1 itself through supervised learning methods, or training models like Bipedal Action Models (BAMs) for use in controlling the robot 1. The data transfer may occur at various rates depending on the application requirements, ranging from batch transfers for offline training to real-time streaming for teleoperation. In some embodiments, the data transfer may employ data compression algorithms to reduce bandwidth requirements while preserving data fidelity for time-sensitive teleoperation applications.

The disclosed data collection system 3010 is a cost-effective solution that may not require an overly complex mechanical design to achieve robust human data capture while maintaining high fidelity in motion tracking. This type of data collection system 3010 simplifies the overall data collection process when compared to some alternatives and may not require a substantial number of additional external sensors or environmental detection devices, such as the external cameras often utilized for tracking in traditional motion capture systems. For example, the data collection system 3010 does not inherently require an extensive external camera setup that necessitates controlled lighting, which is a common requirement for purely vision-based motion capture systems that rely on optical markers. Because the primary positional data is collected through integrated sensors directly coupled to the operator wearing the mobile data collection apparatus 3200, there are generally no line-of-sight occlusion or “black-out” spots created by machines, furniture, or other structures present in the training environment. This can be a significant problem for external camera-based systems where occlusions may result in data loss or interpolation errors. In addition to avoiding such black-outs, the disclosed system is less expensive than highly complex, large-scale motion capture setups that require dedicated facilities and extensive calibration procedures. Unlike conventional approaches, the data collection system 3010 captures continuous kinematic data through localized joint measurement coupled to the operator's body, free of reliance on a calibrated motion-capture volume.

The data collection system 3010 includes onboard sensors integrated directly into the wearable structure, and thus generally does not require a quiet acoustic environment. Additionally, the apparatus 3200 is designed to be portable as it is worn by the operator, relatively lightweight in comparison to full exoskeletons, and quicker to manufacture due to simpler mechanics than a full force-feedback exoskeleton which may require complex actuator assemblies. Further, the data collection system 3010 minimizes the infrastructure footprint when compared to fixed base systems and can eliminate the need for a complicated walking base simulator, numerous external wires that may restrict movement, or extensive external tracking components such as ceiling-mounted camera arrays. As a result, a large quantity of pilot movement data can be collected at a relatively low cost per hour, and this data can be used for training the robot control models (e.g., machine learning, BAM models). The portability of the apparatus 3200 also enables data collection in diverse environments, including outdoor settings, industrial facilities, and confined spaces that would be impractical for fixed motion capture installations.

a. Computing Environment

As shown in FIG. 9, the humanoid robot data collection system 3010 includes a mobile data collection apparatus 3200, a computer 3110, a data storage database 2900, 3204, a clutch 3140, and the robot 1, which are in data communication with each other via a network 2999A-X. The mobile data collection apparatus 3200 is configured to be worn by a human operator to collect and send sensor data to be received and processed by computer 3110. The processed control data is sent from the computer 3110 to the robot 1 via the network 2999A-X for execution by the robot's control systems. The mobile data collection apparatus 3200 can communicate with the computer 3110 via the network 2999A-X. In some embodiments, the mobile data collection apparatus 3200 can communicate directly with the robot 1 via the network 2999A-X, bypassing the computer 3110 for reduced latency applications. In this embodiment, the computer 3110 may be integrated into: (i) the mobile data collection apparatus 3200 and/or (ii) robot 1.

The robot 1 includes a whole body controller (WBC) 1550 that is configured to receive and process control data derived from the mobile data collection apparatus 3200 through kinematic transformation and motion planning algorithms. The WBC 1550 also generates torque targets and current signals for selected actuators (J1-J7) for movement of the actuators (J1-J7). The WBC 1550 further collects robot data from the movement of the actuators (J1-J7) and communicates the robot data to the data storage database 3204 for later training use. The WBC 1550 of the robot 1 can communicate with the computer 3110 via the network 2999A-X to receive and process the control data that is derived from the sensor data that was obtained from the mobile data collection apparatus 3200. The WBC 1550 of the robot 1 can also communicate with the data storage database 3204 collected robot data for training a neural network model and/or running a data collection application to train a neural network. In some embodiments, the WBC 1550 of the robot 1 and the piloting control system 3202 of the mobile data collection apparatus 3200 form a closed teleoperation-to-training data loop, in which time-aligned operator-intent signals captured by the apparatus 3200 and robot-execution signals captured at the actuators (J1-J7) are stored in the data storage database 3204 in a common signal frame, allowing the stored entries to populate the training data corpus under a single calibration and signal-conditioning configuration.

i. Computer

The computer 3110 may comprise, for example, a server computer, a secondary computer, or any other system providing computing capability suitable for real-time data processing. Alternatively, the computer 3110 may comprise a plurality of computing devices that may be arranged, for example, in one or more server banks or computer banks or other arrangements. Such computing devices may be located in a single installation or may be distributed among many different geographical locations for redundancy and load balancing. The computer 3110 can include technology that trains a neural network model and/or run a data collection application to train a neural network. In a further embodiment, the computer 3110 is configured as an edge computing node co-located with the operator and the robot 1 such that end-to-end signal latency from operator motion to robot actuator command is held within an interval that supports continuous closed-loop teleoperation.

The data collection system 3010 may also include a computer system 3110 that is designed to process the sensor data at rates of 100-1000 Hz in order to generate robot data that can be sent to the robot's whole body controller 1550 in order to allow for the mobile data collection apparatus 3200 to control the robot 1 or cause the robot 1 to mimic the movements of operator with latencies under 50 ms. In addition to performing this data generation function with computational throughputs of 1-10 GFLOPS, the computer system 3110 may perform additional functionalities associated with data collection and storage, some of which may include using filtering algorithms such as Butterworth or Chebyshev filters with cutoff frequencies of 10-100 Hz, compression algorithms achieving compression ratios of 10:1 to 100:1, or other data manipulation methods or algorithms including outlier detection and removal. The computer system 3110 may also implement zero-velocity update detection during stationary intervals and magnetometer-based heading correction within the sensor fusion pipeline, such that long-duration drift in the operator pose data remains bounded across teleoperation sessions of arbitrary length.

The computer system 3110 may comprise various computing architectures to perform its intended functions with appropriate performance characteristics. Examples of such architectures include a server computer with multi-core processors, a secondary computer with GPU acceleration, or any other system that provides suitable computing capability of 10-100 TFLOPS for real-time processing. In some implementations, the computer system 3110 may comprise a distributed computing environment, which incorporates a plurality of interconnected computing devices communicating through high-speed networks. These computing devices may be arranged in various configurations, such as in server banks with blade servers, computer banks with rack-mounted systems, or other suitable distributed architectures supporting horizontal scaling. The computing devices may be co-located in a single physical installation with dedicated cooling and power infrastructure, or they may be distributed across multiple geographical locations connected through wide-area networks. This architecture might be implemented as an edge compute node with processors such as NVIDIA Jetson or Intel NUC that is situated geographically close to the robot 1 and the operator in order to minimize network latency to under 5 ms. Alternatively, it could be integrated partially or wholly within the robot 1 itself using the robot's onboard computing resources or within the apparatus 3200 for latency-sensitive image transformation tasks, depending on the chosen processing architecture and power constraints. Sometimes, the computer system 3110 may be deployed on the edge, for instance, as part of the processor and computing architecture of the robot 1 with shared memory architectures. In yet other embodiments, one or more of the operations and/or processes that are performed by the computer system 3110 may be performed by processors and/or an edge computing architecture of the robot 1, thereby improving processing efficiency by 30-50% and the use of computational resources across the disclosed technology as a whole through load balancing and task distribution.

ii. Clutch

The data collection system 3010 may include an optional clutch 3140 (also referred to herein as the robot clutch 3140) that is designed to allow the operator to selectively pause the transmission of robot control data from the computer 3110 to the robot 1. This robot control data is derived from sensor data, which in turn was derived from the collected human data processed through the kinematic mapping algorithms. This feature may allow the operator to reposition their hands or body to a more ergonomic or natural position without causing unintended movements of the robot 1, preventing potential collisions or task errors, before they resume operation of the mobile data collection apparatus 3200. By implementing this pause functionality with software and hardware interlocks, the system 3010 may prevent the unintended hand motions of the operator, which can occur during such repositioning over periods of 1-10 seconds, from being translated into corresponding movements of the hands 56 or other parts of the robot 1.

The operator may activate the clutch 3140, for example, by using their hand to press a button with actuation forces of 2-10 N, to temporarily suspend the transmission of the robot control data that is related to certain degrees of freedom. In some configurations, the clutch 3140 may be configured to suspend transmission for all degrees of freedom simultaneously through a master enable/disable signal. In other configurations, it may be set to suspend transmission for only a predefined subset of degrees of freedom, such as only the arm movements (suspending joints J1-J7), while leaving the head tracking active to maintain the situational awareness of the operator through continuous visual feedback. Upon the release or deactivation of the clutch 3140, the mobile data collection apparatus 3200 and the computer 3110 may resume the process of generating and transmitting the robot control data with smooth trajectory blending. The resumption of this control data transmission may be immediate with latencies under 50 ms, or it may incorporate a brief ramping period of 0.5-2 seconds to ensure the smooth re-engagement of the motion of the robot 1 using velocity and acceleration limits. The smooth trajectory blend on release of the clutch 3140 may be implemented by applying a velocity-limited and acceleration-limited interpolation between (i) a state of the robot actuator at a moment of release of the clutch 3140 and (ii) an operator-derived target actuator state currently indicated by the wearable training apparatus 3200, such that commanded velocity of each affected actuator increases monotonically from zero to an operator-derived velocity target, subject to a configured velocity ceiling and a configured acceleration ceiling. The clutch 3140 is free of any requirement to halt all robot degrees of freedom simultaneously, in that the configurable per-degree-of-freedom suspension permits continued teleoperation of the unsuspended degrees of freedom during the clutched interval.

The clutch 3140 may be implemented in various physical forms, such as a button with tactile feedback, a switch with definitive positions, a trigger mechanism with proportional control, or another type of operator-actuated device that is integrated directly into the mobile data collection apparatus 3200, for example, on a hand-held component with ergonomic placement or on the main body of the mobile data collection apparatus 3200 within easy reach. This integration may allow the operator to selectively engage and disengage the clutch 3140 with one or both hands as appropriate during the performance of a task. For instance, a pressure-sensitive grip on a handheld controller with force thresholds of 5-20 N could be configured to function as the clutch 3140, disengaging control whenever the operator relaxes their grip below the threshold.

In alternative embodiments, the clutch 3140 may be implemented as a separate, discrete device with wireless or wired connectivity. For example, the clutch 3140 could take the form of a foot pedal with adjustable resistance that is coupled to the computer 3110 and positioned on the floor for foot activation by the operator, or it could be made accessible to another supervising operator through a control panel. A supervising operator might utilize such a separate clutch 3140 to intervene in the operation for safety with emergency stop capabilities or for training purposes during skill transfer sessions. Alternative methods for clutch activation could involve the use of voice commands that are recognized by the system 3010 with recognition accuracies above 95%, gesture recognition that is performed using the sensors 3208 on the apparatus 3200 with gesture libraries of 10-50 commands, or even a predictive clutch engagement system using machine learning models. For example, a specific spoken phrase like “Pause robot” processed through speech recognition could activate the clutch 3140, and the phrase “Resume robot” could deactivate it with voice activation latencies under 500 ms.

Predictive engagement of the clutch 3140 might function based on detecting movement patterns that are indicative of non-task-related actions through anomaly detection algorithms, for example, large, rapid repositioning movements of the operator that fall outside the typical workspace (exceeding 1 meter) or velocity profile (exceeding 2 m/s) of the task being performed. A software-based clutch interface, which could be presented on the display 3150 or on an auxiliary screen with touch or gaze interaction, could also allow for activation through gaze control with dwell times of 0.5-2 seconds or through interaction with a tracked controller that is associated with the VR headset. The display 3150 could present a virtual button with visual feedback that the operator selects either via gaze dwell time or by pointing at it with a controller tracked at 90-120 Hz.

The clutch 3140, whether it is implemented as a physical or a virtual device, may incorporate advanced haptic feedback technologies providing multi-modal sensory confirmation. This haptic feedback could provide the operator with a tactile confirmation, such as a click with forces of 2-5 N, a vibration at frequencies of 100-300 Hz, or a change in resistance from 10 N to 30 N, that indicates the successful engagement and disengagement of the clutch 3140. Such feedback enhances the confidence of the operator and improves the overall usability of the system 3010 with user satisfaction scores improving by 15-25%. Additionally, the system 3010 may implement an intelligent clutch behavior, which could be managed by a dedicated intelligent clutch module running at 100-500 Hz. This intelligent clutch module might use machine learning algorithms trained on datasets of 103 to 105 operator interactions to analyze the movements of the operator and the current task context, thereby learning to predict and automatically engage the clutch 3140 during natural pauses lasting 2-10 seconds or transitions in the operator's workflow. This would further enhance the ergonomics and usability of the mobile data collection apparatus 3200, reducing operator fatigue by 20-30%. For example, if the system 3010 detects that the operator is looking away from the primary task area for an extended period exceeding 3 seconds, the intelligent clutch module might infer that a pause is intended and automatically engage the clutch 3140 with predictive accuracies above 90%. Automatic engagement of the clutch 3140 may apply the same configurable per-degree-of-freedom suspension and the same smooth trajectory blend on release as set forth above for operator-actuated engagement, such that automatic and manual engagement events produce continuous joint trajectories at the actuators (J1-J7) of the robot 1 across the boundary at which the clutch 3140 is released.

iii. Display

The humanoid robot data collection system 3010 may include a display 3150 that provides visual feedback to the operator from the robot 1 and/or from the operator's viewpoint with refresh rates of 60-144 Hz and resolutions from Full HD to 8K. To provide this visual feedback with minimal latency, the display 3150 can be incorporated into one or more types of devices, including but not limited to: standard computer monitors that use technologies like liquid crystal display (LCD) with response times of 1-5 ms, organic light-emitting diode (OLED) with infinite contrast ratios, microLED with brightness exceeding 1000 nits, or quantum dot displays with color gamut covering 100% of DCI-P3; virtual reality (VR) or augmented reality (AR) headsets (e.g., Sony PlayStation VR with 120 Hz refresh rate, the HTC Vive with 2K per eye resolution, the Apple Vision Pro with micro-OLED displays, and the Meta Quest series with inside-out tracking), which may function as the headset device; and other head-mounted display (HMD) configurations, including those where a mobile device is positioned within a headset frame (e.g., Google Cardboard-style viewers supporting phones with 5-7 inch displays, Merge VR Goggles with adjustable lenses, Carl Zeiss VR One Plus with 100-degree field of view, Xiaomi Play2 with focus adjustment, and similar models, as well as projected displays with lumens ratings of 3000-10000). A headset device may include a head position sensor, such as an internal IMU, configured to determine a position of a head of the operator and provide head positional data to the piloting control system 3202.

Additionally, the display 3150 may be alternatively implemented using technologies such as transparent displays with 50-80% transparency, holographic projectors creating 3D images without glasses, electronic ink (e-ink) panels with power consumption under 10 mW, laser projection systems with 4K resolution, multi-panel display arrays creating wrap-around views, curved monitors with 1000R-1800R curvature, flexible displays that can be rolled or folded, retinal projection systems directly imaging onto the retina, and/or any other known display or display system technology that is suitable for presenting the visual feed of the robot 1. Projection mapping systems with 10,000+ lumens could serve as an alternative for the display 3150, projecting the view of the robot 1 or related information onto surfaces within the environment of the operator, an approach which offers a different form of immersion or situational awareness when compared to head-mounted displays.

In some embodiments, the display 3150 may further include advanced optical components with specific optical characteristics. Examples of such components include Fresnel lenses with focal lengths of 40-50 mm, pancake lenses reducing thickness by 50%, waveguide optics with efficiency above 85%, or diffractive optical elements with sub-wavelength features, which can be used, particularly in HMDs, to enhance visual clarity to 20/20 vision equivalent, widen the field of view to 110-200 degrees, and minimize optical distortion to less than 2% across the field in augmented and virtual reality environments. Additional implementations may integrate adaptive optics that are capable of adjusting their focal lengths in real-time from 0.5 to 3 meters, in order to accommodate the specific vision conditions of the operator or to simulate focus changes that correspond to the sensor focus of the robot 1. Tunable polarization filters with extinction ratios of 1000:1 might also be included to improve contrast and reduce glare under the varying environmental lighting conditions from 10 to 100,000 lux that are reported by the robot 1. Furthermore, high-refresh-rate displays, such as those operating at 120 Hz, 144 Hz, 240 Hz or higher, may be utilized in conjunction with motion prediction algorithms predicting 16-33 ms ahead to further reduce the perceived latency to under 20 ms and improve the real-time responsiveness of the visual feedback. Variable Refresh Rate (VRR) technologies supporting ranges of 48-144 Hz, adapted for VR use cases, could also help to smooth the visual performance by allowing the display 3150 refresh rate to synchronize with the rendering rate of the graphics pipeline, although fixed high refresh rates combined with latency compensation techniques like Asynchronous Timewarp (ATW) reducing latency by 20-40 ms and ASW maintaining smooth motion at 45 fps input are common strategies in VR. VRR can reduce screen tearing and stutter by 90%. These collective enhancements all contribute to creating a more immersive and accurate visual representation of the operational environment of the humanoid robot 1 for the operator with presence scores above 4.5 on a 5-point scale. The overall goal is to achieve a seamless and realistic operator experience with motion-to-photon latencies under 20 ms.

In order to transform visual data that is received from the robot 1, which may be captured in a vertical stereo vision format using vertically separated cameras with baselines of 50-200 mm, into a horizontally oriented stereo image that is suitable for human viewing (e.g., a VR headset with horizontal IPD of 58-72 mm), specialized software methods may be implemented achieving transformation latencies under 10 ms. These methods may include geometric rectification using homography transformations with 3×3 matrices, disparity re-projection techniques maintaining depth accuracy within 1%, convolutional neural networks (CNNs) with 10⁶ to 10⁸ parameters specifically trained for stereo image conversion tasks, and adaptive warping techniques with per-pixel displacement maps. Algorithms such as those that are based on epipolar geometry transformation can be applied to remap the vertically aligned depth or image data into a horizontal stereo pair while attempting to maintain accurate depth perception for the viewer with depth estimation errors under 5%. This category of methods broadly covers various view synthesis and image rectification techniques, such as Depth Image Based Rendering (DIBR) with depth map resolutions of 1080p, Neural Radiance Fields (NeRF) with 10⁵ to 10⁶ sample rays, 3D Gaussian Splatting (3DGS) with 104 to 10⁶ Gaussians, Multi-Plane Images (MPI) with 32-128 depth planes, or direct learned transformations that are executed on the appropriate processing hardware capable of 1-10 TFLOPS, which could be located on the robot 1, on an edge computer 3110, or distributed between them with task allocation based on available compute. Unlike conventional approaches in which a head-mounted display 3152 receives image data acquired through a horizontally oriented camera pair on the robot platform, the display 3150 is configured to receive image data acquired through a vertically oriented camera pair on the head 10 of the robot 1 and to render that image data as a horizontally oriented stereo image pair sized to the operator's horizontal interpupillary distance, such that the head 10 of the robot 1 retains a compact vertical camera form factor while delivering vergence-consistent stereoscopic imagery to the operator.

In a further embodiment, the transformation step comprises a homography-based geometric rectification in which a per-camera homography is applied to map each captured image plane onto a common virtual horizontal-baseline image plane, followed by a disparity re-projection that resamples the rectified image pair onto pixel grids spaced by the operator's horizontal interpupillary distance, thereby producing a stereo pair sized to the measured interpupillary distance of the operator. In an alternative embodiment, the transformation step comprises an epipolar-geometry remap that aligns epipolar lines of the captured image pair to a horizontal axis prior to the disparity re-projection. In yet another alternative embodiment, the transformation step comprises a depth-image-based rendering pipeline in which a depth map is recovered from the captured image pair and used to synthesize a horizontally separated virtual stereo image pair from the depth map. The transformation step may operate with a transformation latency under approximately 10 ms, contributing to a motion-to-photon latency under approximately 20 ms across the capture, transformation, and display stages of the system, and may employ frame interpolation using one of asynchronous spacewarp and optical-flow-based interpolation to maintain an apparent frame rate at the head-mounted display 3152 of at least 90 frames per second.

Alternative transformation methods may involve the use of light field rendering techniques with 5×5 to 15×15 view arrays, where the system captures or synthesizes a richer representation of the light rays in the scene. This allows for view generation from different perspectives with angular resolution of 0.5-2 degrees, which can offer more comfortable viewing experiences or enable features like variable focus from 30 cm to infinity. The choice between these different transformation methods may involve trade-offs concerning computational cost (GFLOPS used), the quality of the output image (PSNR above 30 dB), the amount of introduced latency (target under 10 ms), and the robustness of the method to different scene types or camera configurations. Additionally, interpolation methods that use optical flow estimation with sub-pixel accuracy can further enhance the alignment between the transformed left and right eye images in order to reduce visual distortion to under 1% and provide a more natural viewing experience for the operator. Optical flow information can also be utilized in techniques like Asynchronous Spacewarp (ASW) or similar frame interpolation methods generating intermediate frames at 90-120 Hz. These methods can be used to synthesize intermediate frames when the system cannot consistently maintain the target frame rate of the display 3150, thereby improving the perceived smoothness of the motion by maintaining apparent frame rates above 90 fps.

The display 3150 and/or the humanoid robot data collection system 3010 may also include capabilities for integrating additional sensor modalities to provide an enriched interaction experience for the operator with multi-modal feedback improving task performance by 15-30%. Multi-modal interaction serves to enhance the level of control precision and situational awareness. These modalities may include eye-tracking sensors with accuracies of 0.5-1 degree and sampling rates of 120-250 Hz, gesture recognition systems which may use cameras or other sensors detecting 20-50 distinct gestures, capacitive or resistive touch interfaces with response times under 10 ms which may be on associated controllers or on the display 3150 itself, voice control systems with vocabulary sizes of 1000-10000 words, or biometric sensors like heart rate monitors (30-250 BPM) or galvanic skin response sensors (0.01-100 S) providing physiological feedback. These additional sensors provide alternative input channels for the operator with recognition accuracies above 95%.

Eye-tracking technology that is integrated into a VR headset is particularly relevant in this context with calibration times under 30 seconds. Eye-tracking has several applications in VR enhancing both performance and user experience. It enables gaze-contingent rendering, which involves rendering higher detail only in the area where the operator is currently looking (typically 20-30 degrees), and it also enables foveated encoding, which involves compressing the video stream more aggressively in the peripheral vision areas with compression ratios of 10:1. These techniques serve to optimize both rendering performance and bandwidth usage by 40-60%. Both of these techniques can significantly reduce the computational load and the network bandwidth requirements for rendering and transmitting the high-resolution video stream from the robot 1. The resulting efficiency gains are substantial, enabling higher resolution displays or reduced hardware requirements.

Furthermore, other sensor modalities, beyond those related to the interaction of the operator, may be incorporated to enhance the ability of the display 3150 to interpret and present the perception of the robot 1 of its surroundings with enhanced environmental awareness. These may include depth-sensing cameras that provide depth maps with 1-10 mm accuracy at 30-60 fps, infrared sensors for enhanced vision in low-light conditions down to 0.001 lux, electromagnetic motion tracking systems for providing precise positional awareness of tracked objects or controllers with sub-millimeter accuracy, environmental microphones that are integrated into the display 3150 device for spatial audio processing with 360-degree sound localization, thermal imaging sensors for detecting heat signatures, and/or any other sensors that are disclosed elsewhere herein as being part of the robot 1 or the system 3010.

Integrating spatial audio rendering with 7.1 or Atmos support, which is synchronized accurately with the visual feed presented on the display 3150 with audio-visual sync within 40 ms, can further enhance the immersion and situational awareness of the operator for teleoperation tasks improving task completion rates by 10-20%. Haptic feedback mechanisms that are integrated into the display 3150 device or its associated controllers, such as vibrating motors operating at 20-1000 Hz or force feedback elements providing up to 40N, could provide tactile cues that correspond to events in the environment of the robot 1 or provide feedback related to the actions of robot 1, thereby complementing the visual and audio information with response times under 20 ms.

Separate and apart from the calibration procedures for the mobile data collection apparatus 3200, the display 3150 itself may also utilize its own calibration procedures using 2-5 minutes. These procedures, which may employ image processing techniques and corrective transformation matrices updated at 60-120 Hz, may be implemented to ensure color accuracy within ΔE<2, geometric fidelity with distortion under 1%, and depth perception consistency within 5% in the visuals that are presented to the operator. These display calibrations may include machine learning-based error correction algorithms with neural networks of 10⁴ to 10⁶ parameters that dynamically adjust for image distortions based on real-time feedback or the known hardware characteristics of the display 3150. This can help to compensate for issues like lens aberrations in HMDs (typically 1-5% distortion), motion blur effects with 1-10 ms persistence, and to adapt to the different environmental lighting conditions from 10 to 100,000 lux that are being experienced by the robot 1. The calibration processes might utilize standardized reference targets, such as color checker patterns with 24 color patches that are viewed by the cameras of the robot 1, structured light scans of known geometries with patterns projected at 30-120 Hz, or pre-computed depth maps with resolutions matching the display, in order to derive calibration equations or lookup tables that are able to mitigate distortion and ensure visual consistency across varying operational conditions with calibration accuracies better than 1%. Operator-specific calibration profiles for the operator could also be stored and applied, which would account for individual operator preferences or visual characteristics, such as their interpupillary distance (IPD) ranging from 52-78 mm. This Personalization improves both comfort reducing eye strain by 30-50% and accuracy for the operator improving depth perception accuracy by 10-20%.

Ensuring an accurate calibration between the cameras of the robot 1, including their intrinsic parameters like focal length (typically 3-50 mm) and distortion coefficients (k1, k2, p1, p2, k3), and their extrinsic parameters like their relative position (accurate to 1 mm) and orientation (accurate to 0.1 degrees), especially the vertical baseline separation if applicable (typically 50-200 mm), and then correctly mapping the resulting stereo view to the measured IPD of the operator in the VR headset is an integral process. This accurate mapping helps to provide a comfortable and accurate stereoscopic viewing experience with vergence-accommodation conflicts minimized, preventing eye strain for the operator during sessions lasting 2-8 hours and avoiding misperceptions of depth or scale in the presented view with depth accuracy maintained within 5%. Furthermore, advanced computational imaging techniques, such as multi-view stereo reconstruction using 2-8 camera views, photometric calibration to ensure consistent brightness and color response across 0.1-100,000 lux, and adaptive exposure correction algorithms with dynamic ranges of 120 dB, may be employed on the image data before it is displayed, in order to enhance the accuracy and reliability of the visual data being presented. Real-time optimization algorithms running at 60-120 Hz may also be implemented to compensate for minor discrepancies in the stereo vision alignment that might occur during operation, which ensures that the depth information remains reasonably accurate within 2-3% error and dynamically responsive to any environmental changes. Techniques for online camera calibration updating every 10-60 seconds or adaptive rectification with sub-pixel accuracy could also be employed for this purpose. These techniques could be configured to run periodically or continuously to maintain the alignment accuracy within 1-2 pixels, even if minor mechanical shifts occur in the camera rig of robot 1 over time due to factors such as vibration at 10-100 Hz or temperature changes of ±20 °C.

Operationally, the display 3150 can be physically configured in multiple ways to accommodate different use cases and operator preferences. It might be designed to be worn by the operator with head strap tensions of 10-30N, as is the case with an HMD weighing 300-800 grams, it might be mounted directly on the mobile data collection apparatus 3200 at eye level, or it could be positioned in a stationary manner, like a desktop monitor at viewing distances of 50-100 cm, in front of the operator during the operation of the apparatus 3200. Additionally and/or alternatively, the display 3150 system or the broader humanoid robot data collection system 3010 may include the capability to process image data through real-time rendering engines achieving 60-120 fps and sensor fusion algorithms with latencies under 5 ms. These algorithms are designed to integrate inputs from various sensors, including inertial measurement units (IMUs) that are located within the display 3150 device itself with update rates of 500-1000 Hz, LiDAR sensors on the robot 1 with 300,000-2,000,000 points per second, infrared depth cameras on the robot 1 operating at 30-90 fps, electromagnetic motion tracking systems with update rates of 240-360 Hz, environmental microphones for spatial audio processing with 48-192 kHz sampling, and other vision-based tracking systems, such as SLAM running on the headset cameras achieving 6-DOF tracking. Specifically for a VR headset implementation of the display 3150, the rendering engine may use inputs from the headset's own IMU updating at 1000 Hz and its tracking system, which could be, for example, inside-out tracking using the headset's cameras with 4-6 cameras or outside-in tracking using external sensors with sub-millimeter precision.

Additionally or alternatively, the display 3150 may include capabilities to provide augmented reality (AR) overlays with registration accuracies of 1-5 mm. These overlays would utilize environmental mapping techniques, such as simultaneous localization and mapping (SLAM) algorithms processing 30-60 fps, which could run either on the robot 1 or on the AR display device itself with dedicated processors. This would enable the dynamic alignment of virtual information or graphics with the view of the operator of their physical surroundings with update rates of 60-90 Hz, as seen either directly or through the cameras of the robot 1. Further, machine learning-based predictive tracking algorithms with prediction horizons of 20-100 ms may be implemented to anticipate the head movements of the operator more accurately and preemptively begin rendering the corresponding visuals, which further contributes to the reduction of perceived latency by 30-50%.

Moreover, the display 3150 system may also include features like diagnostic modes showing system metrics updated at 10-30 Hz, which could show raw sensor data or system status, playback functionalities for reviewing recorded sessions at variable speeds from 0.25× to 4×, or immersive simulation modes for training or testing with physics simulations at 1000 Hz. In these modes, latency minimization may be achieved through techniques such as variable refresh rate (VRR) supporting 48-240 Hz and adaptive sync technologies with response times under 1 ms, which help to ensure that the effective frame update interval remains consistent even under rapid motion conditions exceeding 180 degrees/second, although techniques like ATW/ASW are generally considered for maintaining smooth visual perception during frame rate fluctuations in VR environments. Ensuring low latency under 20 ms and smooth visuals above 90 fps is a constant focus of the system design achieving user comfort ratings above 4/5. For instance, an alternative diagnostic mode may overlay the predicted trajectories or planned paths of the robot 1 onto the view of the operator with trajectory updates at 30 Hz, which would allow for an intuitive assessment of the intentions of the robot 1. The Playback functionalities may also incorporate the synchronized playback of multiple sensor data streams alongside the visual feed with synchronization accuracy within 1 ms, a feature which facilitates a detailed post-session analysis of the performance of both the robot 1 and the inputs of the operator with analysis tools supporting frame-by-frame review.

iv. Data Storage

The data storage database 3204 collects and stores robot data generated by the actuators (J1-J7) for subsequent training and analysis purposes. The robot data collected and stored by the data storage database 3204 can be filtered, labeled, refined, and/or modified to generate training data that can be used for training of networks that will run on one or more robots 1. The data storage database 3204 may be a server, a hard drive, a computer, or other device or devices suitable to collect and store data with sufficient capacity and throughput. Similar to the discussion regarding the location of the computer 3110, the data store 3204 may be local to the robot 1 with direct bus connections, the mobile data collection apparatus 3200 (e.g., integrated with piloting control system 3202), or the computer 3110 with high-speed interfaces. In other examples, the data store 3204 may not be local and instead may be remote relative to one or more of the robot 1, the mobile data collection apparatus 3200, or the computer 3110, connected through network links with appropriate bandwidth and reliability. In some embodiments, the data storage database 3204 stores entries tagged by sensor source, time stamp, task identifier, and operator identifier, and supports retrieval and labeling of stored entries for supervised training of a robot control model implemented on the compute 1000 of the robot 1, such that apparatus-side data and robot-side data are processed under a common preprocessing configuration including shared filter coefficients, shared sample-rate domains, and shared quantization parameters.

b. Mobile Data Collection Apparatus

As best shown in FIGS. 9-11, the mobile data collection apparatus 3200 includes (i) a base mount 3240 (also referred to herein as the base frame 3240), (ii) left and right articulated arms 3300 (also referred to herein as actuated pilot arms 3300) pivotably attached to the base mount 3240, (iii) a wrist assembly 3370 coupled to each articulated arm 3300, (iv) a glove 3400 (also referred to herein as the glove component 3400) coupled to the wrist assembly 3370 via a glove mount 3394, and (v) an apparatus electronics assembly 3201. The apparatus electronics assembly 3201 includes a piloting control system 3202, data storage 3204, a battery 3206, a plurality of sensors 3208, and other circuitry 3209. The mobile data collection apparatus 3200 is configured to be worn by a human operator to perform data collection tasks. The operator wears the mobile data collection apparatus 3200 on the back and secures it in position using the adjustable harness 3270. The operator also wears the gloves 3400 on each hand to capture fine motor movements of the fingers and thumbs. The articulated arms 3300 are configured to move with the arms of the operator wearing the mobile data collection apparatus 3200 as the operator performs data collection tasks, where a plurality of sensors 3208 capture the position, orientation, and/or pitch of the operator's wrists and hands.

The sensors 3208 coupled to the mobile data collection apparatus 3200 include encoders 3211, 3212, 3213, IMUs 3220 and 3224, and hand sensors 3410. The encoders 3211-3213 are fixed to respective rigid frame links 3310-3312 to measure the rotational and positional movement of each rigid frame link. A torso IMU 3224 may be coupled to the base mount 3240 and wrist IMUs 3220 may be coupled to the glove mount 3394, or optionally the glove 3400, to provide information regarding the pitch and orientation of the operator's wrist. The gloves 3400 provide additional positional information for the fingers and thumbs of the operator. The pilot movement data is collected by the piloting control system 3202 as the operator performs tasks. The collected pilot movement data is processed by the piloting control system 3202 and/or computer 3110 to provide robot control data to the robot 1 via the network 2999A-X to be processed by the WBC 1550 of the robot 1. The WBC 1550 utilizes the robot control data to control the actuators 1.2.4 of the robot 1 to replicate the operator's movements and sensor data from the robot 1 is collected as training data as the robot 1 performs the task.

In one embodiment, each actuated pilot arm 3300 includes three actuator encoders 3211, 3212, 3213 and one wrist inertial measurement unit 3220, and the mobile data collection apparatus 3200 includes a single torso inertial measurement unit 3224 mounted to the base mount 3240, totaling four sensors per actuated pilot arm 3300 and nine sensors across the mobile data collection apparatus 3200. The encoders 3211, 3212, 3213 directly measure each actuated joint of the actuated pilot arm 3300, the wrist inertial measurement unit 3220 directly measures wrist orientation independently of joint accumulation along the kinematic chain, and the torso inertial measurement unit 3224 establishes a torso reference frame against which wrist position and orientation are determined. The nine-sensor topology is configured to capture sensor data associated with the movements of the mobile data collection apparatus 3200 and to transmit the sensor data to the computer 3110 for computation of a delta between a last known location of each wrist and a current position relative to the torso reference frame established by the torso inertial measurement unit 3224. The mobile data collection apparatus 3200 is free of any requirement for additional inertial measurement units placed at the upper arm or shoulder, in that the encoders 3211, 3212, 3213 of the actuated pilot arm 3300 supply joint-angle measurements that propagate the wrist pose along the kinematic chain extending from the torso reference frame through the actuated pilot arm 3300 to the wrist component.

The first and second frame links of each actuated pilot arm 3300 are configured for adjustment in length to accommodate operators of differing arm-segment dimensions. In an alternative embodiment, the first and second frame links of an actuated pilot arm 3300 are custom-manufactured for a particular operator based on a measurement set or a three-dimensional scan of the operator. The selection between adjustable frame links and custom-manufactured frame links is made based on whether the apparatus 3200 is intended for use across a population of operators or for use by a single operator over an extended period. In a further embodiment, the actuated pilot arm 3300 includes a quick-release mechanism between the medial actuation assembly and the wrist component, such that the wrist component and the glove 3400 may be detached and re-attached without disturbing the encoder calibration of the base actuation assembly and the medial actuation assembly.

i. Sensors of the Apparatus

The mobile data collection apparatus 3200 can include a plurality of sensors 3208 and other circuitry 3209 for signal conditioning and data processing. The plurality of sensors 3208 include encoders 3211-3213 (e.g., actuator encoders), wrist inertial measurement units (IMUs) 3220 and a torso IMU 3224, and hand position sensors 3410. The mobile data collection apparatus 3200 may also include additional sensors (e.g., IMU, GPS, etc.) to capture other sensor data while the operator is performing data collection tasks while wearing the apparatus 3200. The mobile data collection apparatus 3200 is designed to collect sensor data and communicate the position of one or more of the operator's wrists relative to their torso through the kinematic chain. The IMUs 3220, 3224 may include one or more accelerometers, gyroscopes, and one or more magnetometers to provide complete 9-axis motion sensing.

The apparatus 3200 may include a comprehensive array of sensors 3208 providing multi-modal data capture capabilities for robust tracking. In addition to the encoders 3211-3213 (e.g., optical encoders with resolutions of 12-16 bits or magnetic encoders with absolute position capabilities) located at the joints of the articulated arms 3300 and hand position sensors 3410 in the gloves 3400, the apparatus 3200 may include accelerometers with ranges of ±2 g to ±16 g, gyroscopes with ranges of ±250 to ±2000 degrees/second, and inertial measurement units (IMUs) combining both sensor types with additional magnetometers. In an alternative embodiment, the encoders 3211-3213 are configured as absolute magnetic encoders providing absolute position measurement on both the articulated arms 3300 of the apparatus 3200 and on the joints of the corresponding actuators of the robot 1, such that the absolute position encoding format of operator-side measurements matches the absolute position encoding format of robot-side measurements during the generation of robot control data.

The torso IMU 3224 may be located on base mount 3240 to measure the relative position of the operator's (H) torso and may provide or establish a distance from the ground or a support surface using barometric pressure sensors with altitude resolutions of 10-50 cm. For example, the torso IMU 3224 may be coupled separately or included in electronics and other circuitry 3209 coupled with the piloting control system 3202 on the base mount 3240, maintaining thermal isolation from heat-generating components to prevent temperature-induced measurement drift. Additional IMUs 3220 may be positioned at a distal portion of the articulated arms 3300 (e.g., the glove mount 3394 and/or glove 3400) to measure the relative position of the operator's (H) wrist with 6-DOF tracking capabilities. Further, the torso IMU 3224 may be used to determine the orientation of the operator's torso with accuracies better than 1 degree and establish a reference point for the wrist IMUs 3220 through coordinate transformation matrices. In some cases, the sensor data collected from IMUs 3220 positioned at the wrist of the operator from the apparatus 3200 for wrist pose estimation might rely on the change in position and orientation as determined from the IMUs 3220 and/or other sensors 3208 used for minimizing drift through zero-velocity updates and magnetic heading correction, which is then fused with the kinematic chain data derived from the encoders 3211-3213 at the joints 3313-3315 of the articulated arms 3300 using extended Kalman filtering or complementary filtering approaches.

The torso IMU 3224 contributes a ground-truth orientation and absolute heading signal of the torso of the operator, while the wrist IMUs 3220 and the encoders 3211, 3212, 3213 contribute local rotational and positional movement data along the actuated pilot arm 3300. Together, the torso IMU 3224 and the per-arm sensors enable continuous and stable computation of the six-degree-of-freedom pose of each wrist because the computer 3110 fuses the absolute orientation signal from the torso IMU 3224 with the encoder data and the wrist IMU data using a Mahony complementary filter, a Madgwick gradient-descent filter, or a comparable sensor-fusion technique. The configuration of three actuator encoders per actuated pilot arm 3300, one wrist inertial measurement unit 3220 per actuated pilot arm 3300, and one torso inertial measurement unit 3224 mounted to the base mount 3240 establishes a defined data bandwidth requirement for real-time communication between the apparatus 3200 and the computer 3110, which results in highly responsive closed-loop control and haptic feedback delivery between the apparatus 3200 and the robot 1.

Advantageously, these sensors 3208 are an integral part of the structure of the apparatus 3200 and are not placed manually by the human operator or other operators each time the device is used, ensuring consistent sensor placement within 1-2 mm across sessions. This fixed placement methodology eliminates the variability that can arise due to the misplacement of sensors 3208 by the operator and reduces substantial changes in relative sensor locations between different operators or different sessions, thereby aiding in the consistency and reliability of the collected data with repeatability better than 95%. The fixed structural placement of the encoders 3211-3213 and of the IMUs 3220, 3224 contributes geometric repeatability across sessions and across operators, with each encoder and each IMU mounted in a defined location on a rigid frame element of the apparatus 3200, such that placement consistency falls in a range of 1 mm to 2 mm across sessions and operators and inter-session repeatability is greater than 95%.

Moreover, in some embodiments, the sensors 3208 utilized in the apparatus 3200 may employ the same or similar underlying sensor technology as the sensor technology used in the corresponding parts of the robot 1, maintaining measurement consistency across platforms for simplified data processing. This could include, for example, using specific types of optical encoders (e.g., encoders 3211-3213) with identical line counts and interpolation factors or the exact same model of IMU chip such as the Bosch BMI088 or InvenSense ICM-42688 in both the apparatus 3200 and the robot 1. The use of such similar or identical sensor technology provides a technical advantage by reducing or eliminating the need to perform complex translation, manipulation, or alteration of the sensor data collected from the apparatus 3200, reducing computational overhead by 50-70%. As a result, this data can be more directly and meaningfully used to control the robot 1 or to serve as high-quality training data with minimal preprocessing requirements. Additionally, using the same or similar sensor technology can help to mitigate problems that are commonly associated with comparing data from sensors 3208 that exhibit different drift characteristics (typically 0.1-1 degree/hour for gyroscopes), noise profiles (with noise densities of 0.01-0.1 degrees/second/√Hz), or sensitivities to various environmental factors such as temperature coefficients of 0.01-0.05%/°C. In particular, when subjecting two significantly different sensor technologies (e.g., an IMU vs. an optical encoder, or two IMU models from different manufacturers with different Allan variance characteristics) to the same environmental noise sources (e.g., electromagnetic interference (EMI) noise commonly found on a factory floor with field strengths of 1-10 V/m, or mechanical vibrations at frequencies of 10-1000 Hz), the resulting drift or noise patterns associated with these different sensor technologies might be sufficiently different that combining or comparing their data becomes a significant challenge, potentially rendering the collected human data less usable for direct robot control or for imitation learning without extensive calibration and compensation. Thus, the disclosed apparatus 3200, by using the same sensor technology and sometimes even the exact same sensor components as the robot 1 for corresponding measurements (like joint angles), aims to overcome some of these long-standing challenges in cross-platform data consistency.

The matched sensor selection is made because shared sensor architecture produces shared error characteristics, and shared error characteristics permit a single sensor-fusion and filtering pipeline to operate on sensor data from either the apparatus 3200 or the robot 1 under a common parameterization. The cross-platform sensor configuration is devoid of an intermediate domain-adaptation translation layer between operator-side data and robot-side data, in that captured operator data and captured robot actuator data are combined in a common processing pipeline and applied as labeled training data without an intervening software-based translation stage. In one embodiment, the matching sensors are implemented as absolute magnetic encoders on both the articulated arms 3300 of the apparatus 3200 and the joints of the actuators (J1-J7) of the robot 1, which similarly achieves cross-platform data alignment by maintaining identical absolute position encoding formats during the generation of the robot control data.

In addition to these specifically mentioned sensors 3208, the mobile data collection apparatus 3200 may incorporate a variety of additional sensors 3208, or it may obtain data from other external sensors (such as those found in a VR system), to enhance the quality of data collection and to improve the accuracy of training or control with sensor fusion improving overall system accuracy by 20-40%. For clarity, these additional sensors 3208 may be grouped by category:
Motion and Position: This category includes accelerometers with measurement ranges from ±2 g to ±200 g and bandwidths up to 5 kHz, gyroscopes with drift rates better than 10 degrees/hour, and magnetometers with resolutions of 1-10 nT (which are often combined within IMU packages 3220, 3224), flex sensors for measuring bending with resistance changes of 10-100% over their range, GPS modules for absolute outdoor positioning with accuracies of 1-10 meters, 3D cameras or depth sensors for tracking limb position relative to the body or the environment with depth resolutions of 1-10 mm, optical encoders (such as 3211-3213) with resolutions up to 20 bits, tilt sensors with accuracies of 0.01-0.1 degrees, inclinometers with measurement ranges of 180 degrees, absolute or relative position sensors with resolutions down to nanometers, velocity sensors measuring speeds from 0.01-100 m/s, displacement sensors with ranges from micrometers to meters, vibration sensors detecting frequencies from 0.1 Hz to 10 kHz, angular rate sensors, linear accelerometers, rotary encoders, potentiometers for measuring rotation angle with linearities better than 0.1%, vision-based tracking systems that use markers placed on the operator or apparatus 3200 viewed by external cameras achieving sub-millimeter tracking accuracy, or Ultra-Wideband (UWB) tags for achieving precise relative positioning with accuracies of 10-30 cm.
Biometric: This category includes Electromyography (EMG) sensors for measuring muscle electrical activity with signal amplitudes of 50 μV to 30 mV, which can be used for control input or for fatigue monitoring, and eye-tracking sensors with gaze accuracies of 0.5-1 degree, which may be integrated into the apparatus 3200. Other biometric sensors such as Electroencephalography (EEG) for brain activity monitoring with 8-256 channels, Galvanic Skin Response (GSR) for stress levels detecting conductance changes of 0.01-100 S, or heart rate monitors measuring 30-250 BPM could also be integrated into or interfaced with the system. Skin temperature sensors with accuracies of 0.1-0.5 °C may also be included to monitor the physiological state of the operator.
Environmental: This category includes acoustic sensors such as microphones with frequency responses from 20 Hz to 20 kHz, which can be used for voice commands or for ambient noise awareness, proximity sensors for detecting nearby objects at ranges of 1 mm to 10 m, temperature sensors with ranges from −40 °C to +125 °C, barometric pressure sensors with resolutions of 0.1 Pa, humidity sensors measuring 0-100% RH, and ambient light sensors detecting 0.01-100,000 lux.
Force and Pressure: This category includes force-sensitive resistors (FSRs) with force ranges of 0.1-100N, pressure sensors for measuring applied pressure over an area from 1-1000 kPa, piezoelectric sensors that generate voltages of 1-1000V under stress, piezoresistive sensors that change resistance by 1-10% under stress, strain gauges for measuring deformation with gauge factors of 2-200, load cells for measuring force, torque sensors (which include types like strain gauge-based with accuracies of 0.1-1%, piezoresistive with response times under 1 ms, magnetoelastic with non-contact measurement, capacitive with resolutions of 0.01%, fiber-optic with immunity to EMI, and rotary transformers for continuous rotation), tactile sensor arrays that provide distributed pressure information similar to artificial skin with spatial resolutions of 1-5 mm, shear force sensors measuring tangential forces of 0.01-100N, bending moment sensors, compression sensors, tension sensors, and impact sensors detecting accelerations up to 10,000 g.
Other: A wide variety of other sensor types might be included based on specific application needs. These can include photodiodes for light detection with spectral responses from UV to IR, Hall effect sensors for magnetic field detection with sensitivities of 1-100 mV/mT, capacitive sensors for proximity or touch detection with sensing distances of 0-50 mm, inductive sensors for metal detection or positioning with ranges of 0.5-80 mm, ultrasonic sensors for distance measurement with ranges of 2 cm to 10 m, thermal sensors for non-contact temperature measurement from −70 °C to +380 °C, radar sensors operating at 24-77 GHz, or LiDAR sensors with range resolutions of 1-5 cm, though the latter are less common on a apparatus 3200 compared to their use on robots.

It should be understood that other similar sensors or sensor technologies, including emerging sensor types not listed here such as quantum sensors or neuromorphic sensors, may be utilized by the mobile data collection apparatus 3200. This includes sensor types or specific sensor technologies that might be disclosed in other sections of this application or are otherwise known in the art. Sensor fusion strategies that are specific to the apparatus 3200, employing algorithms such as complementary filters with time constants of 0.5-5 seconds, Kalman filters (including variants like the EKF with 15-30 state variables or UKF with sigma point selections), or machine learning-based approaches using neural networks with 10³ to 10⁶ parameters, may be implemented within the piloting control system 3202 or the computer 3110. The goal of these strategies is to combine data from multiple sensors 3208 in an effective manner, aiming to achieve more accurate and robust estimates of the pose, motion, and intent of the operator with position accuracies better than 5 mm and orientation accuracies better than 2 degrees.

In addition to the sensors already mentioned, the mobile data collection apparatus 3200 may incorporate additional sensors to enhance data collection and improve training accuracy. These may include:
Electromyography (EMG) Sensors (e.g., Delsys Trigno Wireless EMG System, Advancer Technologies MyoWare Muscle Sensor, Otto Bock MyoBock System)
Force-Sensitive Resistors (FSR) or Pressure Sensors (e.g., Interlink Electronics FSR 400 Series, Tekscan FlexiForce Sensors, Honeywell FSS-SMT Series Force Sensors)
Haptic Feedback Devices (e.g., Precision Microdrives Vibration Motors, Tactile Labs Haptics Actuators, Ultrahaptics (Ultraleap))
Flex Sensors (e.g., Spectra Symbol Flex Sensor, Adafruit Flex Sensor, Flexpoint Bend Sensors)
Acoustic Sensors (e.g., Knowles MEMS Microphones (e.g., SPH0645LM4H-B), Audio Analytic's ai3 Acoustic Sensor, MaxBotix MB1000 LV-MaxSonar-EZ1)
Eye-Tracking Sensors (e.g., Tobii Eye Trackers, Pupil Labs Eye Tracking Headsets, SR Research EyeLink Systems)
Proximity Sensors (e.g., Sharp GP2Y0A21YK0F Infrared Proximity Sensor, STMicroelectronics VL53LOX ToF Sensor, Pepperl+Fuchs Ultrasonic Proximity Sensors)
GPS Modules (e.g., u-blox NEO-M8N GPS Module, Adafruit Ultimate GPS Breakout v3, SparkFun GPS Dead Reckoning Breakout (NEO-M8U))
Temperature Sensors (e.g., Maxim Integrated DS18B20, Texas Instruments LM35, Sensirion STS3x Series)
3D Cameras or Depth Sensors (e.g., Intel RealSense Depth Cameras (D435, D455), Microsoft Azure Kinect DK, Structure Sensor by Occipital)
   ii. Piloting Control System

The piloting control system 3202 is coupled to data storage 3204, a battery 3206, other circuitry 3209 including power management and signal conditioning, multiple sensors 3208 including encoders 3211-3213, hand sensors 3410 detecting finger positions, and IMUs 3220, 3224 of the mobile data collection apparatus 3200. The piloting control system 3202 includes a processor, a memory, and instructions stored in the memory configured to be executed on the processor, where the instructions include applications to facilitate the collection of sensor data using the mobile data collection apparatus 3200 at sampling rates of 100-10,000 Hz. Additionally, the piloting control system 3202 may be in data communication with the robot 1, as well as the computer 3110, the data storage database 2900, the clutch 3140, and/or the optional display 3150 via a network 2999A-X supporting bandwidths of 1-1000 Mbps.

The piloting control system 3202 may be attached directly to the main support portion 3242 in a mounting region that is designed to receive electronics with appropriate thermal dissipation capabilities through heat sinks or thermally conductive mounting interfaces. In some embodiments, both the battery 3206 and the piloting control system 3202 are carried by the base mount. In other embodiments, the piloting control system may be remotely located from the base mount, and the base mount may be coupled to a power source that is also remotely located from the portable data collection apparatus. Said electronics may include sensors operating at various sampling rates from 10 Hz to 10 kHz, communication interfaces supporting protocols such as USB 3.0, Ethernet, Wi-Fi 6, and Bluetooth 5.0, processors including ARM Cortex-A series or Intel Atom processors, data storage devices using solid-state drives or eMMC storage, or any other electronic component that facilitates obtaining and transmitting sensor data from the mobile data collection apparatus 3200 to the computer 3110, the data storage 3204, and/or the robot 1 with end-to-end latencies under 20 ms. In some embodiments, the battery 3206 or power source for the piloting control system 3202 may reside with the piloting control system 3202 in a housing or be coupled separately to the main support portion 3242 and electrically connected to the piloting control system 3202 through power cables rated for 5-50 W. In some embodiments, the main support portion 3242 is configured to support at least the battery 3206 and/or piloting control system 3202 with vibration isolation providing 20-40 dB attenuation at frequencies that could affect sensor measurements.

The piloting control system 3202 may also be configured to integrate various software applications or functionalities (e.g., running on embedded Linux or real-time operating systems). These applications may include a sensor tracking application operating at 500-1000 Hz update rates, which may incorporate a drift correction algorithm to enhance tracking accuracy to sub-degree levels. For example, the sensor tracking application is tasked with the real-time acquisition of data from the array of sensors 3208 that are distributed across the apparatus 3200, managing data streams totaling 10-100 MB/s. The sensor tracking application communicates this collected sensor data to the computer 3110 for further processing through TCP/IP or UDP protocols, or it may process the data locally within the piloting control system 3202 using edge computing capabilities. The computer 3110 and/or the on-board processors that are located within the piloting control system 3202 then operate to refine the raw sensor data through filtering, calibration, and fusion algorithms. This refined sensor data can then be utilized, in connection with robot control data received from the robot 1, to dynamically adjust the data that is provided to generate the robot control data that is sent to the robot 1 with control loop frequencies of 100-1000 Hz.

Advanced algorithms, including various machine learning models such as recurrent neural networks with 10⁴ to 10⁶ parameters, can be employed to analyze the various data streams, such as the raw sensor data sampled at native rates, the refined sensor data after processing, and/or the received robot control data, in order to identify patterns with recognition accuracies above 95%, perform sensor fusion reducing uncertainty by 30-50%, correct for sensor drift maintaining errors below 1 degree/hour, and optimize control strategies improving task success rates by 20-40%. This comprehensive feedback loop, which incorporates data from the operator, the apparatus 3200, and the robot 1 with round-trip latencies under 50 ms, not only improves the performance of the apparatus 3200 in real-time but also contributes to the iterative development of more sophisticated control algorithms (or AI models) that can be tailored to operator-specific training regimens or particular task requirements through transfer learning and fine-tuning approaches. This overall system architecture facilitates an adaptive training or teleoperation environment where the mobile data collection apparatus 3200 can continuously adjust its behavior based on accumulated interaction data from the operator and feedback from the robot 1, thereby maximizing both task efficacy achieving success rates above 90% and the immersion of the operator with presence ratings above 4 on a 5-point scale.

c. Robot Head-Mount Sensors

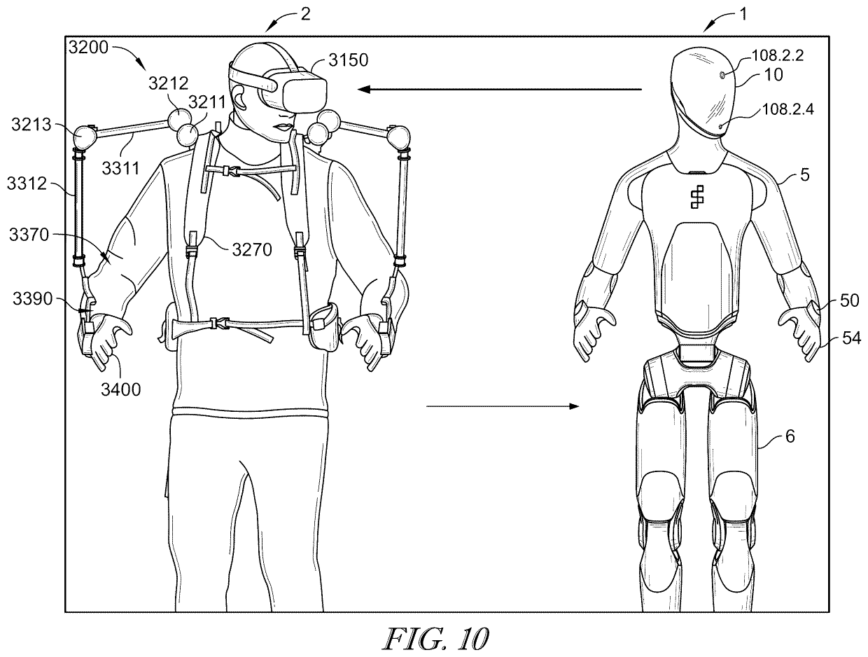

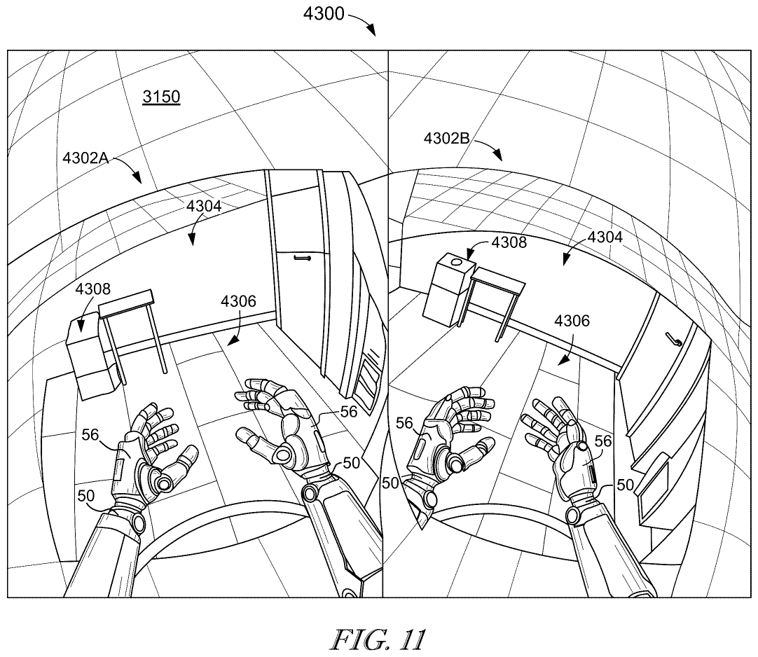

As best shown in FIGS. 10-11, the head and neck assembly 10 of the humanoid robot 1 may be designed to enhance anthropomorphic characteristics while providing functional capabilities that support interaction, perception, and communication. For example, the head 10 may house a range of components, such as high-resolution cameras, microphones, and displays, within an impact-resistant polymer shell designed to resemble a human head. Cameras embedded within the head 10 may include RGB, depth-sensing, or thermal imaging capabilities, enabling the robot 1 to perform tasks such as object recognition, environmental mapping, and facial expression analysis. For the specific purpose of generating a low-latency VR view, a pair of high-resolution, high-frame-rate RGB cameras with global shutters may be utilized. For example, the pair may be the vertically arranged cameras 108.2.2, 108.2.4 and/or the horizontally arranged external cameras (not shown). Microphones may be arranged in an array to facilitate directional audio input and noise cancellation, enhancing the ability of the robot 1 to understand and respond to verbal commands. Displays integrated into the head 10 could serve as user interfaces, providing visual feedback or conveying expressions to improve communication and user engagement. Additionally, the head 10 may house other sensors such as gyroscopes, accelerometers, heat management systems, and communication equipment such as radios and antennas. This integrated design may enable seamless operation and robust functionality in dynamic and interactive environments. The head and neck assembly 10 may also incorporate materials and shock-absorbing structures to protect the electronic components housed within, potentially improving the overall durability and reliability of the robot 1.

The head and neck assembly 10 may include two primary actuators: a head twist actuator J8.1, responsible for enabling rotational movement of the head 10 about the vertical axis (yaw), and a head nod actuator J8.2, which adjusts the pitch of the head 10 about the horizontal axis. Together, these actuators J8.1, J8.2 may provide two degrees of freedom (2 DoF) for the head 10, allowing the head 10 to perform movements that emulate human head motions. The head twist actuator J8.1 may typically be located at the base of the neck, where the head twist actuator J8.1 interfaces with the torso 16, while the head nod actuator J8.2 may be positioned within the head assembly and enables forward and backward tilting of the head 10. This head twist actuator J8.1 and head nod actuator J8.2 may utilize a similar motor, gear reduction system, sensors, and/or encoders as the actuators discussed above in connection with the wearable training apparatus 3200. The head actuators J8.1 and J8.2 may work in coordination to position the head 10 accurately, enabling the robot 1 to track objects, focus on specific areas, or maintain eye contact during human-robot interactions. The actuators J8.1, J8.2 may be controlled by a motion planning system that processes input from visual and inertial sensors to execute smooth, human-like movements. For example, the head twist actuator J8.1 may rotate the head 10 to follow a moving object, while the head nod actuator J8.2 adjusts the pitch to maintain an operating viewing angle.

Variations of this design could include the addition of a third actuator to provide roll motion, further increasing the range of movement of the head 10 to 3 DoF, which could enable more expressive head gestures, such as tilting the head 10 sideways to convey curiosity or empathy. Alternatively, the actuators J8.1, J8.2 could be replaced with compact linear actuators or parallel-link mechanisms for specialized applications requiring higher precision or load capacity. Additionally, variations could include modular head designs that allow for quick customization or replacement of components. These modular designs may facilitate easy upgrades or modifications to the sensory and communication capabilities of the robot 1 without requiring extensive changes to the overall head and neck assembly 10. Furthermore, control algorithms could be implemented to enable more natural, biomimetic head movements, potentially incorporating machine learning techniques to adapt and refine the motion patterns of the head 10 based on interaction data and environmental feedback.

As shown in FIG. 10, the head 10 includes at least one sensor (e.g., upper camera 108.2.2 and lower camera 108.2.4). The upper camera 108.2.2 and the lower camera 108.2.4 may be arranged in a vertical orientation and may be placed at the same angle relative to the horizontal plane or transverse plane. For example, the angle between the upper and lower cameras 108.2.2, 108.2.4 may be positioned at a slight downward angle of about 0 to about 9.0 degrees, or about 6.7 to about 8.2 degrees with respect to a horizontal plane or transverse plane. The specific vertical separation (baseline distance) and convergence angle of these cameras 108.2.2, 108.2.4 are key input parameters for the geometric transformation algorithms, requiring precise calibration. The vertical camera baseline of the upper camera 108.2.2 and the lower camera 108.2.4 lies in a range of 50 mm to 200 mm. The downward pitch angle of the optical axes of the upper camera 108.2.2 and the lower camera 108.2.4 is configured such that, in combination with the mechanized neck bending capability of approximately ±25 degrees provided by the head and neck assembly 10, a visibility envelope is established that extends to about 200 mm directly in front of the feet 92 of the robot 1. The downward pitch angle is selected because operator situational awareness during locomotion tasks depends on continuous visual access to the floor and to the contact points of the feet 92 of the robot 1, while the head 10 of the robot 1 maintains a neutral, upright neck posture corresponding to the head pose of the operator wearing the head-mounted display 3152.

The lens of each of the upper and lower cameras 108.2.2, 108.2.4 can be received within respective upper and lower sensor openings of the housing of the head 10. The robot 1 has stereo vision along with the ability to identify and read bar codes. Due to the fisheye lenses that are installed with the upper and lower cameras 108.2.2, 108.2.4, the field of view of the robot 1 is increased over conventional lenses. However, the use of the fisheye lenses causes the image to be warped or distorted nearly the periphery of said image. Correcting fisheye distortion is a standard preprocessing step in the pipeline, but the extreme distortion can make accurate rectification or view synthesis more challenging, potentially requiring more complex warping functions or learned approaches compared to rectilinear lenses. This being said, the distortion of the image can be corrected or partially corrected by a custom-built algorithm to help increase data extraction in these regions. In other embodiments, the fisheye lenses currently shown and used to generate the image may be replaced with other lens types (e.g., standard or non-fisheye lens). Using rectilinear lenses might simplify the geometric transformation task but would reduce the field of view compared to fisheye lenses, presenting a design trade-off. In an alternative embodiment, the vertically arranged upper camera 108.2.2 and lower camera 108.2.4 are implemented with extreme wide-angle fisheye lenses that capture an expanded field-of-view image, the captured image being subsequently processed through a custom distortion correction algorithm to extract accurate kinematic grounding data for use during locomotion of the robot 1.

The upper and lower cameras 108.2.2, 108.2.4 are primarily for tasks, providing a field of view in front of the robot 1. In other embodiments, a rear camera may be included primarily for situational awareness and localization of the robot 1, providing a field of view behind the robot 1. Similarly, a top camera may assist with localization of the robot 1. The cameras 108.2.2, 108.2.4 are not 360-degree cameras and have restricted fields of view. For example, the angles of the upper camera 108.2.2 and the lower camera 108.2.4 may be adjusted to provide a fuller field of view and minimize blind spots or dead space. Positioning the camera sensors 108.2.2, 108.2.4 on the head 10 of the robot 1 also allows for movement of the sensors 108.2.2, 108.2.4 for better viewing with less movement of the overall robot 1. By moving the head 10 up and down and rotating the head 10 left and right, the target image within the fields of view of the cameras 108.2.2, 108.2.4 is changed and provides a larger, derivative field of view from the sensor assembly 108.2. The vertical orientation of the upper camera 108.2.2 and the lower camera 108.2.4 is selected because a vertical baseline supports superior horizontal edge detection on the head 10 of the robot 1, while the head-mounted display 3152 receives a horizontally oriented stereo image pair derived through the geometric transformation, such that the head 10 is free of any requirement to host a horizontally oriented stereo pair within the compact form factor of the head 10.

The robot 1 may move its head 10 up and down by bending at the neck to adjust the orientation of the cameras 108.2.2, 108.2.4. For example, the neck is able to bend up and down about ±25 degrees, which allows the upper and lower cameras 108.2.2, 108.2.4 to view 200 mm in front of the feet 92 of the robot 1. About 20 degrees of forward torso lean allows the upper and lower cameras 108.2.2, 108.2.4 to view the feet 92. The positions of the cameras 108.2.2, 108.2.4 thus provide a closer or better view to the feet 92 of the robot 1 compared to cameras mounted to the torso 16 of the robot 1 because the fields of view of the upper and lower cameras 108.2.2, 108.2.4 are not entirely blocked by the legs 6 of the robot 1. Additionally, the robot 1 may turn its head 10 left and right to adjust the orientation of the cameras 108.2.2, 108.2.4. The images or video recorded by the cameras 108.2.2, 108.2.4 may be processed for stereoscopic transformation for VR display.

Although upper, lower top, and rear cameras 108.2.2, 108.2.4 are shown as illustrative examples, other sensors may be relied on and coupled to an internal mounting frame in a similar manner to ensure proper directional positioning for respective detection, sensing, or signal reception. Relevant sensor types for low-latency VR include color cameras (typically CMOS), cameras with global shutters (preferred over rolling shutter), high-speed cameras (higher frame rates reduce latency), 3D cameras (like ToF or structured light, if depth is directly used), light field cameras (for alternative view synthesis), or potentially event cameras (for ultra-low latency paths). Said camera may have a megapixel resolution of between 0.4 MP to 20 MP, may record video at frame rates suitable for VR (e.g., >60 FPS, ideally >=90 FPS), may have a CMOS sensor, pixel size may range from 2.4 um to 6.9 um, and preferably utilizes global shutter. Said sensors may include: (i) scan camera(s), (ii) monochrome camera(s), (iii) color camera(s), (iv) CMOS camera(s), (v) CCD sensor(s) or camera(s) that include CCD sensor(s), (vi) camera(s) or sensor(s) that have rolling shutter or global shutter, (vii) other types of 2D digital camera(s), (viii) other types of 3D digital camera(s), (ix) camera(s) or sensor(s) that are capable of stereo vision, structured light, and laser triangulation, (x) sonar camera(s) or ultrasonic camera(s), (xi) infrared sensor(s) and/or infrared camera(s), (xii) radar sensor(s), (xiii) LiDAR, (xiv) other structured light sensors, camera(s), or technologies, (xv) dot projecting camera(s) or sensor(s), (xvi) Time-of-Flight (ToF) cameras, (xvii) hyperspectral cameras, (xviii) multispectral cameras, (xix) thermal imaging cameras, (xx) high-speed cameras, (xxi) panoramic cameras, (xxii) omnidirectional cameras, (xxiii) polarization cameras, (xxiv) plenoptic (light field) cameras, (xxv) depth-sensing cameras, (xxvi) ultraviolet (UV) cameras, (xxvii) single-photon avalanche diode (SPAD) cameras, (xxviii) electron-multiplying CCD (EMCCD) cameras, (xxix) short-wave infrared (SWIR) cameras, (xxx) medium-wave infrared (MWIR) cameras, (xxxi) long-wave infrared (LWIR) cameras, (xxxii) quantum dot cameras, (xxxiii) microbolometer cameras, (xxxiv) holographic cameras, (xxxv) optical coherence tomography (OCT) cameras, (xxxvi) spectral imaging cameras, (xxxvii) phase contrast cameras, (xxxviii) interferometric cameras, (xxxix) fiber optic cameras, (xl) terahertz cameras, (xli) millimeter-wave cameras, (xlii) acoustic cameras, (xliii) biometric cameras (e.g., iris recognition cameras), (xliv) artificial compound eye cameras, (xlv) volumetric capture cameras, (xlvi) computational photography cameras, (xlvii) smartphone cameras with advanced sensors, (xlviii) augmented reality (AR) and virtual reality (VR) cameras, (xlix) streak cameras, (l) burst-mode cameras, (li) LiFi (Light Fidelity) cameras, or any combination of the above or any other known camera or sensor. For example, said camera may have a megapixel resolution of between 0.4 MP to 20 MP, may record video at 5.6 FPS to 286 FPS, may have a CMOS sensor, pixel size may range from 2.4 um to 6.9 um, may utilize a starves rolling shutter technology, can operate in 55 degree c ambient air temperatures, and may have any other properties, technologies, or features that are discussed within U.S. Pat. No. 11,402,726, 11,599,009, 11,333,954, or 11,600,010, all of which are incorporated herein by reference. It should be understood that the cameras are typically configured as video cameras but may have an alternative configuration, such as an image camera. The head 10 can also include one or more cameras, temperature sensors, pressure sensors, force sensors, inductive sensors, capacitive sensors, ultrasonic sensors, infrared sensors, proximity sensors, microphones, gas sensors, light sensors (photodiodes, phototransistors), UV sensors, time-of-flight sensors, LiDAR sensors, optical flow sensors, RFID readers, laser rangefinders, 3D depth cameras, or any combination of these sensors or other known sensors.

The information from each of the upper and lower cameras 108.2.2, 108.2.4, may be used alone or in combination with information from other cameras (e.g., top and rear cameras) and/or sensors included on the robot 1 to aid in the control of the robot 1. The information from said cameras may be used to help the robot 1 navigate or locomote on different terrain, localize to different environments and plan routes, and sense and avoid obstacles. When these cameras 108.2.2, 108.2.4 are used for both control/perception of the robot 1 and generating the VR feed, resource contention (compute, memory bandwidth, data bus) must be managed to avoid impacting the latency of the VR stream. Architectures separating the VR feed (e.g., using external cameras and a direct dataflow) can mitigate the latency issues. The upper, lower top, and rear cameras may be utilized in similar ways or methods that are discussed within U.S. Patent Application Publication 2005/0267631 and U.S. Pat. Nos. 10,638,906, 10,437,251, 11,020,860, 10,580,208, 11,485,013, 11,759,075, or 10,614,588, all of which are incorporated references.

### F. OPERATION OF THE DATA COLLECTION SYSTEM

A method for operating the robot data collection system 3010 to train robot 1 and neural networks running on one or more robots begins by linking the piloting control system 3202 of the mobile/wearable data collection/training apparatus 3200 to the robot 1 and/or computer 3110 via the network 2999A-X. User 2 (also referred to herein as the pilot 2) then dons the wearable training apparatus 3200 on the back and secures it in position using the adjustable harness 3270. The user 2 may also wear the glove components 3400 on each hand. The left and right actuated pilot arms 3300 may extend from the base frame 3240 to the glove components 3400 and may be configured to move with the arms of the user 2 wearing the wearable training apparatus 3200 as the user 2 performs data collection tasks.

The combination of the data obtained from: (i) the actuator sensors (e.g., encoders 3211, 3212, 3213), (ii) the wrist inertial measurement units (IMUs) 3220, (iii) a torso IMU 3224, (iv) potentially additional body-worn IMUs (e.g., on upper arms, head), (v) physiological sensors integrated into the apparatus 3200 or headset display 3150 (e.g., eye-tracking for gaze/intent, EEG/EMG for cognitive state or refined motor commands), and (vi) any of the above sensors or other known sensors can be combined by the wearable training apparatus 3200 and considered sensor data. The actuator sensors are configured to measure the rotational and positional movement of each frame link, while left and right wrist IMUs 3220 are designed to provide information regarding the pitch and orientation of the wrist. Finally, the torso IMU 3224 is designed to provide ground truth for determining the position and orientation of said wrist.

This sensor data is transmitted to the computer 3110 over the network 2999A-X. Upon receiving the data, the computer 3110 processes the sensor data and generates control data. The control data typically includes the six degrees of freedom (DOF) pose of each wrist of user 2 relative to the user's torso. Notably, the control data only includes the difference, or delta, between the last known location of each wrist and their current positions, rather than determining the absolute positions, though absolute poses might be simpler to manage robustly. However, in alternative embodiments, the system 3010 may be designed to compute the absolute six DOF pose of the user's wrists. Based on processing data from the sensors 3208, the computer 3110 generates control data at frequencies suitable for robotic control, typically between 10 Hz and 10 kHz. This control data is sent to robot 1 via the network 2999A-X. The control rate of 10 Hz to 10 kHz is selected to fall within the range of frequencies suitable for closed-loop joint control of the robot 1, such that consecutive control-data packets reflect incremental changes in pilot wrist pose at a temporal resolution sufficient for synchronous mirroring of pilot motion at the robot 1.

Specifically, the delta for the left wrist is determined using data from encoders 3211a, 3212a, 3213a, wrist IMU 3220a, and torso IM 3224. Similarly, the delta for the right wrist is determined from encoders 3211b, 3212b, 3213b, wrist IMU 3220b, and torso IMU 3224 [TECHNICAL FLAG: original stated “encoders 3210b, 3211b, 3213b”; revised to “encoders 3211b, 3212b, 3213b” for consistency with the encoder triplet 3211-3213 introduced in the Sensors of the Apparatus section and used elsewhere in the specification]. The IMUs 3220 and 3224 are primarily used to determine the orientation of the user's wrists, not their positions. In cases where each IMU includes only a 3-axis gyroscope and a 3-axis accelerometer, the computer 3110 may implement a Mahony algorithm or a similar sensor fusion technique to combine these sensors into an orientation signal. The gyroscope signal is integrated to obtain wrist orientation, while the accelerometer provides a measurement of the gravity vector. The Mahony algorithm effectively removes any bias due to gyroscope signal integration along the pitch and roll axes. When the IMUs also include a magnetometer, an absolute heading signal is provided, and the computer 3110 uses a Madgwick algorithm or similar technique to determine an absolute orientation. The data from encoders 3211, 3212, 3213 is then fused with the absolute orientation and heading signals to correct drift in the IMU data, as the encoders are less susceptible to magnetic interference and exhibit less drift.

The encoder data from the encoders 3211, 3212, 3213 of each actuated pilot arm 3300 is fused with the orientation estimate produced by the inertial measurement-unit fusion stage to produce a corrected wrist orientation estimate from which drift accumulated in the inertial measurement-unit integration is reduced through the encoder-derived joint-angle reference. The encoders 3211, 3212, 3213 produce joint-angle measurements that are independent of the magnetic environment surrounding the wearable training apparatus 3200 and exhibit reduced cumulative drift over the duration of a data collection session, while the orientation estimate produced from the wrist inertial measurement unit 3220 reflects the absolute orientation of the wrist component relative to the gravity vector and, where a magnetometer is present, relative to the magnetic-north heading. By combining these two complementary signals, the computer 3110 produces a corrected wrist orientation estimate that is less susceptible to long-term drift than either signal alone. The corrected wrist orientation estimate, together with the joint-angle measurements from the encoders 3211, 3212, 3213 and the torso reference frame established by the torso IMU 3224, allows the computer 3110 to compute the six-degree-of-freedom pose of each pilot wrist relative to the torso reference frame.

a. Simulated Mode

The humanoid robot data collection system 3010 may operate in a simulated mode where the pilot 2 wearing the robot training apparatus 3200 interacts with a simulated environment rendered by one or more applications executed by computer 3110 and/or piloting control system 3202. The simulated environment can include objects that may be encountered by the robot 1 in an operating environment. The pilot 2 wearing the robot training apparatus 3200 receives haptic feedback based on position and orientation detected by the sensors 3208 of the robot training apparatus 3200, as the pilot interacts with the simulated environment. The simulated mode allows for data collection, system testing, training of operators, or skill development in a controlled and purely virtual setting, free of any physical interaction between the apparatus 3200 and the robot 1.

b. Open Loop Mode

Referring to FIG. 10, the user 2 wearing the wearable training apparatus 3200 interacts with robot 1 by receiving primarily visual robot sensor data from robot 1 in real-time and transmitting control data to robot 1. Here, limited data is transmitted between the robot 1 and the piloting control system 3202 of the wearable training apparatus 3200, reducing the bandwidth and/or transmission speed required for real-time communication. In particular, complete and robust sensor data is sent from the wearable training apparatus 3200 to the computer 3110, and then complete and robust control data is sent to the robot 1, meanwhile a limited amount of robot data is sent from the robot 1 to the wearable training apparatus 3200 via the computer 3110. This limited data from the robot 1 may include: (i) video data from what the robot 1 is viewing, and/or (ii) data from the actuators (e.g., torque, current, position). This limited data can then be used by the wearable training apparatus 3200 and the display 3150 to: (i) display what the robot 1 is seeing, and (ii) provide a limited amount of information regarding what the robot 1 is feeling. For example, the limited amount of information regarding the feeling may be only transmitted once the torque or current of an actuator exceeds a threshold limit. This will inform the pilot that is wearing the wearable training apparatus 3200 that the robot 1 has made contact with an object in the real world. In this situation, the pilot can then use this information to proceed with caution while moving the robot 1.

For example, referring to FIG. 11, diagram 3300 illustrates one potential embodiment of an interface that may be provided by the wearable training apparatus 3200 in the open-loop control mode. As described above, the wearable training apparatus may receive video data from the robot 1, for example from multiple stereoscopic cameras mounted to the head 10 of the robot 1. As shown, the wearable training apparatus 3200 maps the video data onto a virtual environment and displays the video data as a stereo pair of sub-images 3302a, 3302b, for example using a head-mounted display 3150. Accordingly, the pilot 2 may view stereoscopic video of the current state of the robot 1 and/or the environment surrounding the robot 1. For example, in the illustrative embodiment, the display 3150 shows the wrists 50 and hands 56 of the robot 1, as well as a wall 3304, floor 3306, object 3308, and other objects in the environment of the robot 1.

In a further embodiment of the open-loop mode, the threshold-triggered feedback signal is produced by a comparison stage in which the actuator-state data received from the robot 1 is evaluated against a threshold value associated with at least one of the actuators (J1-J7) of the robot 1. When the actuator-state value satisfies the threshold condition, the comparison stage generates a feedback indication that is presented to the pilot 2, informing the pilot 2 that the robot 1 has made contact with an object in the environment surrounding the robot 1. As a downstream consequence, the pilot 2 receives discrete contact-event information through a single-bit-style feedback indication, allowing the pilot 2 to proceed with caution while continuing to move the robot 1 through the wearable training apparatus 3200, while the volume of data transmitted from the robot 1 to the wearable training apparatus 3200 is constrained to the video data and the threshold-conditioned actuator-state indication. [SUPPORT GAP: specific numerical threshold values for the actuator torque or current threshold are not stated in the original disclosure; the threshold value is described functionally as the level above which contact information is transmitted to the pilot 2.] The open-loop teleoperation mode is selected for operation across a network 2999A-X having a transmission bandwidth or transmission latency that constrains continuous bidirectional state exchange between the wearable training apparatus 3200 and the robot 1.

c. Closed Loop Mode

Referring back to FIG. 10, the humanoid robot data collection system 3010 may operate in a closed loop mode. In this mode, the closed loop mode may be effective in a networked environment that is capable of high-speed data transmittal between the robot 1 and the piloting control system 3202 of the wearable training apparatus 3200. In particular, the wearable training apparatus 3200 controls the robot 1 using control data that is generated from the sensor data obtained from said wearable training apparatus 3200, and the robot 1 provides robot data to the wearable training apparatus 3200 to help control the actuators of said wearable training apparatus 3200, and provides video data to the display 3150. Unlike the open loop mode, the closed loop mode provides sufficient robot data for the wearable training apparatus 3200 to provide accurate feedback to the pilot or user 2 of the wearable training apparatus 3200 to inform said user or pilot of the forces that the robot 1 is feeling. In other words, the data is transmitted from the wearable training apparatus 3200 to the robot 1 to control said robot 1, and then data is transmitted back to the wearable training apparatus 3200 to control the wearable training apparatus 3200. The user 2 can then push against the forces applied by the wearable training apparatus 3200 to cause the robot 1 to apply additional force to the object. This closed loop mode causes the user or pilot to step in the shoes of the robot 1 and feel, see, touch, and interact with the world as if he/she is the robot 1.

The closed-loop teleoperation mode produces a bidirectional force coupling between the pilot 2 and the robot 1 in which forces measured at actuators (J1-J7) of the robot 1 are transmitted as robot data through the network 2999A-X to the wearable training apparatus 3200, the piloting control system 3202 commands the actuators of the wearable training apparatus 3200 to apply corresponding forces to the actuated pilot arms 3300 worn by the pilot 2, and the pilot 2 exerts force against said applied forces. The exerted force is reflected in updated sensor data captured by the encoders 3211, 3212, 3213 and the wrist inertial measurement units 3220, which sensor data is processed into updated control data and transmitted back to the robot 1, causing the robot 1 to apply additional force to an object in the environment surrounding the robot 1. The closed-loop teleoperation mode is selected for operation across a network 2999A-X having a transmission bandwidth and transmission latency that supports bidirectional state exchange between the wearable training apparatus 3200 and the robot 1 at a rate compatible with the control rate set forth above. [SUPPORT GAP: a specific control law (e.g., admittance, impedance, force-position) governing the bidirectional force coupling is not specified in the original disclosure; the closed-loop mode is described functionally without specifying a particular control law.]

### G. CONTROL OF META-OPERATIONS

During operation of the robot data collection computer 3010, the pilot 2 and/or other users (e.g., supervisors, trainers, safety observers, potentially logged in with different permission levels) may cause activation or deactivation of one or more meta-control actions that do not directly control the primary kinematic chain or end-effector motion of the robot 1. For example, the pilot 2 and/or other user may enable or disable the robot clutch 3140 (a mechanism, potentially implemented in software, hardware, or a combination thereof, configured to selectively decouple pilot input from robot motion commands, possibly with adjustable levels of decoupling or filtering), activate or deactivate data collection operations (e.g., logging of sensor data, pilot actions, robot state information for training purposes, potentially selecting specific data streams to log), reset the robot 1 to a neutral or predefined home position, initiate diagnostic routines, switch robot operational modes (e.g., from teleoperation to autonomous execution of a learned task, or between different control gains or compliance settings), adjust control system parameters (e.g., sensitivity, damping, force feedback intensity), trigger safety stops, define virtual fixtures or restricted zones in the robot workspace, or perform other robot control operations not directly mapped to the pilot's primary limb movements. In an embodiment, the data collection system 3010 (e.g., the computer 3110, the piloting control system 3202, and/or other control elements such as dedicated microcontrollers or field-programmable gate arrays (FPGAs) within the system 3010, potentially employing distributed processing architectures) may execute a method 4400 for enabling robot meta-control. The piloting control system 3202 is free of reliance on a single primary input modality for issuing meta-commands during teleoperation, in that meta-commands may be initiated through any of a plurality of input modalities each independent of motion of the actuated pilot arms 3300 and of the glove components 3400 used for primary teleoperation control of the robot 1.

In some embodiments, the mapping between pilot actions and meta-commands may be adaptive, configurable by the user, or selected based on the current task context. As described further below, the method 4400 allows for the pilot 2 to control these secondary or supervisory operations of the robot 1 by performing motions or other actions that do not correspond to available degrees of freedom (DoF) or mapped primary control motions for the robot 1. Accordingly, the meta-control operations performed by the pilot 2 do not necessarily cause corresponding primary motion of the robot 1 and may optionally not be recorded in the collected robot training data intended for imitation learning, although the meta-command itself and the resulting system state change may be logged for system analysis or context. Feedback confirming the execution of meta-commands may be provided through various modalities, including visual cues in the HMD 3152, specific auditory signals (e.g., distinct tones, synthesized speech confirmation), or haptic feedback (e.g., vibration patterns delivered via glove components 3400 or the wearable apparatus 3200). Accordingly, by allowing the pilot 2 to perform additional meta-control operations using non-traditional input modalities, the techniques disclosed in the method 4400 may reduce the number of human operators required to operate the computer 3010, potentially eliminating the need for a separate monitoring technician for certain tasks. Additionally, as described below, as compared to semi-stationary teleoperation systems, using the method 4400 may not require the use of stationary pedals or other stationary foot controls, and thus may allow for greater mobile movement of the pilot 2 and/or the wearable training apparatus 3200, facilitating data collection in diverse and potentially uninstrumented environments.

In a further embodiment, the method 4400 includes monitoring multiple input modalities concurrently. The monitored input modalities comprise at least two of: gaze direction captured by the head-mounted display 3152; mouth-controller input captured by an intra-oral sensor; finger abduction captured by the glove components 3400 or by an imaging sensor directed toward the hands of the pilot 2; voice input captured by a microphone; facial gesture input captured by a camera of the head-mounted display 3152 or by a facial electromyography sensor; foot pressure or foot motion captured by a sensor worn by the pilot 2; and body or arm gesture input captured by an imaging sensor or motion sensor. The piloting control system 3202 detects, in block 4420, that one of the monitored input modalities has produced a meta-command issued by the pilot 2, and in response to said detection, executes in block 4422 the meta-command. [SUPPORT GAP: arbitration or priority logic specifying behavior when two or more monitored input modalities concurrently produce conflicting candidate meta-commands is described at a high level in the original disclosure but specific arbitration rules are not specified; the method 4400 is described functionally as employing a priority scheme, state-machine logic, or arbitration logic if multiple commands are detected simultaneously or in close succession.] In a further embodiment of the method 4400, the meta-command is executed in response to a combination of inputs from two or more of the monitored input modalities. In a specific case, a gaze fixation on a user interface element 4502 displayed within the head-mounted display 3152 is combined with a confirming input from a second modality comprising at least one of: a finger abduction satisfying an abduction threshold, a voice input matching a confirmation phrase, a facial gesture matching a confirmation pattern, or an intra-oral input matching a confirmation pressure or contact pattern. The combination produces a confirmed selection that is more selective than gaze fixation alone, because the confirming input from the second modality is generated only when the pilot 2 deliberately performs a non-incidental action in addition to looking at the user interface element 4502. The combination of a gaze fixation with a confirming non-gaze input establishes a deliberate command confirmation threshold, which results in the prevention of unintentional command activations during passive visual scanning of the environment.

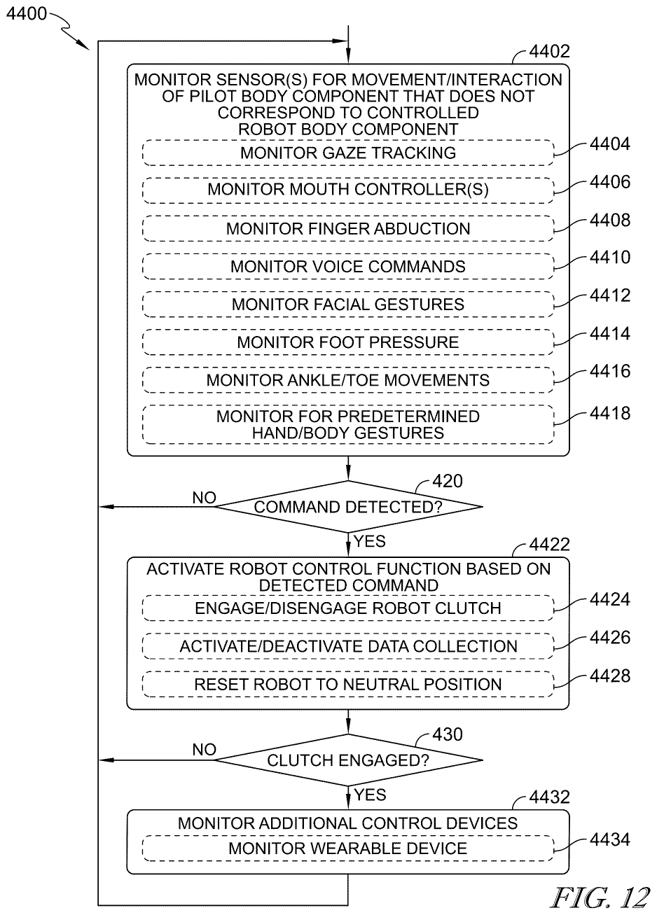

Referring now to FIG. 12, flowchart 4400 shows a method for meta-control of the humanoid robot data collection computer 3010. The method 4400 is executed by the computer 3110 in the illustrative embodiment. Additionally or alternatively, in some embodiments the method 4400 may be executed by one or more computing devices including the computer 3110, the robot 1 (e.g., its onboard processors), the piloting control system 202, dedicated processing units within the wearable apparatus 3200, and/or one or more other computers, servers, edge computing devices, and/or other computing devices networked with the computer 3010. The method 4400 may be executed in connection with, potentially in parallel or interleaved with, one or more other data collection and primary motion control routines executed by the data collection computer 3010, as described above. The method 4400 begins in block 4402, in which the computer 3110 continuously or periodically monitors one or more sensor(s) for a movement, physiological signal, or other interaction from the pilot 2 that does not correspond to a controlled robot 1 body component or primary motion mapping. For example, the computer 3110 may monitor for one or more predetermined input commands, actions, gestures, physiological states (e.g., heart rate variability, electrodermal activity, potentially indicating cognitive load or stress), vocalizations, or other operations originating from the pilot 2 but distinct from the primary teleoperation inputs (e.g., arm, hand, leg movements mapped to the robot). The computer 3110 may monitor one or more different sensor modalities, potentially fusing data from multiple modalities to improve robustness, resolve ambiguity, or expand the command vocabulary. The system might also predict the pilot's need for a meta-command based on interaction patterns or environmental context and prompt the pilot accordingly.

In some embodiments, in block 4404, the computer 3110 may monitor gaze tracking data, for example provided by one or more gaze tracking sensors included in a head-mounted display (HMD) 3152. For example, the HMD 3152 may include one or more cameras directed towards the user's eye(s) to capture images or video streams. Those cameras may be embodied as small, high-frame-rate (e.g., >60 Hz, potentially 90 Hz, 120 Hz, or higher, up to 240 Hz or more for fine-grained analysis like microsaccade detection) near-infrared cameras integrated into the HMD 3152 structure, often positioned unobtrusively around the HMD lenses. Additionally, the HMD 3152 may include one or more illumination sources, such as one or more near-infrared (NIR) light sources (e.g., LEDs operating at wavelengths such as 850 nm or 940 nm) to illuminate the eye, thereby creating reflections (glints) on the cornea and highlighting the pupil, which aids in robust tracking under varying ambient light conditions and minimizes visible distraction to the pilot. Processors (which may be onboard the HMD 3152, within computer 3110, or distributed) analyze the captured images using computer vision algorithms to detect key eye features. This may involve identifying the pupil (e.g., its center using ellipse fitting or centroid calculation and contour using edge detection or template matching) and often corneal reflections (glints, typically appearing as small, bright spots). The relative positions of these features (e.g., the vector between the pupil center and the glint center, known as the Pupil-Corneal Reflection (PCR) vector) may be used to calculate the gaze vector (the 3D direction the eye is pointing) and estimate the point of regard (where the gaze vector intersects with a real or virtual surface, such as the HMD display 3150 or objects identified in the robot's environment, potentially using depth estimation derived from binocular gaze convergence). In some embodiments, eye-tracking data may be integrated with input from other sensors. For example, eye-tracking data may be integrated with data from inertial measurement units (IMUs) within the HMD 3152 tracking head orientation and other sensors (e.g., world-facing cameras on the HMD 3152 performing Simultaneous Localization and Mapping (SLAM)) for comprehensive spatial tracking and coordinate transformations, allowing the system to determine what the pilot is looking at in the 3D world coordinate frame, not just on the display surface. Analysis of pupil diameter (pupillometry) captured by the same cameras might also provide information on cognitive load or emotional state, potentially used to modulate system behavior or confirm high-stakes commands. Furthermore, analysis of subtle eye movements during fixation, such as microsaccades, could potentially serve as an additional, less obtrusive input channel.

The cameras of the head-mounted display 3152 may operate at a frame rate of at least 60 Hz, and in further embodiments operate at frame rates including approximately 90 Hz, approximately 120 Hz, or approximately 240 Hz. In a specific embodiment, the near-infrared light sources operate at wavelengths comprising approximately 850 nm or approximately 940 nm. The near-infrared illumination at said wavelengths produces corneal reflections that are detectable by the cameras across a range of ambient lighting conditions while remaining outside the visible spectrum perceived by the pilot 2. The combination of the cameras and the near-infrared light sources of the head-mounted display 3152 thereby supports gaze tracking under a range of ambient lighting conditions experienced during teleoperation sessions of the robot 1.

Multiple potential approaches may be used to interpret and process the gaze tracking data. For example, in an embodiment the computer 3110 may perform direct position mapping, in which the calculated point of gaze on the display 3150 directly determines the position of a cursor or pointer 4504. For example, a pointer 4504 may be moved based on pupil movement relative to a reference frame. This technique aims to mimic traditional mouse pointing using the eyes, but may require filtering or smoothing algorithms (e.g., Kalman filters, moving averages) to compensate for natural eye saccades and jitter. As another example, the computer 3110 may perform region/object identification, in which, instead of continuous cursor movement, gaze fixation (maintaining gaze within a certain spatial threshold for a minimum duration) is used to identify which user interface (UI) element 4502, region or identifiable object (e.g., chair 4514, robot hand 56) the pilot 2 is looking at. This technique may act like a “hover” state triggered by gaze direction, which can then be combined with a selection mechanism (like dwell time or a button press, as described further below). This approach may be less sensitive to minor eye jitter compared to direct mapping, as it relies on fixation detection rather than precise point mapping. As yet another example, the computer 3110 may perform context-aware targeting, in which gaze direction is correlated with data from a world-facing camera (e.g., on the HMD 3152 or the robot 1) and image recognition or 3D scene understanding algorithms. In this technique, gaze isn't just mapped to a virtual display coordinate, but is used to identify real-world objects or specific locations within the robot's operational environment, which are then tagged or highlighted in the pilot's view (e.g., via AR overlay), which in turn may trigger context-specific UI interactions within the AR overlay. As a further example, the computer 3110 may perform indirect influence, in which gaze data is not used to move a cursor or select targets directly, but is used to control other system parameters, such as adaptive optics (adjusting focus or resolution based on gaze point, known as foveated rendering), highlighting potentially relevant objects based on gaze patterns, or subtly influencing robot attention mechanisms. Another embodiment involves gaze-contingent UIs, where menus or controls only appear or become interactable when the pilot looks towards a specific region of the display, reducing visual clutter.

As described above, certain approaches for processing gaze data may include one or more selection mechanisms to determine when a particular user interface element, object, or location has been selected by the user. For example, in an embodiment the computer 3110 may implement a dwell time, in which the pilot 2 holds their gaze (maintains fixation) on a target (e.g., a software overlay control 4502, a real-word object like chair 4514, or other target) for a predefined duration (e.g., configurable between 0.5-1 second, potentially adjusted based on context or user preference) to trigger selection. This is a common hands-free method but can feel slow or lead to accidental selections if dwell times are too short, known as the Midas Touch problem. Dwell time may be a baseline technique for gaze-only interaction, often combined with visual feedback (e.g., a filling circle or progress bar) to indicate dwell progress. As another example, in an embodiment, the computer 3110 may combine gaze for targeting with a physical trigger. Continuing that example, the user looks at a target and presses a physical button (on a handheld controller, the IMID 3152 itself, a glove component 3400, a bite sensor 4604/4608, a smart ring 4610, or another input device) to confirm selection. This method is often faster and more accurate than dwell time, providing explicit confirmation and avoiding the Midas Touch problem (described further below), but may sacrifice the completely hands-free benefit. As another example, the computer 3110 may combine gaze with a different secondary input such as voice or gesture. Continuing that example, gaze may be used for targeting while a voice command (e.g., an annunciated “select”, “activate”, or other predetermined or context-sensitive command), or a specific hand/finger (e.g., finger abduction as in block 4408)/head gesture (e.g., a deliberate nod or shake detected by HMD IMUs) triggers the action. As yet another example, the computer 3110 may interpret gaze shift patterns or specific eye movements (e.g., smooth pursuit, saccades towards a specific location after fixation, or specific voluntary blink patterns like a double-blink) to determine specific eye movement patterns as commands. For example, different controls may be selected based on predictable saccadic shifts in gaze after initially focusing gaze on a predetermined start control or menu item. This technique may require more sophisticated gaze path analysis and potentially user calibration.

Gaze tracking embodiments may be structured to avoid the so-called “Midas Touch” problem (unintentionally activating controls simply by looking at them) and to otherwise avoid unintentional activation of gaze commands. Mitigation strategies may include requiring a secondary confirmation action, thus preventing activation based solely on gaze landing on a target. As described above, such secondary confirmation actions may include dwell time, which requires sustained gaze for activation, filtering out brief glances. However, dwell time introduces delay and can still lead to accidental activation if the user rests their gaze unintentionally. As another example, secondary confirmation actions may include explicit confirmation, such as a button press, voice command, or gesture performed concurrently with gaze. This is highly effective but may compromise the purely gaze-driven interaction. As another example, secondary confirmation actions may include gaze gestures, such as requiring specific eye movement patterns (beyond simple fixation) to trigger actions, like a deliberate “stare-and-blink” or a specific sequence of saccades or smooth pursuit movements following a defined path. Additionally or alternatively, the UI design itself may be structured to minimize the chance of accidental activation, for example by using dedicated activation zones (areas where gaze must be directed to enable selection functionality), requiring a two-step selection process (e.g., look to select, look at a confirmation button), appropriate spacing and sizing of interactive elements, using gaze-contingent activation where controls are only sensitive after being looked at for an initial short period, or specific UI widgets designed for Midas Touch mitigation.

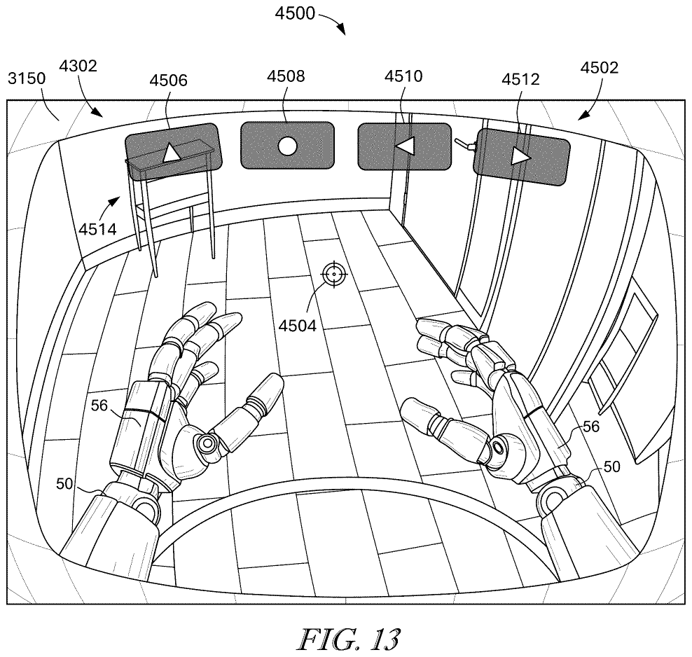

Referring now to FIG. 13, diagram 4500 illustrates one potential embodiment of an interface that may be provided by the wearable training apparatus 3200 for use with gaze-tracking interactions. Similar to the interface 4300 shown in other embodiments, the wearable training apparatus 3200 may receive video data from the robot 1, for example from multiple stereoscopic cameras mounted to the head 10 of the robot 1, and may map the video data onto a virtual environment displayed by the HMD 3152, potentially correcting for distortion and aligning the virtual view with the pilot's head movements. Illustratively, FIG. 13 shows a single subimage 4302; however, in other embodiments the HMD 3152 may display separate subimages 4302 for each eye, for example to provide stereoscopic (3D) vision, enhancing depth perception. As shown, the pilot 2 may view stereoscopic video representing the current state of the robot 1 and/or the environment surrounding the robot 1. For example, in the illustrative embodiment, the display 3150 shows the wrists 50 and hands 56 of the robot 1, as well as a wall, floor, and other objects (e.g., chair 4514) in the environment of the robot 1. Additionally, the display 3150 (specifically, the display surface within the HMD) shows multiple overlaid user interface controls 4502, which are illustrated as rectangular wireframes for simplicity. In embodiments, the user interface controls 4502 may be embodied as icons, buttons, sliders, radio buttons, check boxes, text fields, radial menus, contextual pop-ups, virtual panels attached to the pilot's view or world-locked, and/or any other suitable user interface object, potentially rendered with transparency or specific visual styles to minimize obstruction of the underlying robot view, or rendered dynamically based on gaze as described above. The pilot 2 may interact with one or more of the user interface controls 4502 using any one or more of the gaze tracking and selection techniques as described above. For example, the pilot 2 may direct their gaze to one of the user interface controls 4502 and hold their gaze (fixate) on that control for longer than the dwell time in order to select the control 4502. Additionally or alternatively, the pilot 2 may use any other secondary input as described above to confirm a gaze selection. In an illustrative embodiment, the HMD 3152 may display a reticle 4504 (or cursor, pointer, highlight) at the user's current estimated gaze location, which may provide feedback to the pilot 2 and assist usability. In other embodiments, the HMD 3152 may display a different indication of the current gaze location (e.g., highlighting, outlining, subtle color change, or magnification of the gazed-at element) or may display no explicit indication of the current gaze location, relying solely on the selection feedback.

For example, in an illustrative embodiment, a user control 4506 may represent a robot clutch 3140 toggle control. When the pilot 2 directs their gaze to the control 4506 and confirms a selection (e.g., by remaining fixated for a dwell time, speaking a confirmation command, performing a confirmation hand gesture, or other secondary input as described above), the computer 3110 toggles the engagement state of the robot clutch 3140. That is, if the robot clutch 3140 is disengaged (pilot control active), the computer 3110 engages the robot clutch 3140 (pilot control paused), and if the robot clutch 3140 is engaged, the computer 3110 disengages the robot clutch 3140. Additionally, one or more visual characteristics of the control 4506 (e.g., color, shape, text label, icon state, animation or other characteristics) may be updated to reflect the current state of the robot clutch 3140 (e.g., changing from green “Active” to red “Paused”). Continuing that example, a user control 4508 may represent a data collection toggle control. When the pilot 2 directs their gaze to the control 4508 and confirms a selection as described above, the computer 3110 toggles the activation state of data collection (e.g., training data logging). That is, if data collection is stopped, the computer 3110 starts data collection, and if data collection is currently active, the computer 3110 stops data collection. Additionally, one or more visual characteristics of the control 4508 (e.g., color, shape, text label, or other characteristics) may be updated to reflect the current state of data collection (e.g., a recording icon appearing or disappearing).

Continuing that example, in an embodiment, multiple controls may coordinate to control robot motion incrementally or other meta-control functions for the computer 3010. In an embodiment, user controls 4510, 4512 may control robot bend or lean angle incrementally or continuously while selected. For example, when the pilot 2 directs their gaze to the control 4510 (e.g., an “Increase Lean Left” button) and confirms and holds a selection as described above (e.g., maintains dwell or holds a confirmation button), the computer 3110 may initiate a predetermined robot motion, such as leaning or bending in a particular direction at a predetermined rate or by a predetermined increment. When the pilot 2 directs their gaze away from the control 4510 or releases the confirmation input, the computer 3110 may stop the robot motion. Continuing, when the pilot 2 directs their gaze to the control 4512 (e.g., an “Increase Lean Right” button) and confirms and holds a selection as described above, the computer 3110 may initiate another predetermined robot motion, such as leaning or bending in an opposite direction. When the pilot 2 directs their gaze away from the control 4512 or releases the confirmation input, the computer 3110 may stop the robot motion. Of course, other combinations and/or arrangements of user controls (e.g., virtual sliders adjusted by looking at the ends or using a secondary input, gaze-based dragging of virtual controls) and corresponding robot meta-control functions (e.g., sliders for continuous adjustment, numerical input fields) may be possible in other embodiments.

Additionally or alternatively, in some embodiments, the computer 3110 may provide for gaze-based interaction with one or more real-world objects in the environment of the robot 1 (or parts of the robot 1 itself) that are represented or identifiable in the head-mounted display 3152. For example, in the illustrative embodiment shown in FIG. 13, the pilot's gaze may be directed to a part of the HMD 3152 display 3150 corresponding to a location on the floor in front of the robot 1, as illustrated by the reticle 4504 shown in FIG. 13. When the pilot 2 confirms selection of this location (e.g., using dwell time, a button press, etc.), for example by speaking a vocal command such as “Move here” or another predetermined vocal command, or by performing confirmation with another secondary input as described above, the computer 3110 may cause the robot 1 to move to the location in its environment represented by the location of the reticle 4504, potentially using the robot's navigation stack or motion planning capabilities. In another embodiment, the pilot could trace a path on the floor or environment using gaze combined with a continuous confirmation signal (e.g., holding a button) to define a trajectory for the robot.

In addition to directing movement to locations in the environment of the robot 1, in some embodiments the computer 3110 may support gaze-based interaction with one or more objects positioned in the environment of the robot 1, identified through sensor data (e.g., camera vision, LiDAR) and object recognition algorithms. For example, in the illustrative embodiment shown in FIG. 13, a chair 4514 is displayed by the HMD 3152. When the pilot 2 directs their gaze to the chair 4514 (or a bounding box or highlight overlaid on it) and confirms selection of this object, the computer 3110 may activate an appropriate command for the computer 3010. The selected command may depend on the size, location, type (e.g., object recognition classification: “chair,” “box,” “door handle”), affordances (e.g., “graspable,” “pushable”), state (e.g., “door open”, “switch on”), or other characteristics of the selected object. In the illustrative embodiment, the robot 1 may move near to interact with the selected chair 4514. In another embodiment, the robot 1 may perform a predetermined motion associated with the object type. For example, if the object is recognized as a box, the computer 3110 may cause the robot 1 to initiate a grasp sequence for the box (for example, using a predetermined “pick and place” functionality or motion primitive library of the robot 1). Similarly, gazing at a door handle and confirming might trigger a door-opening routine. In further embodiments, gazing at an object might bring up a contextual menu (via AR overlay) offering several possible meta-commands related to that object (e.g., for a box: “Pick Up”, “Push”, “Inspect”).

Additionally or alternatively, in some embodiments the computer 3110 may select/support gaze-based interaction with one or more parts of the robot 1 itself, visually represented in the HMD 3152 view. For example, in the illustrative embodiment shown in FIG. 13, both of the hands 56 and the wrists 50 of the robot 1 are visible in the HID 3152. When the pilot 2 directs their gaze to a visible part of the robot 1 (e.g., highlighted via segmentation or kinematic model overlay) and confirms selection of this part, the computer 3110 may cause one or more predetermined robot motions or other robot operations associated with the selected robot part. For example, if the pilot 2 directs their gaze to the left hand 56 and confirms selection, the computer 3110 may cause the left hand 56 to grasp and/or un-grasp (toggle grasp state or execute a predefined grasp/release sequence). Similarly, if the pilot 2 directs their gaze to the right hand 56 and confirms selection, the computer 3110 may cause the right hand 56 to grasp and/or un-grasp. As another example, if the pilot 2 directs their gaze to the left wrist 50 and confirms selection, the computer 3110 may cause the left wrist 50 to rotate incrementally or continuously in a predetermined direction (e.g., pronation or supination), perhaps using gaze direction relative to the wrist center to determine rotation direction or speed. Similarly, if the pilot 2 directs their gaze to the right wrist 50 and confirms selection, the computer 3110 may cause the right wrist 50 to rotate in a predetermined direction (e.g., pronation or supination). This allows for targeted adjustments or actions on specific robot parts without needing complex hand gestures or menu navigation. Gazing at a specific joint could also bring up controls to adjust its stiffness or compliance parameter.

Referring again to FIG. 12, in some embodiments in block 4406 the computer 3110 may monitor for input from one or more mouth controller(s) coupled (wired or wirelessly) to the wearable training apparatus 3200 or communicating directly with computer 3110. Mouth controllers may allow the pilot 2 to control functions of the robot 1 using lip, tongue, jaw, bite, breath pressure (sip/puff), or intraoral air pressure movements that are not otherwise sensed by the wearable training apparatus (or are intentionally decoupled from primary control channels) and are not performed by the robot 1. In some embodiments, the mouth controllers may include one or more established assistive technologies, such as sip-and-puff systems or bite sensors, adapted for this meta-control application. Other embodiments may utilize sensors detecting jaw motion (e.g., via chin-mounted IMUs or strain gauges), intraoral air pressure sensors measuring pressure changes within the closed mouth cavity, or even miniature ultrasonic transducers for tracking tongue position and shape without direct contact or magnets. The computer 3110 receives mouth-controller data from said mouth controller via a wired or wireless link, classifies the received data as one of an instantaneous command, a continuous command, or a proportional command, and maps the classified command to a meta-command of the humanoid robot data collection system 3010.

Sip-and-puff systems are an established assistive technology that relies on detecting changes in air pressure generated by the user sipping (i.e., inhaling) or puffing (i.e., exhaling) into a tube or wand, typically connected to a pressure transducer. By varying the pattern (e.g., number of puffs/sips, timing) of inhalation and exhalation and/or the air pressure or flow rate of each inhalation or exhalation-such as short sips, long sips, short puffs, long puffs, hard sips (high negative pressure), soft sips (low negative pressure), hard puffs (high positive pressure), soft puffs (low positive pressure), or sequences or combinations (e.g., puff-sip sequence) of these actions-users can selectively execute a set of distinct commands, decoded by analyzing the pressure signal profile over time. In an embodiment, the computer 3110 may recognize one or more sip-and-puff actions as instantaneous commands (discrete events) to activate and/or deactivate robot functions. For example, in an embodiment the computer 3110 may recognize a hard puff as a command to engage the robot clutch and a hard sip as a command to disengage the robot clutch. As another example, in an embodiment the computer 3110 may recognize a soft puff as a command to start data collection and a soft sip as a command to stop data collection. Of course, other combinations and mappings of sip-and-puff actions (e.g., double puff, sip-puff sequence) and robot commands are possible in other embodiments. For example, in an embodiment a hard puff or a hard sip may toggle the engagement state of the robot clutch (requiring only one distinct pressure level but different actions), and a soft puff or a soft sip may toggle the activation state of data recording.

In an embodiment, the computer 3110 may recognize one or more sip-and-puff actions as continuous commands that continue as long as the pilot 2 continues performing the sip-and-puff action (e.g., maintaining a certain pressure level). For example, in an embodiment, the robot clutch may remain engaged while the user performs a puff action or a sip action above a certain threshold pressure. As another example, the computer 3110 may move the robot 1 between robot states (e.g., adjust lean angle) proportionally according to the duration or sustained pressure level of the sip-and-puff action. For example, in an embodiment the robot 1 may lean in a particular direction at a rate proportional to puff pressure while the pilot 2 is performing a sustained sip action, allowing the pilot 2 to stop the robot 1 when it has reached the desired lean angle by ceasing the action. In an embodiment, the robot 1 may lean in an opposite direction while the pilot 2 is performing a sustained puff action, allowing the pilot 2 to correct the robot lean and/or lean the robot in a different desired direction. In a further embodiment, similar continuous sip-and-puff control may be used to control robot 1 bending motion (e.g., bending at the robot waist). In an embodiment, sip-and-puff controls may be used to control both leaning and bending functions of the robot 1, perhaps using different pressure thresholds or patterns for each axis. For example, a hard puff (>P1) may be used to control robot bend angle in one direction, and a hard sip (<−P1) may be used to control robot bend angle in an opposite direction. Continuing that example, a soft puff (between P2 and P1, where P2<P1) may be used to control robot lean angle in one direction, and a soft sip (between −P2 and −P1) may be used to control robot lean angle in an opposite direction. Of course, other combinations of sip-and-puff action and robot meta-control commands are possible. The dual-threshold pressure scheme produces four distinguishable command regions per sign of pressure across a continuous pressure axis, allowing one input transducer to convey four distinct meta-commands in addition to a no-command rest region.

Similarly, bite-activated sensors offer another potential discrete or analog input channel for the wearable training apparatus 3200. Bite-activated sensors have been used in the context of assistive feeding robots. In that application (as context, not claimed here), sensors (potentially bite sensors, or other sensors like microphones detecting chewing/swallowing sounds) are used to infer the user's readiness for the next bite of food, allowing the robot to time the feeding action appropriately. In the illustrative embodiment, the user may activate a bite sensor with one or more predetermined bite patterns or sequences (e.g., single bite, double bite, bite-and-hold, rhythmic biting) and/or different bite pressures (e.g., light tap vs. hard clench) in order to activate distinct commands. Additionally, certain bite sensors (e.g., multi-element sensors integrated into a mouthguard) may detect bite pressure in different parts or quadrants of the user's mouth (e.g., front, back, left molar region, right molar region, or other part of the user's mouth), and the particular part or quadrant of the mouth where pressure is applied may be used to activate distinct commands. Sensors could employ various transduction methods, such as piezoresistive, capacitive, piezoelectric, or optical sensing principles. In some variations, bite sensors might be combined with sip/puff inputs, requiring both actions simultaneously (e.g., bite while puffing) to trigger a specific command, increasing the command set size or adding a layer of safety confirmation.

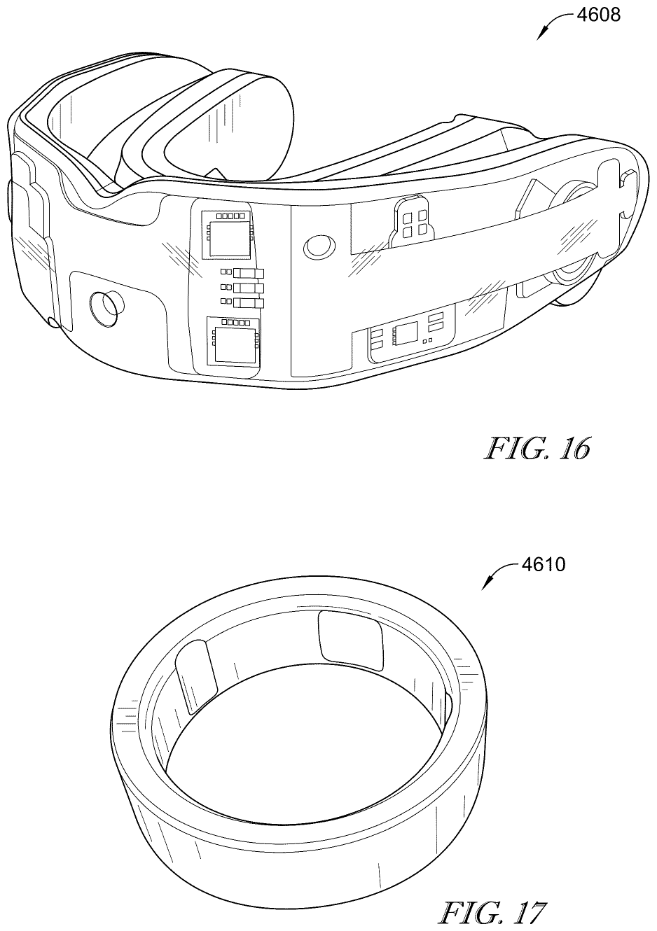

Referring now to FIG. 16, an illustrative smart mouth guard 4608 is shown. The smart mouth guard 4608 may include one or more pressure transducers, accelerometers, gyroscopes, strain gauges, capacitive sensors, or other motion sensors, and/or other sensors configured to detect bite force, duration, location, and potentially jaw motion by the user. The smart mouth guard 4608 may communicate wirelessly (e.g., via Bluetooth Low Energy (BLE), NFC, or proprietary protocols) with the computer 3110 and/or other components of the computer 3010 in order to provide mouth controller data.

In an embodiment, the computer 3110 may recognize one or more bite actions as instantaneous commands to activate and/or deactivate robot functions. For example, in an embodiment the computer 3110 may recognize a single short bite as a command to engage the robot clutch. Continuing that example, the computer 3110 may recognize a double bite or other predetermined sequence of bites (e.g., within a specific time window) as a command to disengage the robot clutch. As another example, the computer 3110 may recognize a hard bite (e.g., a detected bite with a bite pressure above a predetermined threshold T_hard T_{hard} or other relatively high bite pressure) as a command to toggle the engagement state of the robot clutch. As another example, in an embodiment the computer 3110 may recognize a soft bite (e.g., a detected bite with a bite pressure below the predetermined threshold T_{hard} but above a noise threshold T_{soft} or other relatively low bite pressure) as a command to toggle activation state of data collection. Of course, other combinations of bite actions and robot commands are possible in other embodiments. For example, in an embodiment a bite detected toward the front of the pilot's mouth (e.g., incisor region sensor) may toggle the engagement state of the robot clutch, and a bite detected toward the back of the pilot's mouth (e.g., molar region sensor) may toggle the activation state of data recording. As yet another example, in an embodiment, the computer 3110 may recognize one or more bite actions as continuous commands that continue while the pilot 2 continues performing the bite action. For example, in an embodiment, the robot clutch may remain engaged while the user maintains bite pressure above a certain threshold.

Additionally or alternatively, in an embodiment, the computer 3110 may recognize bite pressure as a proportional command or other non-binary command. For example, the computer 3110 may move the robot 1 between robot states proportionally according to the detected bite pressure level. For example, in an embodiment the robot 1 may lean in a particular direction at a rate proportional to bite pressure on the left molar sensor while the pilot 2 is applying bite pressure, allowing the pilot 2 to stop the robot 1 when it has reached the desired lean angle by releasing the pressure. In an embodiment, the robot 1 may lean in an opposite direction while the pilot 2 is applying bite pressure to a different part or quadrant of the mouth (e.g., right molar sensor), allowing the pilot 2 to correct the robot lean and/or lean the robot in a different desired direction. In a further embodiment, similar proportional bite control may be used to control robot 1 bending motion (e.g., bending at the robot waist). In an embodiment, bite controls may be used to control both leaning and bending functions of the robot 1. For example, average bite pressure applied across both front and back sensors may be used to control robot bend angle (e.g., forward bend proportional to pressure), and differential bite pressure applied to the left vs. right side sensors may be used to control robot lean angle (e.g., lean left if left pressure>right pressure). Of course, other combinations of bite sensor action and robot meta-control commands are possible.

Other hands-free mouth controllers that may be used in alternative embodiments to control the computer 3010 may include the Inductive Tongue Computer Interface (ITCI), which includes a custom-fitted palatal retainer containing an array of inductive sensors (e.g., up to 18 sensors). A small ferromagnetic activation unit (AU), which may be attached to the tongue via piercing or gluing, activates specific sensors as the user moves their tongue. This allows for a relatively large number of discrete commands (up to 18). Furthermore, by interpolating signals from adjacent sensors, the ITCI can emulate a continuous 2D joystick or touchpad, enabling proportional control. The system is wireless and can be virtually invisible when the mouth is closed. As another example, the Tongue Drive System (TDS) uses an array of magnetic sensors (e.g., Hall effect sensors), for example mounted on an external headset or integrated into the HMD 3152, to track the position of a small permanent magnet attached to the user's tongue (via piercing or gluing). The system translates detected tongue positions (relative to the sensor array) into discrete commands (e.g., six commands corresponding to different tongue locations like up, down, left, right, forward, back) or continuous joystick-like signals based on the magnet's estimated 2D or 3D position. Alternative tongue controllers might use capacitive sensing between the tongue and a retainer, electropalatography (EPG) mapping detailed tongue-palate contact patterns, or optical tracking of a tongue-mounted marker. In a further embodiment using the ITCI, tongue motion along a front-to-back axis is mapped to robot bend angle and tongue motion along a left-to-right axis is mapped to robot lean angle, the two-dimensional tongue position thereby enabling continuous proportional control of robot lean and bend along orthogonal axes.

In an embodiment utilizing such tongue controllers, the computer 3110 may recognize one or more tongue control actions (e.g., contacting a specific sensor, moving the magnet to a specific zone, achieving a specific EPG pattern) as instantaneous commands to activate and/or deactivate robot functions. For example, in an embodiment the computer 3110 may recognize a tongue interaction with a particular sensor (e.g., upper left sensor in ITCI) as a command to engage the robot clutch and a tongue interaction with a different sensor (e.g., upper right sensor) as a command to disengage the robot clutch. As another example, in an embodiment the computer 3110 may recognize a tongue command with yet another sensor (e.g., center sensor) as a command to start data collection and tongue command with yet a different sensor (e.g., lower center sensor) as a command to stop data collection. Of course, other combinations of tongue commands (e.g., specific movement patterns like a swipe across sensors, or holding a specific contact pattern) and robot commands are possible in other embodiments. For example, in an embodiment a tongue command with a particular sensor may toggle the engagement state of the robot clutch, and tongue command with a different sensor may toggle the activation state of data recording.

In an embodiment, the computer 3110 may recognize one or more tongue interactions as continuous commands that continue while the pilot 2 continues performing the tongue interaction. For example, in an embodiment, the robot clutch may remain engaged while the user maintains contact of the tongue AU with a particular sensor or keeps the tongue magnet within a specific region or maintains a specific EPG pattern. As another example, the computer 3110 may recognize tongue position as a proportional command or other non-binary command. For example, the computer 3110 may move the robot 1 between robot states proportionally according to the interpolated, relative position of the tongue (e.g., derived from ITCI sensor interpolation or TDS magnet tracking). Continuing that example, in an embodiment the robot 1 may lean in a particular direction proportionally to the leftward displacement of the tongue while the pilot 2 moves the tongue in a corresponding direction, allowing the pilot 2 to stop the robot 1 when it has reached the desired lean angle by returning the tongue to a neutral position. In an embodiment, the robot 1 may lean in an opposite direction while the pilot 2 moves the tongue in the corresponding opposite direction, allowing the pilot 2 to correct the robot lean and/or lean the robot in a different desired direction. In a further embodiment, similar proportional tongue control may be used to control robot 1 bending motion (e.g., bending at the robot waist). In an embodiment, tongue controls may be used to control both leaning and bending functions of the robot 1. For example, as described above, tongue control position may be interpreted as mapping to two-dimensional axes, similar to a joystick or touchpad. Continuing that example, tongue motion from front to back may be used to control robot bend angle (forward/backward bending), and tongue motion from left to right may be used to control robot lean angle (sideways leaning). Of course, other combinations of tongue command and robot meta-control commands are possible.

Referring back to FIG. 12, in some embodiments in block 4408 the computer 3110 may monitor for finger abduction or other specific finger/hand gestures. For example, in an embodiment the computer 3110 may monitor for abduction (spreading fingers apart) or other finger motions (e.g., specific finger taps, finger-thumb contacts like pinching, making a fist with only certain fingers extended, or more subtle microgestures like slight finger twitches if sensor resolution permits) made by the pilot 2 that the hands 56 of the robot 1 are incapable of performing or are intentionally not mapped to during primary control. The computer 3110 may use any sensor or combination of sensors to monitor for finger abduction or gestures. For example, in an embodiment, the computer 3110 may monitor finger position and orientation data received from one or more of the glove components 3400. Each of the glove components 3400 may include one or more digit sensors capable of determining the location and/or pose (position and orientation, potentially including joint angles) of the pilot's fingers and thumbs relative to the corresponding palm or a reference point on the glove/wrist. The glove component 3400 may, in some implementations, be a Manus™ Prime 3 Haptic XR glove or other similar glove used to track a pilot's hand. Each glove apparatus 3400 may include an electromagnetic field (EMF) source (emitter) to generate a magnetic field around each of the pilot's hands to determine the location and/or pose of the pilot's fingers and thumbs, equipped with corresponding magnetic sensors. The EMF source may be configured to create an alternating magnetic field with specific spatial and temporal characteristics. The one or more digit sensors (e.g., attached to fingertips or segments) may be configured to detect the magnetic field generated by the EMF source, allowing calculation of their 6DoF pose relative to the source. The location and/or pose of each of the pilot's fingers may be tracked with the one or more sensors, and the location of all the sensors may be tracked with the EMF source. The glove component 3400 may alternatively or additionally incorporate various sensor technologies, including but not limited to resistive bend sensors (measuring joint flexion/extension), inertial measurement units (IMUs) on each finger segment (providing orientation, potentially fused with other data for position), optical fiber sensors (measuring bending based on light attenuation), or capacitive touch sensors (detecting finger proximity or contact), to enhance the accuracy and granularity of hand and/or finger motion tracking. Haptic feedback capabilities of the gloves could also be used to guide the pilot in performing meta-control gestures correctly or to confirm recognition. The finger-abduction meta-control channel of block 4408 is free of reliance on a primary kinematic mapping to the hands 56 of the robot 1, in that the abduction motions monitored in block 4408 are selected from motions that operate orthogonally to the flexion and extension mappings used by the glove components 3400 to actuate the robotic gripper, such that finger abduction provides a meta-command channel during concurrent operation of the primary teleoperation.

Additionally or alternatively, the glove component 3400 of the wearable training apparatus 3200 may utilize mechanical linkages (e.g., exoskeletons with joint encoders) to determine the location and/or pose of the pilot's fingers and thumbs relative to their palm. The glove component 3400 may, in some implementations, be a force feedback or haptic feedback glove from Dexmo, Teslaglove from Teslasuit, Haptx Gloves G1, or another similar glove that can provide feedback to the pilot and track the motion of the pilot's hand. Such gloves often combine motion tracking (e.g., IMU, bend sensors) with feedback mechanisms (e.g., servo motors, pneumatic actuators, vibrotactile elements). The motion tracking data can be repurposed for detecting meta-control gestures. In a further embodiment, the mechanical-linkage glove embodiment of the glove component 3400 captures finger flexion, finger extension, and finger abduction through joint-angle measurements taken at the linkage joints, the joint-angle measurements being supplied to the computer 3110 for use in the same finger-abduction detection pipeline applied to data from the EMF-based gloves and the bend-sensor-based gloves.

Additionally or alternatively, in some embodiments, the computer 3110 may monitor video data or other image data indicative of the pilot's finger position(s), using computer vision techniques. For example, the wearable training apparatus 3200 may include one or more dedicated video cameras or other imaging sensors (e.g., depth cameras like time-of-flight or structured light sensors) pointed toward the pilot's hands and/or the glove components 3400 in order to track the location and/or pose of the pilot's fingers relative to their palm, without requiring instrumented gloves. As another example, one or more wide-angle cameras or other general-purpose cameras mounted to the wearable training apparatus (potentially including cameras on the HMD 3152 facing downwards/outwards) may include the pilot's hands and/or the glove compartments (e.g., glove components 3400) within the field of view of the cameras. Such cameras may be mounted to, for example, the base frame, the harness, one or more of the actuated pilot arms, one or more wrist assemblies, and/or other components of the wearable training apparatus 3200. Vision-based tracking could also detect gestures performed on surfaces, such as tapping patterns on the pilot's own leg or a designated area of the apparatus. The vision-based tracking embodiment is selected because it operates without instrumented gloves and is therefore available when the pilot 2 is not wearing the glove components 3400 or when the EMF source is unavailable, broadening the operating envelope of the finger-abduction meta-control channel.

The computer 3110 may use any appropriate articulated body pose estimation algorithm (e.g., model-based optimization, deep learning-based methods like MediaPipe Hands or OpenPose) or other technique to determine finger positions, joint angles, and overall hand pose of the pilot from sensor data (gloves or vision). For example, in some vision-based embodiments, the computer 3110 may estimate the finger position by minimizing differences between observed images and a predetermined 3D kinematic hand model or other model of the pilot's hands. As another example, in some embodiments the computer 3110 may estimate the finger position using one or more pretrained machine learning models (e.g., convolutional neural networks (CNNs), transformers), which may be trained to locate joint positions (landmarks) in three-dimensional space based on input two-dimensional image data or directly from glove sensor readings. Additionally or alternatively, rather than fully estimating the pose of the pilot's fingers, the computer 3110 may use a gesture recognition model (e.g., template matching, dynamic time warping (DTW), recurrent neural networks (RNNs), hidden Markov models (HMMs), or classifiers operating on pose features) to identify one or more predetermined finger abduction, adduction, flexion, extension, static pose, or dynamic gestures. The articulated body pose estimation pipeline produces a hand-pose data structure that is consumed by both the finger-abduction comparison stage described below and by the gesture-classification stage, such that the same pose data supports both threshold-based abduction detection and pattern-based gesture recognition.

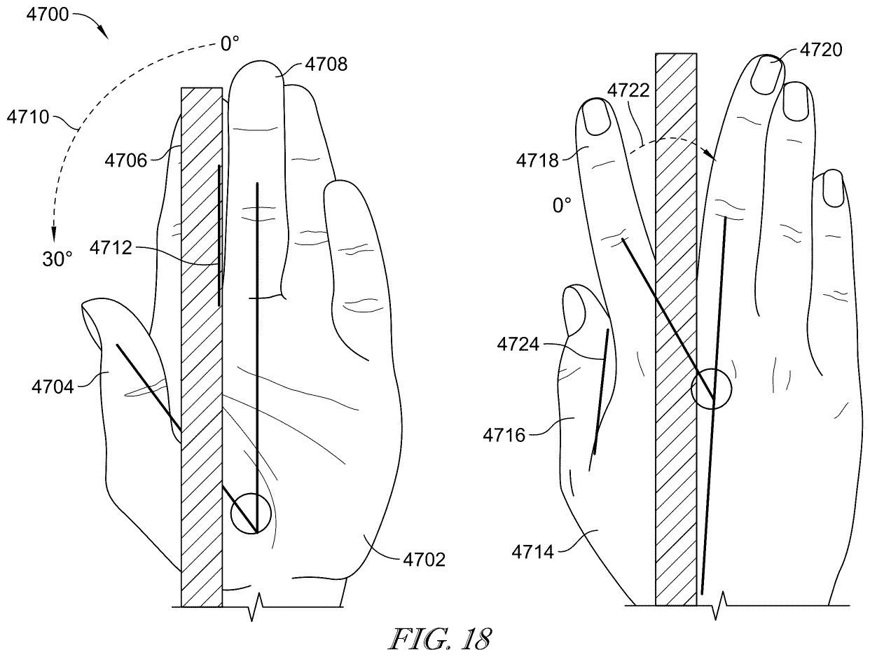

Referring now to FIG. 18, diagram 4700 illustrates potential finger abduction that may be detected by the computer 3110. The diagram 4700 illustrates a left hand 4702 and a right hand 4714 of the pilot 2. The hands 4702, 4714 may be placed within respective glove components 3400 in some embodiments, or tracked visually. As shown, for the left hand 4702, a thumb 4704 is separated apart from a first finger 4706 by an abduction angle 4710. The first finger 4706 is not separated from a middle finger 4708. Thus, the first finger 4706 and the middle finger 4708 may be separated by an abduction angle 4712 of zero (or below a threshold). Similarly, for the right hand 4714, a thumb 4716 is not separated from a first finger 4718, and the first finger 4718 is separated by an abduction angle 4722 from a middle finger 4720. Thus, the thumb 4716 and the first finger 4718 may be separated by an abduction angle 4724 of zero (or below a threshold).

The computing device 3110 may detect finger abduction, for example, by determining values for one or more of the abduction angles 4710, 4712, 4722, 4724, and/or abduction angles between other adjacent fingers (e.g., middle-ring, ring-pinky) and/or otherwise determining whether various fingers and/or thumbs of the pilot's hands 4702, 4714 are separated, potentially by calculating distances between fingertip landmarks or analyzing joint angles derived from the pose estimation. Additionally, although illustrated as determining abduction angles between the thumb and first finger and between the first finger and middle finger, it should be understood that in some embodiments the computer 3110 may determine abduction angles or separation metrics between any pair of digits (adjacent or non-adjacent) of the user's hands. For example, in an embodiment, the computer 3110 may determine whether any of the detected abduction angles exceed a predefined threshold; that is, the computer 3110 may determine one or more binary values indicating whether a respective pair of digits (i.e., thumb and/or finger(s)) are separated apart sufficiently to constitute a command signal. The computer 3110 may use this determination as one or more binary inputs or instantaneous inputs used to control one or more corresponding meta-functions of the computer 3010 (e.g., on/off, activate/deactivate, toggle state, etc.).

In some embodiments, each distinct abduction motion (e.g., thumb-index abduction vs. index-middle abduction) or specific static finger pose (e.g., “OK” sign, pointing, fist) or dynamic finger gesture (e.g., finger tapping sequence, pinching motion) may be assigned to a different meta-function or other control of the computer 3010. For example, as described further below, abduction of the left thumb 4704 from the left first finger 4706 beyond an angle θ_th,L may engage the robot clutch 3140, abduction of the left first finger 4706 from the middle finger 4708 beyond an angle θ_{12,L} may disengage the robot clutch 3140, abduction of the right thumb beyond angle θ_{th,R} may start data gathering, and abduction of the right first finger from the middle finger beyond angle θ_{12,R} may stop data gathering. Of course, other assignments of digits, angles, gestures, and/or functions may be used in other embodiments, and/or in some embodiments the assignment of digits and functions may be configurable by the user or system administrator. Coordinated gestures involving both hands (e.g., bringing index fingers together) could also be mapped to specific meta-commands. The threshold-based abduction-to-meta-command mapping does not require the pilot 2 to interrupt the primary kinematic teleoperation of the wearable training apparatus 3200, in that the abduction motions are performed by the pilot 2 within the same hand pose used for primary control of the hands 56 of the robot 1.

As another example, in an embodiment, the computer 3110 may determine one or more continuous angle values representing the abduction angle between a respective pair of digits, or other continuous pose parameters like finger flexion or pinch distance. These one or more angle values (potentially normalized or scaled) may be used as analog input, proportional control input, or other real-valued user inputs to control one or more corresponding meta-functions of the system 3010. For example, the angle value θ_{12,L} may be used to control the rate of robot bending or the target lean angle, or any other proportional control of the system 3010 (e.g., adjusting sensitivity parameter, scrolling through a list, setting a force limit). The speed or acceleration of a dynamic finger gesture could also be used as a proportional input. The proportional finger-abduction embodiment is selected because the abduction angle varies continuously across a measurable range during deliberate digit separation by the pilot 2, which results in a continuous control signal that may be used to drive proportional meta-commands of the computer 3010.

As another example, the computer 3110 may determine abduction values (e.g., binary values based on thresholds, proportional values representing angles, or other values) for each pair of adjacent digits on each hand, potentially combined with flexion/extension states for each joint. Those abduction values may be represented as a vector of abduction values (a feature vector representing the hand state). As an example, each hand may be represented as a four-value vector V_{hand} [v_{th,1}, v_{1,2}, v_{2,3}, v_{3,4}], with the values of the vector representing the abduction value determined between the thumb and first finger (v_{th,1}), the first finger and the second finger (v_{1,2}), the second finger and the third finger (v_{2,3}), and the third finger and the fourth finger (v_{3,4}). As a concrete example, the left hand 4702 shown in FIG. 18 (assuming binary detection where 1=abducted, 0=not abducted) may be represented by the vector V_{left}=[1,0,0,0], indicating that the thumb 4704 is abducted, and the other fingers remain positioned together. As another concrete example, the right hand 4714 shown in FIG. 18 may be represented by the vector V_{right}=[0,1,0,0], indicating that the thumb 4716 is not abducted, but the first finger 4718 is abducted from the second finger 4720. As yet another example, a vector “[1, 1, 0, 0]” would indicate that the thumb is abducted from the first finger, the first finger is abducted from the second finger, and the second through fourth fingers are held together. Similar vector representations (potentially including flexion/extension values as well, forming a higher-dimensional hand pose vector) may be determined for each other potential combination of abduction values or overall hand pose. In an embodiment, each of those unique vector values or classified hand gestures may be assigned to a particular robot function or other meta-function that may be activated with finger abduction or specific hand poses.

Referring back to FIG. 12, in some embodiments in block 4410 the computer 3110 may monitor for one or more voice commands, captured by one or more microphones integrated into the HMD 3152, the wearable apparatus 3200, or wirelessly connected headsets. Voice commands may include specific words or phrases (e.g., keywords, short sentences) and/or specific non-verbal vocal sounds (e.g., clicks or hums, potentially easier to produce while concentrating on motor tasks, or learned sound patterns). The computer 3110 may employ audio processing techniques such as noise cancellation, beamforming (if multiple microphones are available), automatic speech recognition (ASR) engines (potentially speaker-dependent or independent, running locally or in the cloud), keyword spotting algorithms (optimized for detecting specific trigger words), and/or natural language understanding (NLU) modules to interpret the pilot's intent, allowing for more conversational commands (e.g., “Robot, engage clutch now”). Those voice commands may be standalone robot commands and/or may be used in combination with other control techniques such as gaze tracking (as a confirmation trigger). For example, in an embodiment, the computer 3110 may detect a particular phrase (e.g., “Confirm Selection”) and/or vocal sound (a trigger sound) that is used to confirm a gaze tracking selection. When the trigger sound is detected, the computer 3110 may activate and/or deactivate the particular function currently selected by the gaze of the pilot 2. The function may correspond to, for example, a user interface element 4502 displayed by the head-mounted display 3152, or a robot part (e.g., hand 56) or environmental object (e.g., chair 4514) represented in the display 3150. As another example, the computer 3110 may detect a particular phrase (e.g., “Engage Clutch”) and/or vocal sound that is directly mapped to a system meta-command. Continuing that example, in an embodiment, the user may state a descriptive command to activate the corresponding command, such as “engage robot clutch.” As yet another example, in an embodiment a semantic or emergent word or shorter keyword may be used to activate a system metacommand. For example, the pilot 2 may state a short, declarative command such as “STOP,” and the computer 3110 may engage the robot clutch 3140. As another example, the computer 3110 may use a voiceprint analysis (speaker recognition) or other personalization feature in order to determine the identity of the particular user who is speaking, potentially enabling speaker-specific command sets or preferences. Continuing that example, the computer 3110 may determine whether a voice command has been spoken by a known pilot 2 or authorized user, and only respond to commands spoken by that pilot 2 for certain sensitive operations, while allowing safety commands from any recognized speaker (i.e., speech diarization).

Additionally or alternatively, in some embodiments, the computer 3110 may respond to any speaker for some or all commands, such as safety-related commands (e.g., “Emergency Stop”). For example, the computer 3110 may engage the robot clutch 3140 or otherwise stop motion of the robot 1 in response to a command detected from any nearby user whose voice level exceeds a threshold. Further embodiments might analyze vocal prosody (pitch, tone, rhythm) to gauge pilot stress or confidence, potentially adapting system responses or requiring extra confirmation for critical commands under high stress. Silent speech interfaces, detecting subvocalizations via EMG or ultrasound, could provide another voice-based input channel. The voice-command meta-control channel does not require the pilot 2 to remove the hands 56 of the pilot 2 from the glove components 3400 or to interrupt the primary kinematic teleoperation, in that the voice signal is captured concurrently with motion of the actuated pilot arms 3300.

In some embodiments, in block 4412 the computer 3110 may monitor for one or more facial gestures. For example, the computer 3110 may monitor for winks, eyebrow raises, smiles, frowns, nose wrinkles, lip purses, cheek movements, or other facial gestures, including sequences or combinations thereof (e.g., wink followed by smile). The facial movements may be detected by one or more cameras (e.g., one or more cameras mounted to the HMD 3152 or otherwise mounted to the wearable training apparatus 3200) and/or one or more electromyography (EMG) sensors, which measure electrical activity produced by facial muscles, or potentially via alternative sensors like thermal cameras detecting facial temperature patterns associated with expressions. For example, in an embodiment the HMD 3152 may include one or more cameras (including near-infrared cameras, potentially shared with gaze tracking) mounted in an interior of the HMD 3152 and pointed toward the pilot's eyes and upper face. In those embodiments, the HMD 3152 may include one or more infrared LEDs or other infrared emitters, which may also be used for gaze-tracking or other functions. As another example, in an embodiment, the HMD 3152 may include one or more exterior cameras (e.g., RGB or NIR) configured to track the user's mouth and/or lower face.

In some embodiments, the computer 3110 may detect facial gestures using image data from one or more interior and/or exterior cameras mounted to the HMD 3152, for example by combining video data from multiple cameras and applying facial landmark detection algorithms (e.g., identifying positions of eyebrows, eye corners, nose tip, lip corners) followed by gesture classification (e.g., based on landmark displacements, velocities, or machine learning models trained on facial action units (AUs) derived from the Facial Action Coding System (FACS)). As another example, in an embodiment the HMD 3152 may include one or more dry or wet EMG sensors in contact with the pilot's face (e.g., embedded in the facial interface padding near target muscles like frontalis (eyebrows) or zygomaticus major (smile), or orbicularis oculi (wink)). In some embodiments, the wearable training apparatus 3200 may include or otherwise be in communication with one or more standalone EMG sensors (e.g., adhesive electrodes placed on the face). EMG signals require filtering and feature extraction (e.g., mean absolute value, root mean square, frequency analysis, wavelet transforms) before classification into gestures, potentially using more complex features like muscle fatigue indicators or co-activation patterns for finer control or state assessment.

The computer 3110 may monitor for one or more predetermined facial gestures and activate one or more corresponding system meta-commands. The computer 3110 may distinguish between different discrete facial gestures in order to activate particular meta-commands. For example, in response to detection of a left eye wink, the computer 3110 may engage or disengage the robot clutch 3140, and in response to a smile held for a duration Tₛₘᵢₗₑ, the computer 3110 may activate or deactivate data collection. A quick eyebrow raise might trigger another command. Specific voluntary eye blink patterns (e.g., double blink left eye) could also be defined as commands. As another example, the computer 3110 may interpret facial gestures as analog, proportional, or real-valued commands. For example, the computer 3110 may determine a degree of facial gesture intensity between neutral and smile (e.g., based on zygomaticus major activation level from EMG or lip corner displacement from video), between neutral and frown, between frown and smile; a degree (amplitude or height) of eyebrow raising; or other degree of facial gesture, and interpret that degree as a proportional command (e.g., using smile intensity to adjust a control parameter).

In some embodiments, in block 4414 the computer 3110 may monitor for foot pressure changes. For example, the computer 3110 may monitor for the pilot 2 shifting their weight left/right or front/back, detected via changes in the center of pressure (CoP) under each foot or between feet. In some embodiments, the computer 3110 may monitor for specific pressure patterns (e.g., heel-toe rocking, tapping specific regions like the ball or heel, or recognizing pressure signatures corresponding to different phases of gait if the pilot is walking). The computer 3110 may monitor for foot pressure using, for example, pressure sensors mounted in the shoes or specialized insoles of the pilot 2 or other non-stationary pressure sensors. These sensors may include arrays of force-sensitive resistors (FSRs), capacitive sensors, or piezoelectric elements, allowing for measurement of pressure distribution across the sole of the foot. Data may be transmitted wirelessly (e.g., BLE) from the shoe/insole to computer 3110. Similarly, in some embodiments, in block 4416 the computer 3110 may monitor for ankle or toe movements by the pilot 2. The computer 3110 may, for example, monitor for specific small movements detected by sensors such as IMUs (accelerometers, gyroscopes) integrated into the pilot's shoes or ankle straps, or bend sensors detecting toe flexion/extension, or FSRs placed under the toes. Multi-sensor insoles combining pressure arrays, IMUs, and potentially bend sensors can provide a richer dataset for interpreting foot-based commands. The foot-pressure meta-control channel of block 4414 and the ankle-and-toe meta-control channel of block 4416 do not require stationary pedals, foot-mounted floor controls, or other floor-fixed input devices, in that the sensors of blocks 4414 and 4416 are worn by the pilot 2 in shoes or insoles such that the meta-control channels remain available throughout the operating envelope of the wearable training apparatus 3200.

In an embodiment, the computer 3110 may recognize one or more foot pressure changes or movements as instantaneous commands to activate and/or deactivate robot functions. For example, in an embodiment the computer 3110 may recognize a relative increase in pressure (or CoP shift) to the front of the foot or feet (e.g., the left foot, the right foot, or both feet) exceeding a threshold as a command to engage the robot clutch 3140. Continuing that example, the computer 3110 may recognize a relative increase in pressure (or CoP shift) to the back of the foot or feet (e.g., the left foot, the right foot, or both feet) exceeding a threshold as a command to disengage the robot clutch 3140. As another example, the computer 3110 may recognize a change in foot pressure such as a quick heel tap detected by a pressure spike or accelerometer signal on the back of the foot or feet as a command to toggle the engagement state of the robot clutch 3140. As another example, in an embodiment the computer 3110 may recognize a different change in foot pressure such as a quick toe tap (or sequence of taps, e.g., “shave and a haircut”) on the front of the foot or feet as a command to toggle activation state of data collection. Ankle dorsiflexion/plantarflexion or inversion/eversion detected by IMUs could also be mapped to discrete commands. Of course, other combinations of foot pressure changes, patterns, taps, or ankle/toe movements and robot commands are possible in other embodiments. For example, in an embodiment, pressure changes or movements along the front-to-back axis of the right foot may engage or disengage the robot clutch, and pressure changes or movements along the left-to-right axis of the left foot may activate or deactivate data recording. Actions combining ankle movement with pressure (e.g., ankle inversion while pressing the heel) could expand the command set. As yet another example, in an embodiment, the computer 3110 may recognize one or more pressure changes as continuous commands that continue while the pilot 2 continues maintaining the foot pressure distribution or ankle/toe position. For example, in an embodiment, the robot clutch 3140 may remain engaged while the pilot 2 continues to shift their weight toward the back of the foot or feet beyond a certain CoP threshold.

Additionally or alternatively, in an embodiment, the computer 3110 may recognize foot pressure (e.g., CoP position, pressure magnitude under a specific region) or ankle/toe angle as a proportional command or other non-binary command. For example, the computer 3110 may move the robot 1 between robot states proportionally according to the detected foot pressure or angle, or the rate of change of these parameters. For example, in an embodiment the robot 1 may lean in a particular direction proportionally to the leftward CoP shift of the pilot's combined feet while the pilot 2 is shifting their foot weight (and associated foot pressure) in a corresponding direction. The pilot 2 may stop the robot 1 when it has reached the desired lean angle by returning to neutral foot pressure distribution. In an embodiment, the robot 1 may lean in an opposite direction while the pilot 2 shifts their weight in the opposite, corresponding direction, allowing the pilot 2 to correct the robot lean and/or lean the robot in a different desired direction. In a further embodiment, similar proportional foot pressure or ankle angle control may be used to control robot 1 bending motion (e.g., bending at the robot waist, perhaps mapped to CoP shift front/back or ankle plantarflexion/dorsiflexion). In an embodiment, foot pressure and/or movement controls may be used to control both leaning and bending functions of the robot 1. For example, foot pressure changes (CoP) along the front-to-back axis may be used to control robot bend angle (e.g., at the waist in the front-to-back direction), and foot pressure changes (CoP) along the left-to-right axis may be used to control robot lean angle (e.g., in the left-to-right direction). Of course, other combinations of foot pressure changes, movements, and robot meta-control commands are possible.

Referring now to FIG. 12, in some embodiments in block 4418 the computer 3110 may monitor for one or more predetermined hand and/or body gestures performed by the pilot 2 that are distinct from the primary teleoperation movements or specific finger gestures described earlier (block 4408). For example, the computer 3110 may monitor for movement of the entire hand or arm in a certain location, orientation, trajectory, or at a certain speed, such as a quick movement up with the hands, a “swipe” gesture in the air, a head nod or shake, or a shoulder shrug, or crossing arms. Those movements may not be replicated by the robot 1, for example if the pilot 2 does not actuate the glove components 3400 or arm controllers of the wearable training apparatus 3200 in a way that maps to robot motion, or if the detected gesture is specifically designated as a meta-command. The computer 3110 may use any appropriate technique to monitor for hand and/or body gestures. For example, as described above in connection with finger abduction recognition (block 4408), in an embodiment the computer 3110 may receive video data from one or more cameras (e.g., external cameras on the wearable apparatus 3200 or HMD 3152, or cameras in the environment) or other imaging sensors pointed toward the pilot's hands and/or other body parts.

The computer 3110 may use one or more full-body or partial-body gesture recognition models (e.g., a multistage neural pipeline with body landmark detection (like OpenPose), feature extraction, and temporal modeling (e.g., LSTMs, Transformers) or gesture classifiers) to identify predetermined hand, arm, head, or torso gestures performed by the pilot 2. The computer 3110 may use one or more similar gesture recognition models to recognize gestures performed with multiple hands, arms, and/or other limbs. Additionally or alternatively, in some embodiments the computer 3110 may monitor one or more motion sensors such as accelerometers, gyroscopes, IMUs placed on the pilot's limbs, torso, or head (potentially leveraging IMUs already present in the HMD 3152 or wearable apparatus 3200 for primary control tracking), and may recognize gestures based on the motions sensor data patterns (e.g., detecting specific acceleration profiles, orientation changes, or using machine learning classifiers trained on IMU time-series data). Sensor fusion techniques combining vision and IM data may improve robustness and accuracy. Parameters of body gestures, such as the speed of a nod or the amplitude of a shrug, could potentially be used for proportional meta-control input.

After monitoring the sensors for movement/interactions across one or more modalities (blocks 4402-4418), in block 4420 the computer 3110 determines whether a command requested by the pilot 2 via any of the monitored meta-control channels was detected. This may involve comparing sensor readings or processed features against predefined thresholds, patterns, templates, or classifier outputs. The system may employ a priority scheme, state-machine logic, or arbitration logic if multiple commands are detected simultaneously or in close succession, or if a command conflicts with the current system state. Confidence scores from classifiers may be used to filter out low-certainty detections. If no valid meta-command is detected, the method 4400 loops back to block 4402 to continue monitoring for movement/interactions. If a command was detected, the method 4400 advances to block 4422.

In block 4422, the computer 3110 performs the command requested by the pilot 2 via the detected meta-control input. As described above, the requested command may include meta-control commands related to the operation of the robot data collection computer 3010 but not directly controlling primary motion of the robot 1. Meta-control commands may include binary or instantaneous commands, which include activation or deactivation of one or more functions, modification of system state (e.g., changing modes), or other changes that may be activated in response to a binary signal or discrete event. For example, one or more control commands or system states may be activated in response to detecting the presence or absence (or exceeding a threshold) of finger abduction (block 4408). As another example, one or more control commands or system states may be activated in response to detection of a specific keyword or vocal command or sound (block 4410). As another example, one or more control commands or system states may be activated in response to detection of a discrete facial gesture such as a wink, raised eyebrow, or smile (block 4412). As another example, one or more control commands or system states may be activated in response to detection of a specific sip-and-puff action pattern (block 4406). As another example, one or more control commands or system states may be activated in response to detection of a specific bite action pattern (block 4406). As another example, one or more control commands or system states may be activated in response to detection of a discrete tongue command (block 4406). As another example, one or more control commands or system states may be activated in response to detection of a particular change in foot pressure pattern or discrete movement (blocks 4414, 4416). As a further example, a specific hand or body gesture (block 4418) like a thumbs-up or head nod could trigger a discrete command. The system may support defining macros, where a single meta-command input triggers a predefined sequence of actions. An “undo” meta-command might also be implemented to reverse the effect of the last executed meta-command.

Additionally or alternatively, meta-control commands may include analog, proportional, or other commands that respond to a user input representing a real value or other non-binary value, allowing for continuous adjustment. For example, one or more control commands or system states (e.g., robot leaning speed) may be adjusted proportionally in response to a particular finger abduction angle (block 4408). As another example, one or more control commands or system states may be adjusted proportionally in response to a particular degree (intensity) of a facial expression, such as a degree or amount of eyebrow raise, or a degree or amount of a smile (block 4412). As another example, one or more control commands or system states may be adjusted proportionally in response to a particular measured pressure or duration of a sip-and-puff action (e.g., proportional control based on duration or pressure) (block 4406). As another example, one or more control commands or system states may be adjusted proportionally in response to a particular measured bite pressure (block 4406). As another example, one or more control commands or system states may be adjusted proportionally in response to a particular determined tongue position (block 4406). As another example, one or more control commands or system states (e.g., robot bending angle) may be adjusted proportionally in response to detection of a particular foot pressure pattern (e.g., CoP position) or ankle/toe angle (blocks 4414, 4416). The rate of change of a body gesture (block 4418), like the speed of a head tilt, could also serve as a proportional input.

Additionally or alternatively, in some embodiments, one or more commands may be activated in response to associated combinations or sequences of multiple user inputs, potentially from different modalities, creating hierarchical or multi-stage commands. For example, as described above, in some embodiments a command may be executed in response to a detected pilot gaze on a target (block 4404) in combination with a confirming secondary input such as the presence or absence of finger abduction (block 4408), a vocal command (block 4410), or a facial gesture (block 4412). As another example, a command may be determined based on a predetermined combination or sequence of finger abduction values, such as a vector representation of finger abduction values changing over time (dynamic gesture). As a further example, a voice command like “Adjust Parameter” might modify the function associated with a subsequent proportional input (e.g., bite pressure now adjusts sensitivity instead of lean angle), or a foot pressure shift might enable a specific set of gaze-based commands, effectively acting as a mode switch. A sequence like “left foot heel tap followed by right index finger point” could be mapped to a unique command.

In some embodiments, as specific examples of commands executed in block 4422, in block 4424, the computer 3110 may engage or disengage (e.g., selectively engage or disengage and/or toggle the engagement state) of the robot clutch 3140. As described above, when the clutch 3140 is engaged, control of the robot 1 via the primary teleoperation interface is paused, for example by pausing transmission or processing of control data from the piloting control system 3202 via the computer 3110 to the robot 1, potentially holding the robot at its current position or allowing it to relax specific joints. While robot control is paused, the pilot 2 may reposition their hands or body as described above, without causing unintended robot motion. The pilot 2 may also operate one or more additional control devices as described further below (block 4432). When the clutch 3140 is disengaged, control of the robot 1 by the pilot 2 via the primary interface is resumed, potentially with smooth blending or recalibration. In some embodiments, in block 4426, the computer 3110 may activate or deactivate data collection in response to the user command, or tag the collected data with a specific label indicated by the command (e.g., “Start difficult phase”, “Mark error”). For example the computer 3110 may start or stop collecting training data or other data (e.g., sensor streams, event logs) from the robot 1, pilot 2, and environment in response to the user command. In some embodiments, in block 4428 the computer 3110 may reset the robot 1 to a neutral or predefined ‘home’ position, or cycle through predefined robot poses. Additionally or alternatively, in some embodiments, the computer 3110 may cause the robot 1 to perform a predetermined motion or execute a stored motion primitive, such as bending and/or leaning, potentially initiated by a discrete command or controlled continuously via an analog meta-control input. In some embodiments, the relative amount or rate of the predetermined motion (e.g., angle or speed of bending and/or leaning) may be based on an analog, proportional, or other real-valued user input as described above (e.g., degree of tongue displacement, foot pressure CoP, finger abduction angle). Other meta-commands may include cycling through different camera views presented in the HID 3152, adjusting HID display parameters (brightness, contrast), saving a system state snapshot, loading a previously saved state, or sending a notification (e.g., to a supervisor).

In block 4430, the computer 3110 determines whether the robot clutch 3140 has been engaged (i.e., whether primary teleoperation control is currently paused, potentially as a result of a command executed in block 4424 or via another mechanism). If not (i.e., if primary control by the pilot 2 of the robot 1 remains active), the method 4400 loops back to block 4402 to continue monitoring for further meta-control movements or other interactions. If the clutch 3140 has been engaged (i.e., if primary control by the pilot 2 of the robot 1 is paused), the method 4400 advances to block 4432 to optionally monitor for input from additional control devices that might become accessible or usable when the pilot's hands are freed from primary control tasks. Alternatively, monitoring of additional control devices in block 4432 could occur in parallel with block 4402, regardless of clutch state, for devices that do not require hand interaction (e.g., a BCI).

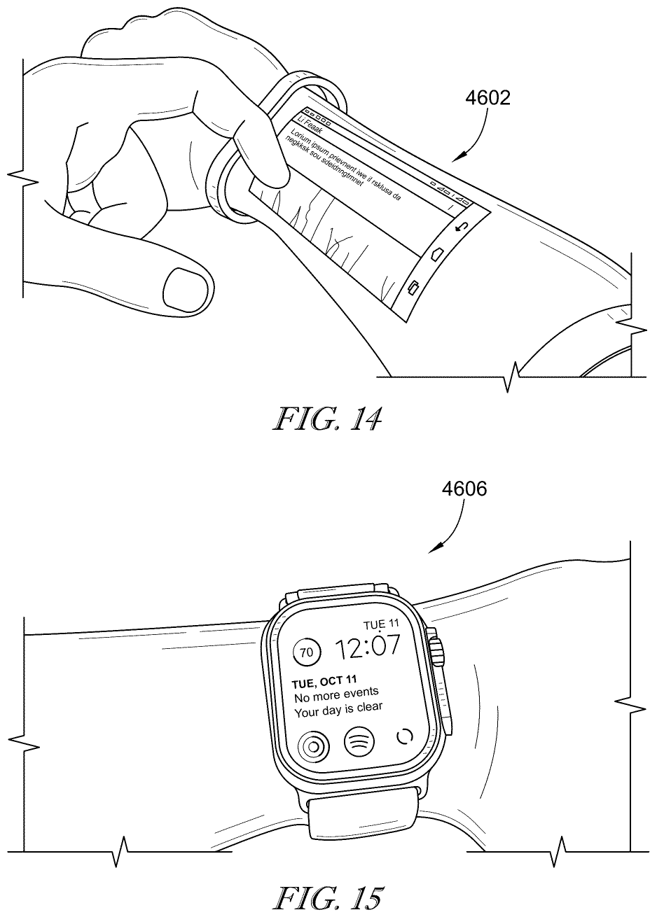

In block 4432, while the robot clutch 3140 is engaged (in this embodiment), the computer 3110 monitors additional control devices for input provided by the pilot 2. For example, the computer 3110 may monitor for touch input, button presses, gestures, or voice input directed at secondary devices, potentially provided with the hands of the pilot 2 now that they are not occupied with primary robot control. Such hand-based secondary touch input would not typically be possible or advisable while actively controlling the robot 1 via the primary hand controllers/gloves. In some embodiments, in block 4434 the computer 3110 may monitor a wearable device, such as a flexible arm display 4602 (FIG. 14), a smartwatch 4606 (FIG. 15), a smart ring 4610 (FIG. 17), or other wearable computing device (e.g., smart glasses separate from the HMD, body-worn pendants with buttons, EMG armbands detecting forearm muscle activity for gesture recognition). For example, referring to FIG. 14, the computer 3110 may monitor for touch input (taps, swipes, multi-touch gestures) from a flexible arm display 4602 worn on the pilot's forearm. As another example, referring to FIG. 15, the computer 3110 may monitor for touch input on the screen, voice input via its microphone, button input (physical buttons or crown rotation), or other appropriate input (e.g., wrist gestures detected by its IMU) from a smartwatch 4606 worn by the pilot 2. As another example, referring to FIG. 17, the computer 3110 may monitor for motion input (gestures like twisting or pointing detected by internal IMUs), tap input on its surface (detected capacitively or via accelerometers), or other appropriate input from a smart ring 4610 worn by the pilot 2. Of course, the computing device 110 may also monitor for other devices and/or input modalities, such as a projector device (potentially integrated into the HMD 3152 or wearable apparatus 3200) that projects a graphical user interface onto a surface (e.g., a nearby wall, a table, or the forearm of the pilot 2), with interactions potentially detected by cameras observing the projected interface and the pilot's hand/fingers. A handheld controller (e.g., a small joystick, trackball, or keypad) could also be used as an additional control device when the clutch is engaged. In advanced embodiments, Brain-Computer Interfaces (BCIs) could be monitored, using sensors (e.g., EEG, fNIRS integrated into the HMD or a separate cap) to detect specific neural signals corresponding to intended commands (e.g., motor imagery, P300 responses to flashed UI elements). Body-coupled communication might also be employed for data transfer between wearable sensors/devices. The secondary control devices monitored in block 4432 are worn or carried by the pilot 2, and the secondary control devices are free of attachment to a stationary console or to a fixed workstation, in that the secondary control devices are wearable or handheld devices that travel with the pilot 2 throughout the operating envelope of the wearable training apparatus 3200.

As an illustrative example, one or more of the additional control devices monitored in block 4432 may provide a graphical user interface (GUI) with user interface controls corresponding to various robot meta-control commands that may also be controlled using one or more of the hands-free meta-control techniques described above (blocks 4404-4418). Continuing that example, in an embodiment, a smartwatch 4606, flexible arm display 4602, or other screen display may provide buttons, icons, menus, or sliders or other user interface elements corresponding to one or more robot operations such as engage or disengage the robot clutch 3140, start or stop data collection (block 4426), reset robot to neutral position (block 4428), or perform (or adjust parameters for) predetermined motion, such as bending or leaning. This provides a redundant or alternative means of accessing meta-controls, potentially preferred by the pilot in certain situations or for less frequently used commands.

As another example, one or more of the additional control devices may provide a graphical user interface with user interface controls to control one or more additional robot operations, including directly controlling aspects of robot motion while the primary teleoperation is paused (clutch engaged). Continuing that example, in an embodiment, a smartwatch 4606, flexible arm display 4602, or other control device with a display screen may receive touch input indicative of a target navigation location, and the computer 3110 may direct the robot 1 to move to that location using its autonomous navigation capabilities. In an embodiment, the control device may display a map (e.g., 2D occupancy grid or 3D mesh) or other schematic view of the environment of the robot 1, and the user may tap or draw a target location and/or path for the robot 1. In another embodiment, the control device may display a video feed, still image, or other visual representation (e.g., synthetic view from the robot's perspective) of the environment of the robot 1, and the user may similarly select (e.g., by tapping on the image) a target location and/or path for the robot 1.

As another example, in an embodiment, one or more of the additional control devices may provide a non-graphical interface or otherwise respond to user input detected via means other than a visual display. For example, in an embodiment, a smart ring 4610 may respond to user gestures performed by tapping or moving the smart ring itself and/or moving other fingers against the smart ring. For example, the smart ring 4610 may detect interactions using one or more capacitive touch sensors on its surface, switches (e.g., small buttons), motion sensors (accelerometers, gyroscopes, IMUs), or other sensors. Continuing that example, in an embodiment the computer 3110 may recognize a single tap detected by the accelerometer of the smart ring 4610 as a command to engage the robot clutch 3140. Continuing that example, the computer 3110 may recognize a double tap or other predetermined sequence of taps (e.g., tap-and-hold, swipe gesture across the ring surface) as a command to disengage the robot clutch 3140. As another example, the computer 3110 may recognize a specific tap or predetermined sequence of taps as a command to toggle the engagement state of the robot clutch 3140. As another example, in an embodiment the computer 3110 may recognize a different tap or predetermined sequence of taps or a ring rotation gesture as a command to toggle activation state of data collection. Similarly, EMG armbands could recognize forearm muscle patterns corresponding to specific hand gestures (even if the hand itself is resting) to trigger commands.

In an embodiment, one or more of the additional control devices monitored in block 4432 may be used to directly control fine motion of the robot 1 while the primary control is paused. For example, when the robot clutch 3140 is engaged, the pilot 2 may use a graphical or non-graphical interface provided by an additional control device (e.g., smartwatch touch screen, flexible arm display sliders, smart ring gestures, voice commands, BCI commands) to fine-tune the pose of the robot 1, for example by directly adjusting joint angles (“jogging” individual joints) and/or end-effector limb positions incrementally in Cartesian space, or adjusting tool center point (TCP) offsets. Continuing that example, the pilot 2 may select a particular robot joint or limb (e.g., wrist roll joint, left elbow yaw joint, end-effector X position) using the graphical interface of the control device, and then further adjust the angle and/or position of the selected joint or limb using the control device (e.g., via on-screen buttons, sliders, rotating the smartwatch crown, or specific ring gestures). After adjusting the pose or other position of the robot 1, the pilot 2 may disengage the robot clutch 3140 (e.g., using a meta-command from any available modality) and continue operating the wearable training apparatus 3200 via the primary control interface as described above. This clutch-engage->fine-tune->clutch-disengage sequence allows for precise robot positioning that might be difficult or tedious using only the primary teleoperation controls.

Referring back to FIG. 12, after monitoring the additional control devices in block 4432 (if the clutch was engaged, or potentially in parallel), the method 4400 loops back to block 4402 to continue monitoring for hands-free meta-control movements or other interactions, regardless of the current clutch state. Accordingly, the data collection computer 3010, by implementing method 4400, may provide robust and flexible meta-control of data collection operations and other system functions for the pilot 2 using a variety of non-primary input modalities (gaze, mouth, fingers, voice, face, feet, gestures, potentially physiological signals or BCI) while also allowing direct control of robot 1 movement via the primary piloting control.

### H. ALTERNATIVE EMBODIMENTS

In another embodiment, the meta-control system may exhibit context-awareness, dynamically adapting the available meta-commands or their activation methods based on the robot's current operational context or state. The computer could analyze factors such as the specific task the robot is performing (e.g., delicate manipulation versus locomotion), the state of the environment (e.g., presence of obstacles detected by sensors), or the robot's internal status (e.g., joint limits, battery level). Based on this context, the system might restrict certain meta-commands, prioritize safety-related inputs, adjust the sensitivity of input detection (e.g., requiring longer dwell times for gaze commands in cluttered environments), or change the function mapped to a specific pilot input, thereby enhancing safety and operational efficiency. The context-aware embodiment of the meta-control system is selected because operating context varies across tasks performed by the robot 1, which results in a meta-control mapping that is responsive to the present task without manual reconfiguration by the pilot 2.

An alternative embodiment may involve varied or configurable mappings between the pilot's non-primary actions and the resulting meta-commands. Rather than employing a fixed association (e.g., where a specific finger abduction gesture always engages the clutch), the system could allow for different predefined mapping profiles or permit user-level configuration via a settings interface. This would enable pilots or administrators to assign specific meta-operations (such as engaging/disengaging the clutch, toggling data collection, or resetting the robot) to their preferred input modality (e.g., gaze, voice, bite sensor, facial gesture) or specific action pattern within that modality, tailoring the meta-control interface to individual preferences, accessibility needs, or task demands. The configurable-mapping embodiment is selected because pilot preferences and accessibility needs differ across operators of the wearable training apparatus 3200, which results in an interface that may be matched to each pilot 2 without modification of the underlying detection pipelines.

Further embodiments may incorporate alternative secondary control devices, particularly for use when the primary control clutch is engaged, freeing the pilot's hands. While devices like smartwatches or flexible arm displays are contemplated, the system could also interface with other hardware. Examples include small, handheld controllers featuring joysticks, buttons, or trackballs; wearable smart rings capable of detecting taps or motion gestures; or even projection-based interfaces that display controls onto a nearby surface or the pilot's body, allowing interaction via hand gestures observed by system cameras. These devices could provide alternative means for triggering meta-commands or performing fine-grained robot adjustments not easily achieved through the primary or hands-free interfaces. The alternative-secondary-device embodiments are selected because the pilot 2 may have differing access to specific wearable or handheld hardware across operating sessions, which results in a meta-control architecture that supports substitution of secondary control devices without modification to the meta-control method 4400.

In some embodiments, the execution of meta-commands could require the detection of combined inputs, either simultaneously or in a specific sequence, potentially across different modalities. For instance, activating a function might necessitate both sustained gaze fixation on a target UI element and a concurrent confirmation action, such as a specific voice command, a deliberate finger gesture detected by the glove component, a facial gesture like a nod, or a bite sensor activation. This approach can enhance command specificity, expand the total number of distinct meta-commands available, and improve robustness against unintentional activation, particularly for modalities like gaze tracking where the “Midas Touch” problem can occur. The combined-input embodiment is selected because the combination of two independent modalities establishes a deliberate command confirmation threshold, which results in the prevention of unintentional command activations during passive visual scanning of the environment.

An alternative operational mode involves utilizing the system entirely within a simulated environment, without interfacing with a physical humanoid robot. In this embodiment, the pilot wears the wearable training apparatus, and the sensors capture movement data. The computer processes this sensor data to generate control data, which then drives a simulated robot avatar within a virtual environment displayed to the pilot, potentially via the head-mounted display. The system would calculate interactions between the simulated robot and virtual objects, generating corresponding haptic feedback data transmitted back to the actuators in the wearable apparatus to provide feedback to the pilot. This mode allows for data collection, training, system testing, or skill development in a safe, controlled, and purely virtual setting.

In some embodiments, a calibration system may be employed to ensure display accuracy. The system may comprise a processor configured to execute calibration procedures utilizing image processing techniques applied to images captured from or displayed by the apparatus. Corrective matrices, generated based on reference targets or predetermined calibration data, may be applied to adjust displayed images, thereby enhancing color accuracy, geometric fidelity, and consistency in depth perception, particularly in stereoscopic or multi-view displays. Furthermore, machine learning models may be trained to identify and dynamically correct optical distortions, aberrations, or alignment errors in real-time. Calibration equations, potentially derived from imaging known reference targets, can be utilized to mitigate geometric distortion across the field of view. Advanced computational imaging algorithms may be implemented to further refine accuracy, potentially compensating for component variations or environmental factors. Real-time optimization processes may continuously monitor and adjust display parameters to compensate for detected discrepancies, such as stereo vision alignment drift, ensuring a consistent and accurate visual output.

The apparatus may be configured for adaptability to accommodate a diverse range of user anthropometries and operational requirements. In various embodiments, the apparatus may comprise adjustable components, such as telescoping elements for adjusting length or distance, adjustable straps for securing the apparatus to a user, and articulating joints allowing for variations in angle or fit. Alternatively, or in addition, the apparatus may be offered in multiple discrete sizes. A modular design philosophy may be employed, wherein certain components can be easily exchanged or reconfigured. For instance, quick-release mechanisms may facilitate the rapid attachment, detachment, or servicing of components. A modular backplate or chassis element could provide standardized interfaces for integrating alternative or upgraded sensor packages, computing modules, power sources, or other subsystems, thereby enhancing the versatility and longevity of the apparatus.

In certain embodiments, the system may determine the position, orientation, or configuration of a user's hand and/or fingers using non-EMF (Electromagnetic Field) based tracking methods. One such embodiment may utilize a system of mechanical linkages coupled between a base structure (e.g., worn on the back of the hand or forearm) and segments of the user's digits. The angles or displacements within these linkages can be measured by sensors (e.g., potentiometers, encoders) to calculate finger joint angles and overall hand pose. Alternative sensor technologies may also be employed, either individually or in combination. These may include, but are not limited to, resistive bend sensors measuring flexure, Inertial Measurement Units (IMUs) detecting orientation and motion of hand/finger segments, optical fiber sensors measuring bending or stretching via light transmission changes, or capacitive touch sensors detecting proximity or contact, which can contribute to gesture recognition or state determination.

A control system may be implemented wherein user actions, detected via one or more input modalities, are translated into meta-commands for controlling the apparatus or an associated system. The mappings between specific user actions (e.g., gestures, gaze direction, voice commands, physiological signals) and corresponding meta-commands may be configurable. In some embodiments, these mappings may be adaptive, learning or adjusting based on user behavior, context, or explicit user configuration. The context, such as the currently active application or operational state, may dynamically alter the available meta-commands or the actions required to trigger them. Furthermore, the issuance of a meta-command may require combined inputs from the user. These inputs could be required simultaneously (e.g., maintaining gaze on a target while issuing a voice confirmation) or in a specific sequence across the same or different input modalities, potentially enhancing control precision or preventing unintended activations.

### I. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.” It should be understood that any parameter that disclosed a range herein may be set to any value within that range, and/or may set a smaller range within the larger disclosed range. For example, disclosing a range between 10 million and 2 trillion parameters discloses a range from 1 billion to 50 billion parameters. Further, disclosing a range between 100 mHz to 50 Hz discloses a range from 1 Hz to 50 Hz.

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a Delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), wheeled robots with torsos and arms, a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/322,446, 19/323,751, 19/325,486, 19/325,415, 19/321,159, 19/324,342, 19/329,008, 19/329,474, 19/329,559, 19/337,845, 19/337,852, 19/337,899, 19/347,690, 19/342,470, 19/342,474, 19/347,994, 19/351,294, 19/342,470, 19/357,879, 19/352,959, 19/355,393, 19/321,022, 19/355,531, 19/355,786, 19/357,879, 19/358,414, 19/656,881, 19/362,617, 19/577,331, 19/565,007 and 19/565,304; and (iii) U.S. Design Patent Application Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/024,351; (iv) U.S. Provisional Patent Application Nos. 63/556,102, 63/557,874, 63/558,373, 63/561,307, 63/561,311, 63/561,313, 63/561,315, 63/705,802, 63/706,779, 63/763,209, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A robot teleoperation system comprising: a primary motion-mapping interface configured to capture continuous limb movement of a human operator and to map the continuous limb movement to continuous movement of a robot during a teleoperation session; one or more non-primary input sensors configured to receive operator input concurrently with the primary motion-mapping interface; and one or more processors configured to: identify, from the operator input received via the one or more non-primary input sensors, a meta-command while the primary motion-mapping interface continues to map the continuous limb movement to the continuous movement of the robot; and execute the meta-command on the robot, the meta-command comprising at least one of (i) toggling a data collection subsystem, (ii) adjusting a posture parameter of the robot, (iii) engaging a clutch of the primary motion mapping, or (iv) causing the robot to perform a predetermined motion.

2. The system of claim 1, wherein the one or more non-primary input sensors comprise a microphone, and wherein the meta-command is identified from a spoken voice command issued by the operator while the primary motion mapping remains continuously active.

3. The system of claim 1, wherein the one or more non-primary input sensors comprise an eye-tracking sensor, and wherein the meta-command is identified by detecting the operator's gaze dwelling on a specific region of a user interface for a predetermined duration.

4. The system of claim 1, wherein the one or more non-primary input sensors comprise a foot-actuated pedal, allowing the operator to issue the meta-command using a lower extremity while upper extremity limb movement is continuously mapped to the robot.

5. The system of claim 1, wherein the meta-command comprises toggling a data collection subsystem, and wherein executing the meta-command causes the system to begin recording a telemetry dataset of the teleoperation session and to cryptographically tag the dataset for use in training a machine learning model.

6. The system of claim 1, wherein the meta-command comprises adjusting a posture parameter of the robot by shifting a base stance or center of gravity of the robot without altering a real-time position of a robotic end-effector controlled by the primary motion mapping.

7. The system of claim 1, wherein the one or more processors are further configured to evaluate the identified meta-command against a pre-programmed safety envelope, and to block execution of the meta-command if executing the meta-command would cause the robot to collide with a detected environmental obstacle.

8. A method of teleoperating a robot, comprising: capturing, via a wearable apparatus worn by a human operator, primary motion data representing movement of the operator; mapping the primary motion data to actuation of corresponding parts of the robot; capturing, via one or more sensors, a meta-gesture comprising movement of the operator that lies outside a kinematic envelope of the robot such that the meta-gesture is not physically replicable by the robot through the mapping; and executing, in response to the meta-gesture, a meta-command that modifies an operational state of the robot.

9. The method of claim 8, wherein the robot comprises a robotic arm having a parallel gripper lacking independent finger articulation, and wherein the meta-gesture comprises the operator moving individual fingers in a sequence that cannot be physically replicated by the parallel gripper.

10. The method of claim 8, wherein the robot is a stationary or wheeled robot lacking lower extremities, and wherein the meta-gesture comprises a leg or foot movement performed by the operator.

11. The method of claim 8, wherein the meta-command comprises returning the robot to a predetermined pose, and wherein executing the meta-command further comprises automatically calculating and executing a collision-free trajectory from a current pose of the robot to a home pose.

12. The method of claim 8, wherein the meta-command comprises toggling a data collection subsystem, and wherein the method further comprises appending an annotation label to the captured primary motion data in response to the meta-gesture, thereby categorizing the data for a specific robotic task.

13. The method of claim 8, wherein the meta-gesture comprises a rapid, high-velocity flinch movement exceeding a normal operational speed limit of the robot, and wherein the executed meta-command comprises an emergency stop that arrests all robot actuation.

14. The method of claim 8, further comprising disambiguating the meta-gesture from incidental operator motion by requiring that the meta-gesture (i) exceed a confidence threshold of a gesture classifier, (ii) be sustained for at least a minimum duration, or (iii) both.

15. A method of teleoperating a robot, comprising: transmitting, from a wearable apparatus worn by a human operator, motion-derived control commands that cause the robot to move in correspondence with movement of the operator; receiving an input that engages a clutch of the wearable apparatus; in response to engagement of the clutch, suspending transmission of the motion-derived control commands and maintaining a commanded pose of the robot; while the clutch is engaged, accepting a meta-command via an independent modality, the meta-command comprising at least one of a re-origination input, a fine-adjustment input modifying a joint angle or end-effector coordinate of the robot, or a state-toggle input modifying an operational state of the robot; executing the meta-command on the robot; and upon disengagement of the clutch, resuming transmission of the motion-derived control commands.

16. The method of claim 15, wherein the independent modality comprises a spatial computing interface, and wherein accepting the meta-command comprises detecting the operator interacting with a virtual menu displayed in an augmented reality or virtual reality environment while the clutch is engaged.

17. The method of claim 15, wherein the meta-command comprises a re-origination input establishing a new tracking origin, allowing the operator to physically reposition the operator's limbs into a more ergonomic posture without moving the robot, thereby ratcheting the motion-derived control commands.

18. The method of claim 15, further comprising, while the clutch is engaged, displaying a simulated ghost robot within a user interface to visually preview an effect of the fine-adjustment input before the meta-command is executed on the robot.

19. The method of claim 15, wherein the meta-command comprises a state-toggle input modifying an operational state of the robot, and wherein the operational state modified comprises an impedance, stiffness, or compliance profile of a robotic joint.

20. The method of claim 15, wherein accepting the meta-command further comprises capturing an operator-provided semantic label annotating the motion-derived control commands transmitted immediately prior to engaging the clutch.

21. The method of claim 15, wherein resuming transmission of the motion-derived control commands comprises blending from the maintained commanded pose to a resumed motion-mapped pose over a ramp time or according to a velocity-limited transition.
